(19) United States
(12) Patent Application Publication
(10) Pub. No.: US 2006/0097715 A1
(43) Pub. Date: May 11, 2006

(54) Vertical Hall device and method for adjusting offset voltage of vertical Hall device

(75) Inventors: Satoshi Oohira, Gifu-city (JP); Hirotsugu Funato, Nagoya-city (JP); Yoshihiko Isobe, Toyoake-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/260,681

(22) Filed: Oct. 28, 2005

(30) Foreign Application Priority Data
Oct. 28, 2004 (JP) 2004-314416
Nov. 12, 2004 (JP) 2004-328907
Nov. 17, 2004 (JP) 2004-333355
Apr. 6, 2005 (JP) 2005-110234

(51) Int. Cl. G01B 7/30

(52) U.S. Cl. 324/207.2

(57) ABSTRACT

A vertical Hall device includes: a semiconductor substrate including a magnetic field detection portion, a current portion and an output portion. The output portion includes a pair of output terminals. The current portion is capable of supplying the current to the magnetic field detection portion and retrieving the current from the magnetic field detection portion. The current portion is sandwiched between a pair of the output terminals in such a manner that the current portion is disposed apart from a line connecting between a pair of the output terminals.

### CROSS REFERENCE TO RELATED APPLICATIONS

This application is based on Japanese Patent Applications No. 2004-314416 filed on Oct. 28, 2004, No. 2004-328907 filed on Nov. 12, 2004, No. 2004-333355 filed on Nov. 17, 2004, and No. 2005-110234 filed on Apr. 6, 2005, the disclosures of which are incorporated herein by reference.

### FIELD OF THE INVENTION

The present invention relates to a vertical Hall device and a method for adjusting an offset voltage of a vertical Hall device.

### BACKGROUND OF THE INVENTION

As well known, since the Hall element is capable of non-contact angle detection, it is mounted on a so-called Hall IC to be used, for example, as a magnetic sensor for an angle detection sensor such as opening degree sensor of a throttle valve of an internal combustion engine for vehicle. First, a principle of magnetic detection of the Hall element is described with reference to FIG. 67.

When a magnetic field (i.e., magnetism) perpendicular to electric current flowing through a substance is applied, an electric field (i.e., electric voltage) is generated in a direction perpendicular to both the electric current and the magnetic field. This phenomenon is called Hall effect, and voltage generated herein is called Hall voltage.

For example, when a Hall element (i.e., conductor) 100 as shown in FIG. 67 is considered, assuming that width of a magnetic detection part (i.e., Hall Plate) of the element is W, length is L, thickness is d, an angle made by the element and a magnetic field is θ, magnetic flux density to be applied is B, and supply (i.e., drive) current (i.e., current flowing between terminals TI and TI′) is I, Hall voltage (i.e., voltage generated between terminals TV_{H} an TV_{H}′) V_{H} can be expressed as follows.
V_{H}=(R_{H}IB/d)cos θ, R_{H}=1/(qn).

Here, R_{H} is a Hall coefficient, q is electric charges, and n is carrier concentration.

As known from the relational expression, since Hall voltage V_{H} is changed according to an angle θ made by the Hall element and the magnetic field, the angle can be detected by using this. Thus, the angle detection sensor can be realized by using the Hall element. As a typical Hall element, a Hall element as described in Ichisuke Maenaka and other three, “Integrated Three-Dimensional Magnetic Sensor,” Transactions of the Institute of Electrical Engineers of Japan 1988, 109, No. 7, pp 483-490, so-called horizontal Hall element is known. The horizontal Hall element detects a magnetic field component perpendicular to the substrate surface (i.e., chip surface).

Hereinafter, the Hall element (i.e., horizontal Hall element) is further described with reference to FIGS. 68A and 68B. FIG. 68A is a plan view of the Hall element, and FIG. 68B is a cross section view along a line L1-L1 of FIG. 68A.

As shown in FIG. 68A and FIG. 68B, the Hall element is roughly configured to have a semiconductor region 22 comprising N-type silicon, which is formed, for example, by epitaxial growth, on a semiconductor layer (i.e., P⁻ sub) 21 comprising, for example, P-type silicon. The semiconductor region 22 can be similarly formed as an N-type semiconductor substrate (i.e., N⁻ sub), or a diffusion layer formed by ion implantation, that is, a well. In a semiconductor material such as silicon, N-type semiconductor has large carrier mobility compared with P-type semiconductor, therefore an N-type semiconductor material (i.e., for example, silicon) is often used for a material of the semiconductor region 22. However, a P-type semiconductor material is sometimes used depending on manufacturing processes or structural conditions. Moreover, since as impurity concentration in the semiconductor region 22 is decreased (i.e., less), carrier mobility in the region increases, the impurity concentration in the semiconductor region 22 is desirably decreased (i.e., less) in order to improve sensitivity as a Hall element, that is, in order to obtain large voltage as output voltage. Generally, the semiconductor region 22 (i.e., N⁻ layer) is set to have an impurity concentration of “1.0×10¹⁴ to 1.0×10¹⁷/cm³.”

In the semiconductor region 22, for example, a P-type diffusion layer (i.e., P-type diffusion isolation wall) 24 to be connected to the semiconductor layer 21 is formed in order to isolate the Hall element from other elements. On a surface of the semiconductor region 22, contact regions 23a to 23d are formed in a manner of selectively increasing impurity concentration (i.e., N-type) of the surface, so that excellent ohmic contact is formed between the contact regions 23a to 23d and electrodes (i.e., wiring lines) arranged thereon. More specifically, the contact regions 23a, 23b and the contact regions 23c, 23d are disposed at four corners of the region (i.e., active region) 22a enclosed by the diffusion layer 24 in a manner of being perpendicular to each other. The contact regions 23a to 23d are electrically connected to terminals S and G and terminals V1 and V2 via respective electrodes (i.e., wiring lines) arranged thereon, respectively. That is, the contact regions 23a and 23b are corresponding to current supply terminals, and the contact regions 23c and 23d are corresponding to voltage output terminals.

Here, for example, when constant drive current is made to flow from the terminal S to the terminal G, the current flows from the contact region 23a to the contact region 23b through the inside of the semiconductor region 22. That is, in this case, current mainly containing a component parallel to a substrate surface (i.e., chip surface) flows near the substrate surface. At that time, when a magnetic field (for example, magnetic field indicated by an arrow B in FIGS. 68A and 68B) containing a component perpendicular to the substrate surface (i.e., chip surface) is applied to the current, Hall voltage responding to the magnetic field is generated between the terminals V1 and V2 due to the Hall effect. Therefore, a signal of the generated Hall voltage signal is detected through the terminals V1 and V2, thereby a magnetic component as an object to be detected, or a magnetic field component perpendicular to the surface (i.e., chip surface) of the substrate used for the relevant Hall element is obtained according to the previous relational expression “V_{H}=(R_{H}IB/d)cos θ” as shown in FIG. 67. In the Hall element, drive current may be made to flow between the terminals V1 and V2 to detect the Hall voltage at terminals S and G. Therefore, a drive method (i.e., chopper drive) that cancels offset voltage (i.e., unbalanced voltage) occurring in the element by using such exchange of electrodes, for example, by periodically exchanging electrodes is practically used.

As another example of such a horizontal Hall element, a horizontal Hall element as shown in FIG. 69 is given. That is, in the horizontal Hall element, a region (i.e., active region) 22a enclosed by the diffusion layer 24 is formed in a crosswise pattern and the contact regions 23a to 23d are arranged at respective end portions. In the Hall element, an operation mode of it is the same as in the horizontal Hall element shown in the previous FIGS. 68A and 68B.

Recently, in addition to the horizontal Hall element, for example, as described in JP-A-H01-251763, a Hall element that detects a magnetic field component parallel to the substrate surface (i.e., chip surface), so-called vertical Hall element is proposed. Since the vertical Hall element has a feature that it can integrate two elements for detecting different phases (i.e., angles) into one chip, two vertical Hall elements are disposed in a manner of making an angle of “90 degrees,” thereby a rotation sensor that can provide linear output (i.e., voltage signal) in an angle range of “0° to 90°” can be realized. Hereinafter, an example of the vertical Hall element is described with reference to FIGS. 70A to 70C. FIG. 70A is a plan view of the Hall element, FIG. 70B is a cross section view along a line L1-L1 of FIG. 70A, and FIG. 70C is a cross section view along a line L2-L2 of FIG. 70A.

As shown in FIGS. 70A to 70C, the Hall element is roughly configured to have a semiconductor layer (⁻sub) 31 comprising, for example, P-type silicon, a buried layer BL formed in a manner of introducing an N-type conductivity type impurity into a surface of the layer, and a semiconductor region 32 comprising N-type silicon further formed thereon, for example, by epitaxial growth. The buried layer BL functions as a kind of lower electrode, the impurity concentration of which is set to high compared with the semiconductor region 32.

Again in this Hall element, in the semiconductor region 32, for example, a P-type diffusion layer (P-type diffusion separation barrier) 34 to be connected to the semiconductor layer 31 is formed in order to isolate the relevant Hall element from other elements. In a region (active region) that is situated on a surface of the semiconductor region 32 and enclosed by the diffusion layer 34, contact regions (N⁺ layer) 33a to 33e are formed in a manner of selectively increasing impurity concentration (N-type) of the surface, so that excellent ohmic contact is formed between the contact regions 33a to 33e and electrodes (wiring lines) arranged on the regions. The contact regions 33a to 33e are electrically connected to terminals S, G1, G2, V1 and V2 via respective electrodes (wiring lines) arranged thereon, respectively. That is, in the Hall element, the contact regions 33a to 33c correspond to current supply terminals, and the contact regions 33d and 33e correspond to voltage output terminals.

As shown in FIG. 70A, the region (active region) enclosed by the diffusion layer 34 is divided into regions 32a to 32c separated from one another by P-type diffusion layers (P-type diffusion separation barriers) 34a and 34b. Here, the diffusion layers 34a and 34b are formed in a mode of being connected to the buried layer BL, and in the region 32a to 32c, as shown in FIG. 70C, electrically partitioned regions are formed even in the substrate. Regarding the regions, the contact region 33b is formed on the region 32b, the contact region 33e is formed on the region 32c, and the contact regions 33a, 33c and 33d are formed on the region (element region) 32a, respectively. More specifically, the contact region 33a is disposed in a manner of being interposed by both of the contact regions 33b, 33e and the contact regions 33c, 33d perpendicular to the regions. That is, a layout where the contact region 33a is opposed to each of the contact regions 33b and 33e across the contact regions 34a and 34b is made.

In the Hall element, a region that is situated in the region electrically partitioned within the substrate of the region 32c and interposed by the contact regions 33c and 33d is the so-called magnetic detection part (Hall Plate) HP. That is, in the Hall element, a Hall voltage signal responding to a magnetic field applied to the region is generated.

Here, for example, when constant drive current is made to flow from the terminal S to the terminal G1, and from the terminal S to the terminal G2 respectively, the current flows from the contact region 33a formed on the substrate surface to the contact regions 33b and 33e through the magnetic detection part HP and the buried layer BL respectively. That is, in this case, current mainly containing a component perpendicular to the substrate surface (chip surface) is made to flow into the magnetic detection part HP. Therefore, when a magnetic field (for example, magnetic field indicated by an arrow B in FIGS. 70A to 70C) containing a component parallel to the substrate surface (chip surface) is assumed to be applied to the magnetic detection part HP of the relevant Hall element, Hall voltage responding to the magnetic field is generated between the terminals V1 and V2 due to the Hall effect. Accordingly, the generated Hall voltage signal is detected through the terminals V1 and V2, thereby a magnetic field component as the detection object, or the magnetic-field component parallel to the surface (chip surface) of the substrate used for the relevant Hall element is obtained according to the previous relational expression “V_{H}=(R_{H}IB/d)cos θ” as shown in FIG. 67. In the Hall element, a dimension d shown in FIG. 67 corresponds to thickness (“d” in the relational expression) of the magnetic detection part (Hall Plate). In addition, in the Hall element, a direction along which the drive current is made to flow can be optionally set, and the magnetic field (magnetism) can be detected in a direction opposite to the direction of the drive current.

As another vertical Hall element in such a type, for example, a vertical Hall element described in R. S. Popovic, “The Vertical Hall-Effect Device,” IEEE ELECTRON DEVICE LETTER, SEPTEMBER 1984, EDL-5, No. 9, pp 357-358 is given.

In this way, according to the vertical Hall element exemplified in the FIG. 70, the magnetic filed component applied to the magnetic detection part HP, more specifically a magnetic filed component parallel to the substrate surface (chip surface) can be surely detected. However, the vertical Hall element is not always in a structure that can meet the temporal circumstance where the element is placed, or a structure that is optimized depending on use of the Hall element and use of a sensor using the element, or use environment, and there is room for improvement (., problems). Hereinafter, the problems are described in detail with reference to FIG. 71A to FIG. 74.

For example, as shown in FIG. 71A, a vertical Hall element 30 exemplified in the FIGS. 70A to 70C is arranged on a rotational axis between magnets MG1 and MG2 comprising the N pole and the S pole in order to detect rotation of the magnets. Here, when the magnets MG1 and MG2 rotate, for example, voltage signals (Hall voltage signals) as shown as waveforms M1 to M3 in FIG. 71B are outputted from the vertical Hall element 30. Then, as shown in FIGS. 72A and 72B, a linear portion (range MA) of a waveform M4 as the voltage signal (output voltage) is used, thereby a rotational sensor that provides linear output (output waveform) M5 as sensor output is realized.

Specifically, the waveform M3 (in FIG. 71B) is an ideal waveform (Sin wave) that does not include output voltage in the case that the magnetic field is not applied, or the offset voltage (unbalanced voltage) is not generated. However, in an actual Hall element, some output voltage (offset voltage) is typically generated, for example, as a waveform M2 despite the magnetic field is not applied to. Mainly, two reasons for generation of the offset voltage are pointed out as follows.

One is positional displacement (i.e., alignment displacement) occurring due to error in mask alignment and the like in a manufacturing process (i.e., lithography process) of the Hall element. When such positional displacement occurs, that is, when components (i.e., including diffusion layers 34, 34a and 34b and contact regions 33a to 33e) are formed in a manner of being displaced (i.e., biased) from original positions, a current channel within the element is biased, causing unbalance in potential distribution (i.e., equipotential line) within the element. As a result, some offset voltage is generated in the Hall element.

Another reason is mechanical stress externally applied to the element. For example, when the Hall element is packaged, stress is applied to a substrate due to a sealing material such as thermosetting epoxy resin (i.e., mold resin) or adhesive comprising silver paste and the like. When such stress is applied to the substrate, uneven stress is applied to respective portions of the substrate, and a resistance bridge as an equivalent circuit of a resistance component within the element becomes more unbalanced due to the piezoresistance effect. That is, again in this case, unbalance occurs in the potential distribution within the element, consequently offset voltage is generated.

In addition, as shown as the wave form M1 in FIG. 71B, the output voltage (i.e., Hall voltage signal) of the Hall element varies depending on a temperature characteristic of the element. Actually, temperature characteristics of the magnets MG1 and MG2 also have influence on detection of rotational angle.

Such variation in output voltage due to the offset voltage or the temperature characteristic hinders accurate magnetic field detection. Therefore, a correction circuit is typically provided in order to correct or remove the variation. However, even in such a case, when the variation in output voltage (for example, standard deviation) is large, the correction circuit must be enlarged, and therefore various inconveniences along with it become inevitable. Moreover, when such a correction circuit is provided, the correction circuit may be integrated into one chip together with the Hall element, or provided as a separate chip. While the expansion of the correction circuit causes the inconveniences in either case, particularly in the case that the correction circuit is integrated into one chip, many inconveniences such as spatial restriction on chip area or increase in cost occurs along with it.

Further, hindrance to accurate magnetic field detection is not limited to an offset voltage. For example, detection accuracy is reduced by reduction in sensitivity of a Hall element (so-called integrated sensitivity), or reduction in output voltage (i.e., Hall voltage) responding to a magnetic field. Again in this case, the output voltage is considered to be increased (i.e., amplified) by a signal processing circuit that is integrated into one chip together with the relevant Hall element, or provided as a separated chip. However, when the output voltage is small, expansion of the circuit is eventually inevitable, and various inconveniences in accordance with the expansion are inevitable.

In this way, in the magnetic field detection using the Hall element, the offset voltage and element sensitivity are important factors. Since desired values for the factors are different depending on use of the Hall element, or various environment in which the element is placed, a structure that can flexibly respond to the use and the environment, that is, a structure that can be optimized depending on the use and the environment is required.

Furthermore, FIG. 73 shows an example of a Hall element integrated into one chip with the correction circuit. FIG. 74 shows an example of temperature characteristic of offset voltage as a graph.

That is, the Hall element performs correction for variation in output voltage or variation in offset voltage (see FIG. 74) due to temperature change using an appropriate correction circuit, while detecting temperature, for example, by a temperature detection device TD comprising a diode or a resistance element. Thus, even when contact regions 33a to 33e are arranged in a manner of being displaced from original positions, or displaced with respect to reference axes P11 to P13 and P21 to P23, output voltage having a desired waveform can be obtained through the correction. However, the correction method further requires the temperature detection device, causing further expansion of circuit scale.

Here, in a horizontal or vertical Hall element as exemplified in FIGS. 75A to 76 and FIGS. 70A to 70C, movable ions such as sodium (i.e., Na) ions exist in an interlayer insulating film formed on an element surface. Therefore, the movable ions move in accordance with current application to the relevant Hall element or temperature change, thereby electric potential near voltage output terminals (for example, contact regions 33c and 33d shown in FIG. 70A) becomes unstable, which may fluctuate an extremely small Hall voltage signal outputted from the element. This is called temporal fluctuation or drift, causing error in magnetic detection based on the voltage, and in particular, when the relevant Hall element is used as an angle detection sensor, since deterioration of characteristics of the sensor is inevitable, the problem is serious.

Thus, for example as shown in FIG. 77, a Hall element in which a conductor plate GP comprising aluminum, which is fixed to a predetermined potential (for example, ground potential), is provided such that it covers the element surface has been traditionally proposed. Here, as an example of the element, a case that the conductor plate GP is applied to the horizontal Hall element exemplified in the previous FIG. 75A and FIG. 75B is described. In FIG. 78, an example of the temporal variation (i.e., temporal change of output voltage) is shown in a graph.

In this way, the conductor plate GP is provided such that it covers the element surface, thereby electric potential at the element surface is fixed, and the periphery of the element surface is also in stable potential environment. Therefore, movement of movable ions PI within the interlayer insulating film (abbreviated to be shown) is suppressed, and the fluctuation of the output voltage due to the movable ions PI is reduced, consequently detection accuracy as the magnetic detection element can be maintained high. As another one, a Hall element in which the element surface is covered with a P-type diffusion layer so that the element surface does not contact to the interlayer insulating film through PN junction formed with an N-type semiconductor region 22 has been traditionally proposed.

However, in the vertical Hall element, for example as shown in FIG. 79, depletion layers VR (i.e., regions indicated by a two-dot chain line in the figure) are formed between the semiconductor region 32 and the diffusion layers 34, 34a and 34b. Here, a formation mode of the depletion layer when drive current flows from the terminal S to the terminals G1 and G2 respectively in the vertical Hall element exemplified in the previous FIGS. 70A to 70C is shown. That is, at a power side region 32a where the terminal S is arranged, electric potential is increased compared with ground side regions 32b and 32c, and expansion of the depletion layer VR is large only at a level corresponding to the increased electric potential.

It has been confirmed by the inventors that in the vertical Hall element, electric potential is unstable at a portion where the depletion layer VR is formed, and the movable ions actively moves near the portion. That is, it is concerned that the temporal variation becomes larger due to the formation of the depletion layer VR. As described before, sensitivity of the Hall element depends on a dimension of the element, particularly dimension of the magnetic detection part (i.e., Hall Plate); therefore sensitivity during magnetic detection varies due to change of an element shape along with the formation of the depletion layer VR. Specifically, width (i.e., expansion level) of the depletion layer VR depends on temperature environment in the periphery of the element and process conditions during element production, and the sensitivity of the element becomes unstable depending on the conditions.

In this way, while the temporal variation is somewhat suppressed by providing the conductor plate on the element surface, it does not always provide a sufficient effect, in addition, there is room for improvement on variation in sensitivity during magnetic detection.

### SUMMARY OF THE INVENTION

In view of the above-described problem, it is an object of the present invention to provide a vertical Hall device. It is another object of the present invention to provide a method for adjusting an offset voltage of a vertical Hall device.

A vertical Hall device includes: a semiconductor substrate including a magnetic field detection portion, a current portion and an output portion. The output portion outputs a Hall voltage in accordance with a magnetic field component parallel to a surface of the substrate when a magnetic field is applied to the magnetic field detection portion, and current including a component perpendicular to the surface of the substrate is supplied to the magnetic field detection portion through the current portion. The output portion includes a pair of output terminals. The current portion is capable of supplying the current to the magnetic field detection portion and retrieving the current from the magnetic field detection portion. The current portion is sandwiched between a pair of the output terminals in such a manner that the current portion is disposed apart from a line connecting between a pair of the output terminals.

In this case, the offset voltage of the device is reduced, and the detection sensitivity of the device is improved. Thus, sensor characteristics of the device are improved.

Alternatively, a pair of the output terminals is disposed on a portion of the substrate, the portion at which equipotential lines in an electric potential distribution are dense. Alternatively, a pair of the output terminals is disposed on a portion of the substrate, the portion at which equipotential lines in an electric potential distribution are dilute.

Alternatively, the substrate has an asymmetric electric potential distribution with reference to the line connecting between a pair of the output terminals. Alternatively, the current portion is disposed on a dense side of equipotential lines in the asymmetric electric potential distribution. Alternatively, the current portion is disposed on a dilute side of equipotential lines in the asymmetric electric potential distribution.

Alternatively, the current portion includes a pair of current terminals, which is disposed asymmetric with reference to the line connecting between a pair of the output terminals. Alternatively, the current portion includes a pair of current terminals, which is disposed on one side of the line connecting between a pair of the output terminals.

Alternatively, the current including the component perpendicular to the surface of the substrate flows through the magnetic field detection portion in a slanting direction with reference to the surface of the substrate.

Alternatively, the device further includes a signal processing circuit for processing a signal corresponding to the Hall voltage outputted from the output terminals. The signal processing circuit is disposed on the substrate so that one chip magnetic sensor is provided, and the one chip magnetic sensor detects the magnetic field applied to the device in a predetermined direction. Alternatively, the magnetic field detection portion, the current portion and the output portion provide a first Hall element. The semiconductor substrate further includes a second magnetic field detection portion, a second current portion and a second output portion, which provide a second Hall element. The first Hall element detects a first magnetic field component of a magnetic field in a first direction, and the second Hall element detects a second magnetic field component of the magnetic field in a second direction.

Alternatively, the substrate has four sides of a rectangular shape. A line connecting between the first and the third Hall elements has a 45 degree angle with respect to one side of the substrate, and a line connecting between the second and the fourth Hall elements has a 45 degree angle with respect to another one side of the substrate. Alternatively, the line connecting between a pair of the output terminals is parallel to a predetermined crystal orientation of the substrate, and a line connecting between a pair of output terminals of the second output portion is parallel to another predetermined crystal orientation of the substrate.

Further, a vertical Hall device includes: a semiconductor substrate including a magnetic field detection portion, an output portion, a separation wall and a high concentration region. The separation wall electrically separates the substrate into a plurality of parts by a PN junction between the separation wall and the substrate. The high concentration region is disposed on a surface of the substrate and disposed between the separation wall and the substrate, and the high concentration region has an impurity concentration higher than that of the substrate.

In this case, the depletion layer in the device is limited from expanding; and therefore, movable ions near the surface of the substrate are also limited from moving. Thus, change of an output voltage with time is reduced, so that the detection accuracy of the device is increased. Further, the detection sensitivity of the device is improved. Furthermore, the deviation of the detection sensitivity of the device is also improved.

Alternatively, the high concentration region has a depth perpendicular to the substrate, and the depth of the high concentration region is minimized as long as the current including the component perpendicular to the surface of the substrate is capable of flowing through the magnetic field detection portion. Alternatively, the high concentration region includes a first high concentration region and a second high concentration region, and the first high concentration region is disposed inside of the separation wall, and the second high concentration region is disposed outside of the separation wall.

Alternatively, the substrate further includes a current portion having a pair of current terminals. A pair of the current terminals is capable of supplying the current to the magnetic field detection portion. The output portion includes a pair of output terminals for outputting the Hall voltage. A pair of the output terminals is disposed on the substrate. Each output terminal has an impurity concentration higher than that of the substrate. A pair of the current terminals is disposed on the substrate. Each current terminals has an impurity concentration higher than that of the substrate. The high concentration region has a depth perpendicular to the substrate. The depth of the high concentration region is almost equal to a depth of the current terminals or a depth of the output terminals.

Further, a vertical Hall device includes: a semiconductor substrate including a magnetic field detection portion, a current portion and an output portion. The output portion includes a pair of output terminals for outputting the Hall voltage. The current portion includes a pair of current terminals for supplying the current to the magnetic field detection portion. Each output terminal includes a plurality of output terminal parts having a predetermined pattern, and each current terminal includes a plurality of current terminal parts having a predetermined pattern.

In this case, without adding a temperature sensor, a compensation value of the offset voltage is easily and accurately determined on the basis of the positioning of the patterns of the current terminal parts and the output terminal parts. Thus, the offset voltage can be easily compensated and removed. Even if the device includes a compensation circuit, the dimensions of the compensation circuit can be reduced appropriately.

Alternatively, the pattern of the output terminal parts is symmetric on the basis of the pattern of the current terminal parts. Alternatively, the pattern of the current terminal parts is symmetric on the basis of the pattern of the output terminal parts.

Alternatively, the number of the current terminal parts is odd number, and the current terminal parts are symmetric on the basis of one of the current terminal parts. The number of the output terminal parts is odd number, and the output terminal parts are symmetric on the basis of one of the output terminal parts. Alternatively, the number of the current terminal parts is even number, and the current terminal parts are symmetric so that a predetermined number of pairs of the current terminal parts is provided. The number of the output terminal parts is even number, and the output terminal parts are symmetric so that a predetermined number of pairs of the output terminal parts is provided.

Alternatively, each current terminal part is connected to a wiring, which is capable of temporary or eternally disconnecting to an external circuit, and each output terminal part is connected to a wiring, which is capable of temporary or eternally disconnecting to the external circuit. Alternatively, the wiring of the current terminal part includes a fuse for disconnecting itself by overcurrent, and the wiring of the output terminal part includes a fuse for disconnecting itself by overcurrent. Alternatively, the wiring of the current terminal part includes a thin film resistor capable of disconnecting by a trimming, and the wiring of the output terminal part includes a thin film resistor capable of disconnecting by the trimming. Alternatively, the wiring of the current terminal part includes a switching device for switching on the basis of an external signal, and the wiring of the output terminal part includes a switching device for switching on the basis of an external signal.

Further, a vertical Hall device includes: a semiconductor substrate including a magnetic field detection portion, a current portion and an output portion. At least one of the output terminals is disposed on a concavity or a convexity on the surface of the substrate.

In this case, the electric potential distribution in the device is appropriately deformed so that the offset voltage of the device is reduced. Further, the offset voltage is appropriately compensated. Thus, without adding a temperature sensor, a compensation value of the offset voltage is easily and accurately determined on the basis of the positioning of the patterns of the current terminal parts and the output terminal parts. Thus, the offset voltage can be easily compensated and removed. Even if the device includes a compensation circuit, the dimensions of the compensation circuit can be reduced appropriately.

Further, a vertical Hall device includes: a semiconductor substrate including a magnetic field detection portion, a current portion and an output portion. At least one of the current terminals is disposed on a concavity or a convexity on the surface of the substrate.

In this case, the electric potential distribution in the device is appropriately deformed so that the offset voltage of the device is reduced. Further, the offset voltage is appropriately compensated. Thus, without adding a temperature sensor, a compensation value of the offset voltage is easily and accurately determined on the basis of the positioning of the patterns of the current terminal parts and the output terminal parts. Thus, the offset voltage can be easily compensated and removed. Even if the device includes a compensation circuit, the dimensions of the compensation circuit can be reduced appropriately.

Further, a method for adjusting an offset voltage of a vertical Hall device is provided. The device includes a semiconductor substrate having a magnetic field detection portion, a current portion and an output portion. The output portion outputs a Hall voltage in accordance with a magnetic field component parallel to a surface of the substrate when a magnetic field is applied to the magnetic field detection portion, and current including a component perpendicular to the surface of the substrate is supplied to the magnetic field detection portion through the current portion. The output portion includes a pair of output terminals having a predetermined pattern for outputting the Hall voltage, and the current portion includes a pair of current terminals having a predetermined pattern for supplying the current to the magnetic field detection portion. The method includes the step of: determining a compensation value for adjusting the offset voltage of the Hall device on the basis of a relation ship between a position of the patterns of the output terminals and the current terminals and the offset voltage.

In this case, without adding a temperature sensor, the offset voltage is easily and accurately determined, so that the offset voltage is compensated and removed.

Alternatively, the method may include the step of: canceling the offset voltage by controlling the current flowing through the magnetic field detection portion periodically when the Hall device is operated. Alternatively, the method may include the step of: selectively adjusting a height of at least one of the output terminals or at least one of the current terminals so that the offset voltage of the Hall device is adjusted.

### BRIEF DESCRIPTION OF THE DRAWINGS

The above and other objects, features and advantages of the present invention will become more apparent from the following detailed description made with reference to the accompanying drawings. In the drawings:

FIG. 1A is a plan view showing a vertical Hall device according to a first embodiment of the present invention, FIG. 1B is a cross sectional view showing the device taken along line L1-L1 in FIG. 1A, and FIG. 1C. is a cross sectional view showing the device taken along line L2-L2 in FIG. 1A;

FIG. 2A is a plan view explaining an electric potential distribution in a vertical Hall device as a comparison, and FIG. 2B is a plan view explaining an electric potential distribution in another vertical Hall device as another comparison, according to the first embodiment;

FIG. 3 is a plan view explaining an electric potential distribution in the vertical Hall device according to the first embodiment;

FIGS. 4A and 4B are cross sectional views explaining an operation state of the vertical Hall device according to the first embodiment;

FIGS. 5A to 5C are cross sectional view explaining a method for manufacturing the vertical Hall device according to the first embodiment;

FIGS. 6A to 6C are cross sectional view explaining a method for manufacturing the vertical Hall device according to the first embodiment;

FIG. 7 is a plan view explaining an electric potential distribution in a vertical Hall device according to a second embodiment of the present invention;

FIG. 8 is a plan view explaining an electric potential distribution in a vertical Hall device according to a third embodiment of the present invention;

FIG. 9 is a plan view explaining an electric potential distribution in a vertical Hall device according to a modification of the third embodiment;

FIG. 10A is a plan view showing a vertical Hall device according to a fourth embodiment of the present invention, and FIG. 10B is a cross sectional view showing the device taken along line L2-L2 in FIG. 10A;

FIG. 11A is a plan view showing a vertical Hall device according to a modification of the fourth embodiment, and FIG. 11B is a cross sectional view showing the device taken along line L2-L2 in FIG. 11A;

FIG. 12A is a plan view showing a vertical Hall device according to a fifth embodiment of the present invention, and FIG. 12B is a cross sectional view showing the device taken along line L2-L2 in FIG. 12A;

FIG. 13A is a plan view showing a vertical Hall device according to a sixth embodiment of the present invention, and FIG. 13B is a cross sectional view showing the device taken along line L2-L2 in FIG. 13A;

FIG. 14 is a plan view showing a vertical Hall device according to a seventh embodiment of the present invention;

FIG. 15 is a plan view showing a vertical Hall device according to a modification of the seventh embodiment;

FIGS. 16A and 16B are plan views showing vertical Hall devices according to a second and a third modifications of the seventh embodiment;

FIG. 17 is a plan view showing a vertical Hall device according to an eighth embodiment of the present invention;

FIG. 18 is a graph showing a waveform of an output voltage of the vertical Hall device according to the eighth embodiment;

FIG. 19 is a plan view showing a vertical Hall device according to a ninth embodiment of the present invention;

FIG. 20 is a plan view showing a vertical Hall device according to a tenth embodiment of the present invention;

FIG. 21 is a plan view showing a vertical Hall device according to a modification of the tenth embodiment;

FIG. 22 is a plan view showing a vertical Hall device according to an eleventh embodiment of the present invention;

FIG. 23 is a plan view showing a vertical Hall device according to a modification of the eleventh embodiment;

FIG. 24 is a plan view showing a vertical Hall device according to a second modification of the eleventh embodiment;

FIG. 25 is a plan view showing a vertical Hall device according to a third modification of the eleventh embodiment;

FIG. 26 is a plan view showing a vertical Hall device according to a twelfth embodiment of the present invention;

FIG. 27 is a plan view showing a vertical Hall device according to a modification of the twelfth embodiment;

FIG. 28A is a plan view showing a vertical Hall device according to a modification of the first embodiment, FIG. 28B is a cross sectional view showing the device taken along line L1-L1 in FIG. 28A, and FIG. 28C is a cross sectional view showing the device taken along line L2-L2 in FIG. 28A;

FIG. 29A is a plan view showing a vertical Hall device according to a second modification of the first embodiment, FIG. 29B is a cross sectional view showing the device taken along line L1-L1 in FIG. 29A, and FIG. 29C is a cross sectional view showing the device taken along line L2-L2 in FIG. 29A;

FIG. 30A is a plan view showing a vertical Hall device according to a third modification of the first embodiment, FIG. 30B is a cross sectional view showing the device taken along line L1-L1 in FIG. 30A, and FIG. 30C is a cross sectional view showing the device taken along line L2-L2 in FIG. 30A;

FIG. 31A is a plan view showing a vertical Hall device according to a fourth modification of the first embodiment, FIG. 31B is a cross sectional view showing the device taken along line L1-L1 in FIG. 31A, and FIG. 31C is a cross sectional view showing the device taken along line L2-L2 in FIG. 31A;

FIG. 32A is a plan view showing a vertical Hall device according to a fifth modification of the first embodiment, and FIG. 32B is a plan view showing a vertical Hall device according to a sixth modification of the first embodiment;

FIG. 33A is a plan view showing a vertical Hall device according to a thirteenth embodiment of the present invention, FIG. 33B is a cross sectional view showing the device taken along line L1-L1 in FIG. 33A, and FIG. 33C is a cross sectional view showing the device taken along line L2-L2 in FIG. 33A;

FIG. 34A is a plan view showing a vertical Hall device according to a fourteenth embodiment of the present invention, FIG. 34B is a cross sectional view showing the device taken along line L1-L1 in FIG. 34A, and FIG. 34C is a cross sectional view showing the device taken along line L2-L2 in FIG. 34A;

FIG. 35 is a plan view showing a vertical Hall device according to a modification of the thirteenth embodiment;

FIG. 36 is a plan view showing a vertical Hall device according to a second modification of the thirteenth embodiment;

FIG. 37 is a plan view showing a vertical Hall device according to a third modification of the thirteenth embodiment;

FIG. 38 is a plan view showing a vertical Hall device according to a fourth modification of the thirteenth embodiment;

FIG. 39 is a plan view showing a vertical Hall device according to a fifth modification of the thirteenth embodiment;

FIG. 40 is a plan view showing a vertical Hall device according to a sixth modification of the thirteenth embodiment;

FIG. 41 is a plan view showing a vertical Hall device according to a seventh modification of the thirteenth embodiment;

FIG. 42A is a plan view showing a vertical Hall device according to an eighth modification of the thirteenth embodiment, and FIG. 42B is a cross sectional view showing the device taken along line L1-L1 in FIG. 42A;

FIG. 43A is a plan view showing a vertical Hall device according to a fifteenth embodiment of the present invention, FIG. 43B is a cross sectional view showing the device taken along line L1-L1 in FIG. 43A, and FIG. 43C is a cross sectional view showing the device taken along line L2-L2 in FIG. 43A;

FIGS. 44A and 44B are graphs showing characteristics of an offset voltage in the vertical Hall device according to the fifteenth embodiment;

FIG. 45 is a plan view showing a vertical Hall device according to a sixteenth embodiment of the present invention;

FIGS. 46A and 46B are graphs showing characteristics of the offset voltage in the vertical Hall device according to the sixteenth embodiment;

FIG. 47 is a plan view showing a vertical Hall device according to a seventeenth embodiment of the present invention;

FIGS. 48A and 48B are graphs showing characteristics of the offset voltage in the vertical Hall device according to the seventeenth embodiment;

FIG. 49 is a plan view showing a vertical Hall device according to a modification of the seventeenth embodiment;

FIGS. 50A and 50B are graphs showing characteristics of the offset voltage in the vertical Hall device according to the modification of the seventeenth embodiment;

FIG. 51 is a plan view showing a vertical Hall device according to a modification of the fifteenth embodiment;

FIG. 52 is a plan view showing a vertical Hall device according to a second modification of the fifteenth embodiment;

FIG. 53 is a plan view showing a vertical Hall device according to a third modification of the fifteenth embodiment;

FIG. 54 is a plan view showing a vertical Hall device according to a fourth modification of the fifteenth embodiment;

FIG. 55A is a plan view showing a vertical Hall device according to a fifth modification of the fifteenth embodiment, and FIG. 55B is a cross sectional view showing the device taken along line L1-L1 in FIG. 55A;

FIG. 56 is a circuit diagram explaining cancellation of an offset voltage by a chopping operation, according to an eighteenth embodiment of the present invention;

FIG. 57 is a plan view showing a vertical Hall device according to the eighteenth embodiment;

FIG. 58A is a plan view showing a vertical Hall device according to a nineteenth embodiment of the present invention, FIG. 58B is a cross sectional view showing the device taken along line L1-L1 in FIG. 58A, and FIG. 58C is a cross sectional view showing the device taken along line L2-L2 in FIG. 58A;

FIG. 59 is a cross sectional view showing a vertical Hall device according to a modification of the nineteenth embodiment;

FIG. 60 is a cross sectional view showing a vertical Hall device according to a second modification of the nineteenth embodiment;

FIG. 61 is a cross sectional view showing a vertical Hall device according to a third modification of the nineteenth embodiment;

FIG. 62 is a cross sectional view showing a vertical Hall device according to a fourth modification of the nineteenth embodiment;

FIG. 63 is a cross sectional view showing a vertical Hall device according to a fifth modification of the nineteenth embodiment;

FIG. 64 is a cross sectional view showing a vertical Hall device according to a sixth modification of the nineteenth embodiment;

FIG. 65 is a cross sectional view showing a vertical Hall device according to a seventh modification of the nineteenth embodiment;

FIG. 66 is a cross sectional view showing a vertical Hall device according to an eighth modification of the nineteenth embodiment;

FIG. 67 is a schematic view explaining a magnetic detection method of a Hall device;

FIG. 68A is a plan view showing a lateral Hall device according to a prior art, and FIG. 68B is a cross sectional view showing the device taken along line L1-L1 in FIG. 68A;

FIG. 69 is a plan view showing a lateral Hall device according to a prior art;

FIG. 70A is a plan view showing a vertical Hall device according to a prior art, FIG. 70B is a cross sectional view showing the device taken along line L1-L1 in FIG. 70A, and FIG. 70C is a cross sectional view showing the device taken along line L2-L2 in FIG. 70A;

FIG. 71A is a schematic view explaining a positioning of a vertical hall device, and FIG. 71B is a graph showing a waveform of an output voltage of the vertical Hall device;

FIG. 72A is a graph showing a waveform of the output voltage of a vertical Hall device, and FIG. 72B is a graph showing a sensor output of the vertical Hall device;

FIG. 73 is a plan view showing a vertical Hall device integrated into one chip with a compensation circuit according to a prior art;

FIG. 74 is a graph showing temperature dependence of the offset voltage of a vertical Hall device;

FIG. 75A is a plan view showing a lateral Hall device according to a prior art, FIG. 75B is a cross sectional view showing the device taken along line L1-L1 in FIG. 75A;

FIG. 76 is a plan view showing a lateral Hall device according to a prior art;

FIG. 77 is a schematic view showing a lateral Hall device having a conductor plate as a comparison;

FIG. 78 is a graph showing change of an output voltage with time; and

FIG. 79 is a plan view showing a depletion layer in a vertical Hall device according to a prior art.

### DETAILED DESCRIPTION OF THE PREFERRED EMBODIMENTS

### First Embodiment

Hereinafter, a first embodiment of a vertical Hall element according to the invention is represented.

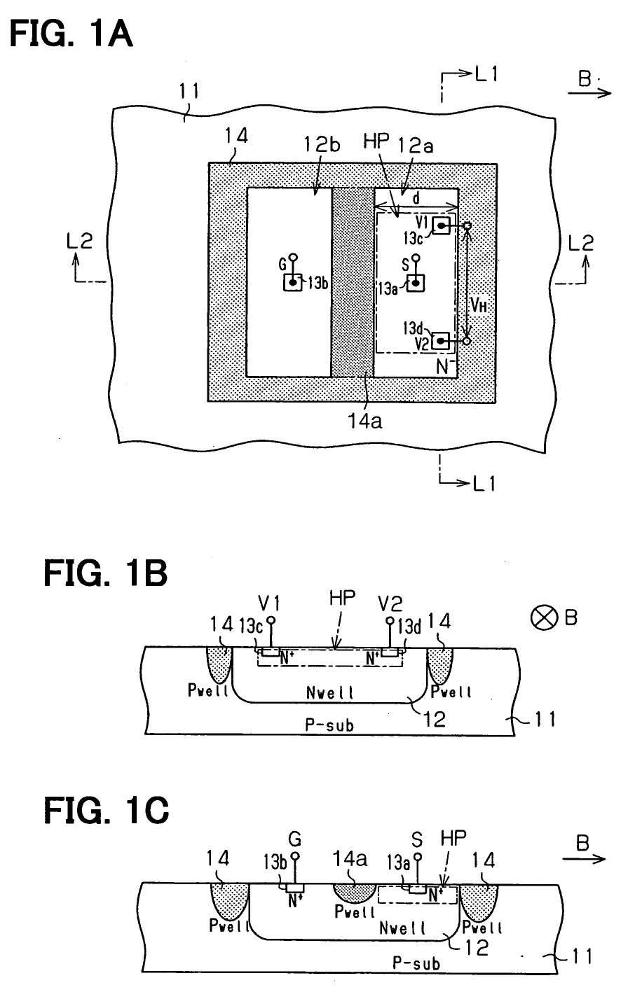

First, a schematic structure of the vertical Hall element according to the embodiment and an operation mode of the element are described with reference to FIG. 1A to FIG. 1C. In FIG. 1A to FIG. 1C, FIG. 1A is a plan view typically showing a planar structure of the Hall element, FIG. 1B is a cross section view along a line L1-L1 of FIG. 1A, and FIG. 1C is a cross section view along a line L2-L2 of FIG. 1A.

As shown in FIGS. 1A to 1C, the Hall element is roughly configured to have a semiconductor layer (i.e., P⁻sub) 11 comprising, for example, P-type silicon, and a N-type semiconductor region (i.e., N well) 12 formed as a diffusion layer (i.e., well), for example, by introducing an N-type conductivity type impurity into a surface of the layer 11. As described before, in the semiconductor material such as silicon, since N-type semiconductor has large carrier mobility compared with P-type semiconductor, the N-type semiconductor material is desirably used for a material (for example, silicon) of the semiconductor region 12. However, the P-type semiconductor material (i.e., P-sub) can be also used depending on manufacturing processes or structural conditions. Moreover, as impurity concentration of the semiconductor region 12 is decreased (i.e., less), carrier mobility in the region increases, therefore impurity concentration in the semiconductor region 12 is desirably decreased (i.e., less) in order to improve sensitivity as the Hall element, that is, in order to obtain large voltage as output voltage.

Again in this Hall element, in the semiconductor layer 11, for example, a P-type diffusion layer (i.e., P-type diffusion separation barrier) 14 is formed in order to isolate the relevant Hall element from other elements. In a surface of the semiconductor region 12, contact regions (i.e., N⁺ layers) 13a to 13d are formed in a manner of selectively increasing the impurity concentration (i.e., N-type) of the surface, so that excellent ohmic contact is formed between each of the contact regions and an electrode (i.e., wiring line) arranged thereon. The contact regions 13a to 13d are electrically connected to terminals S and G, and terminals V1 and V2 via respective electrodes (i.e., wiring lines) for forming the ohmic contact.

As shown in FIG. 1A, the region (i.e., active region) enclosed by the diffusion layer 14 is divided into regions 12a and 12b separated from each other across a P-type diffusion layer (i.e., P-type diffusion separation barrier) 14a through PN-junction separation by each diffusion layer. As shown in FIG. 1B and 1C, the regions 12a and 12b form electrically partitioned regions even within the substrate by the diffusion layers 14 and 14a. Among the regions, the contact regions 13a, 13c and 13d are formed in the region 12a (i.e., element region), and the contact regions 13b is formed in the region 12b respectively. Specifically, a layout where an axis given by the contact regions 13a and 13b and an axis given by the contact regions 13c and 13d are perpendicular to each other, and the contact region 13b is opposed to the contact regions 13a across the contact regions 13b is made. Furthermore, in the region 12a, the contact region 13a is arranged in a mode of being interposed by the contact regions 13c and 13d in a manner of deviating from the axis (line L1-L1) given by the contact regions 13c and 13d.

In the Hall element, a region (i.e., space) in the region 12a which is electrically partitioned within the substrate and interposed by the contact regions 13c and 13d is a so-called magnetic detection part (i.e., Hall plate) HP. That is, the Hall element generates a Hall voltage signal responding to a magnetic field applied to the part.

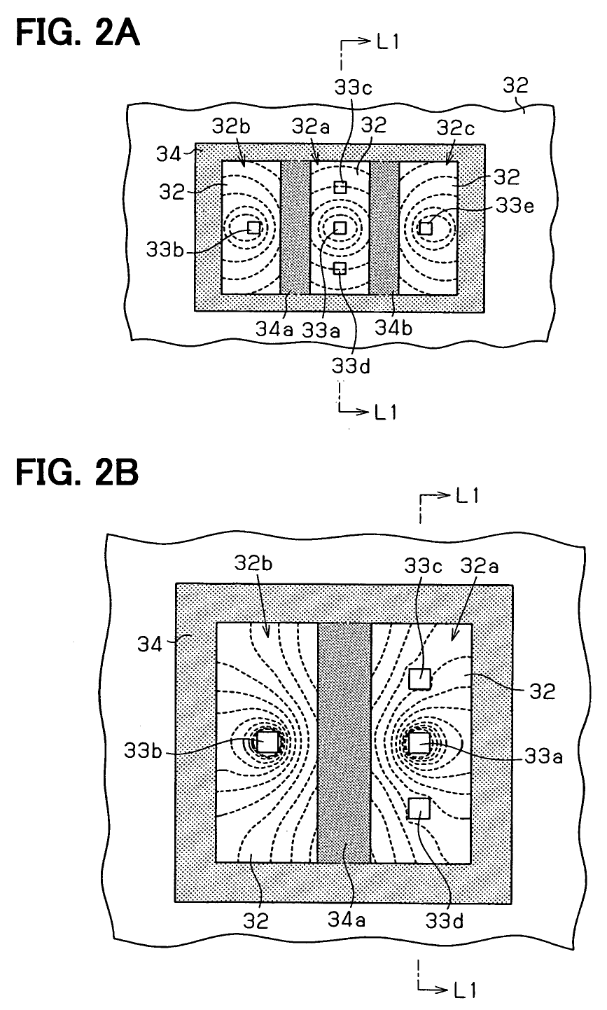

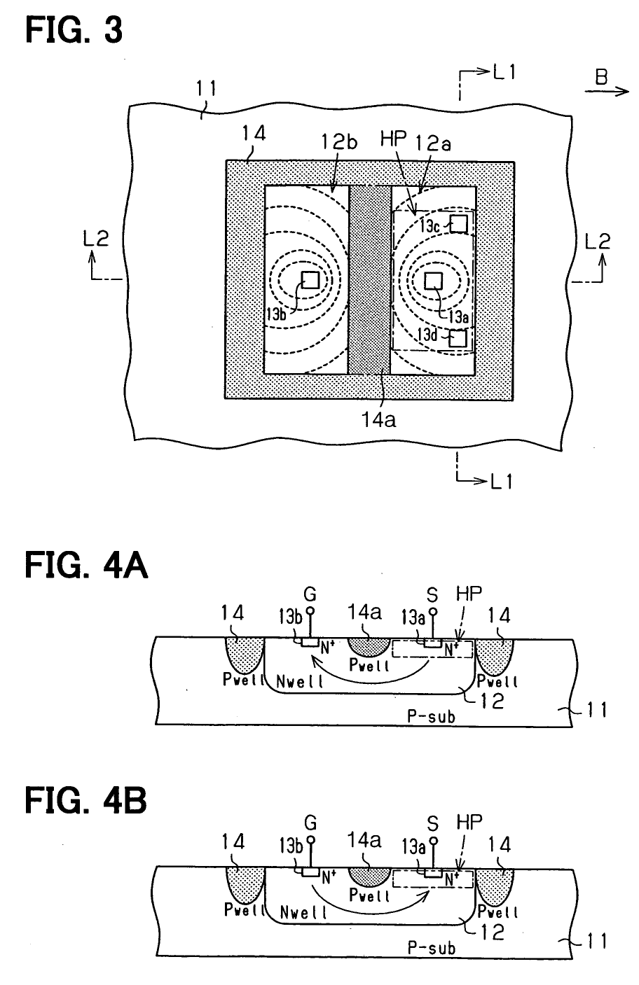

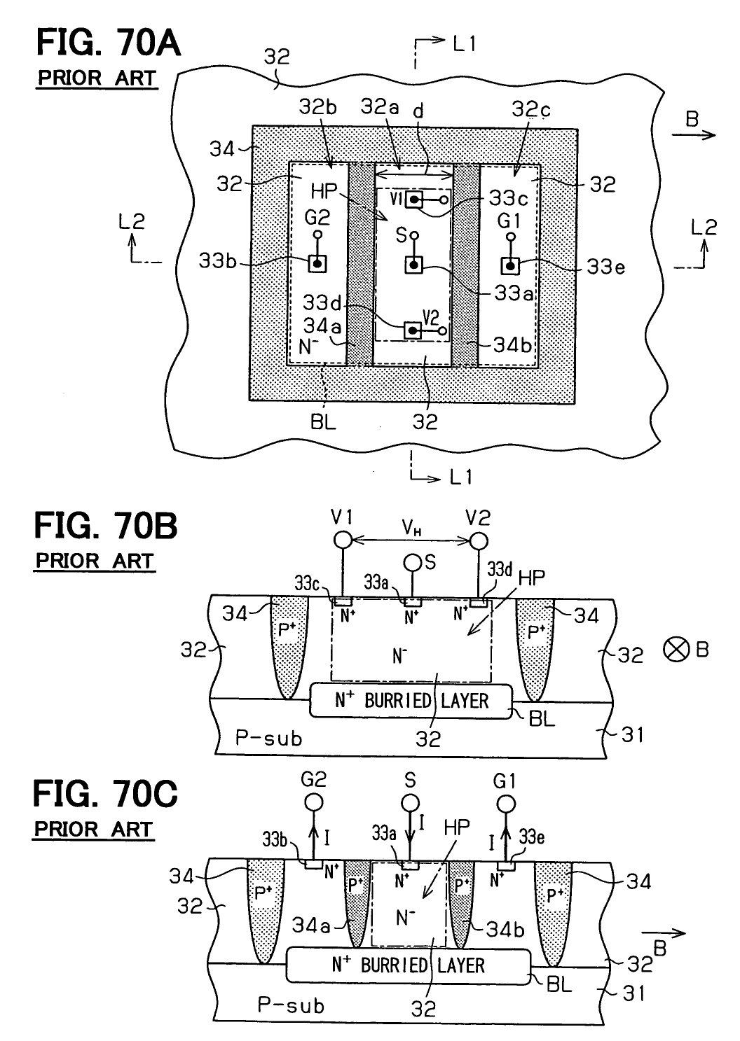

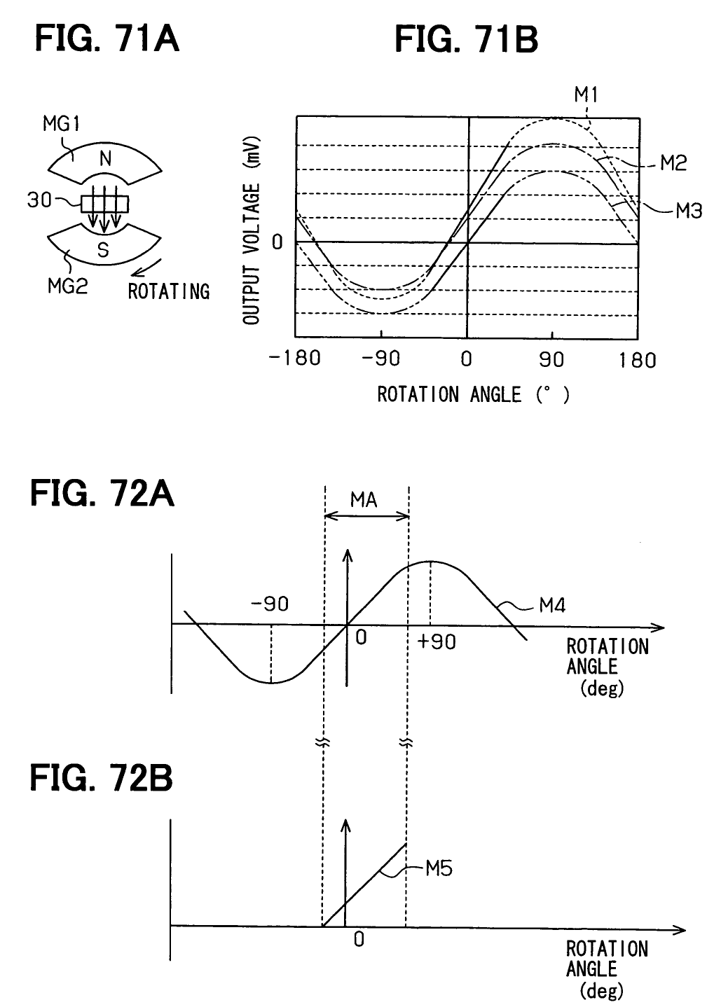

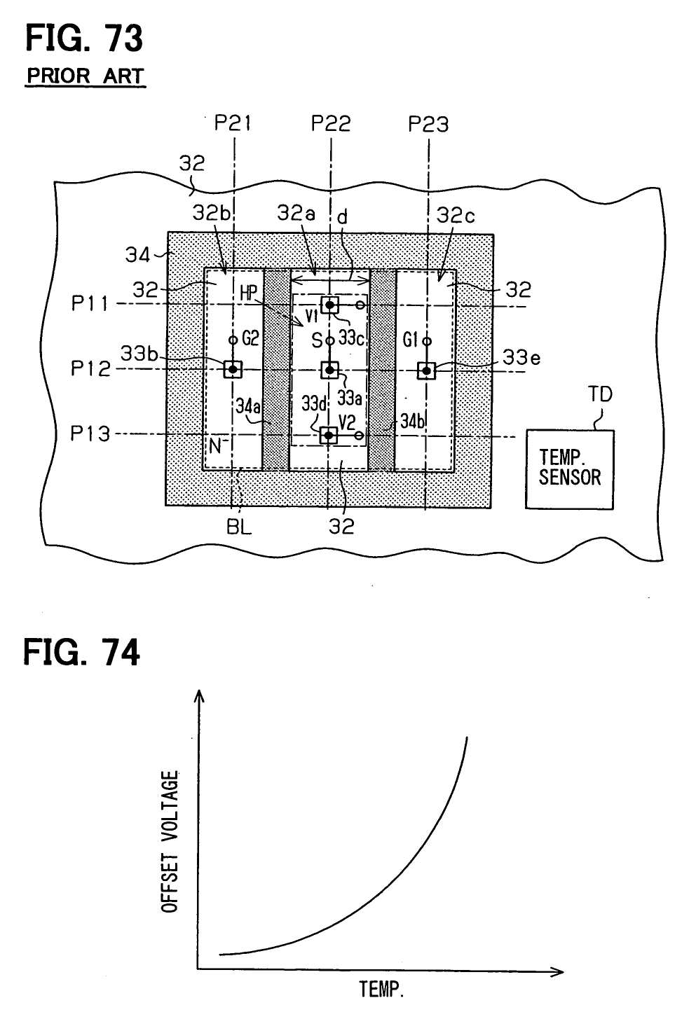

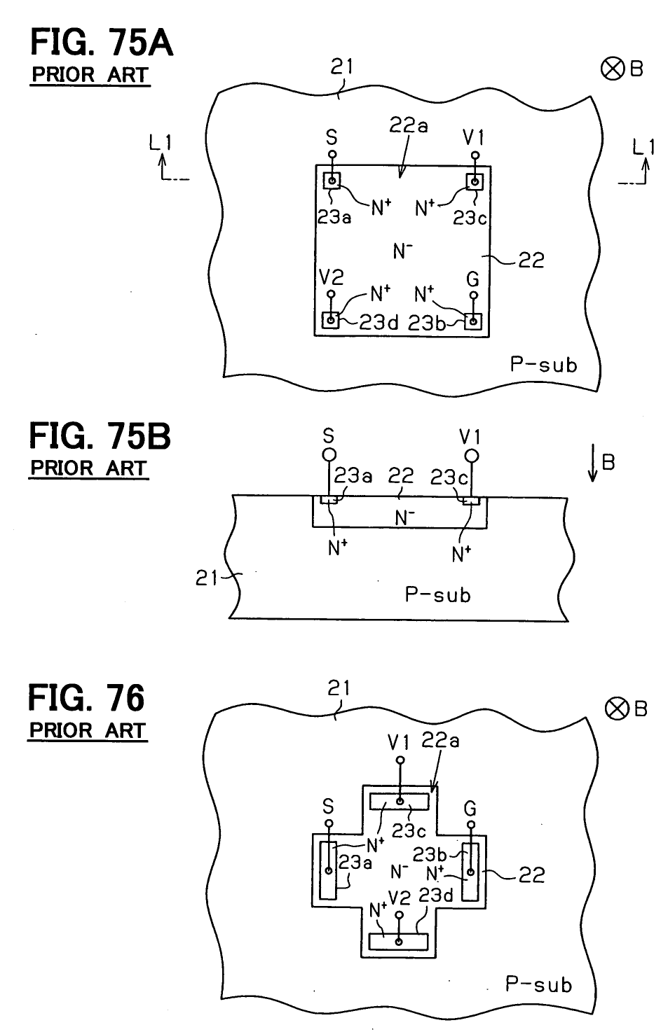

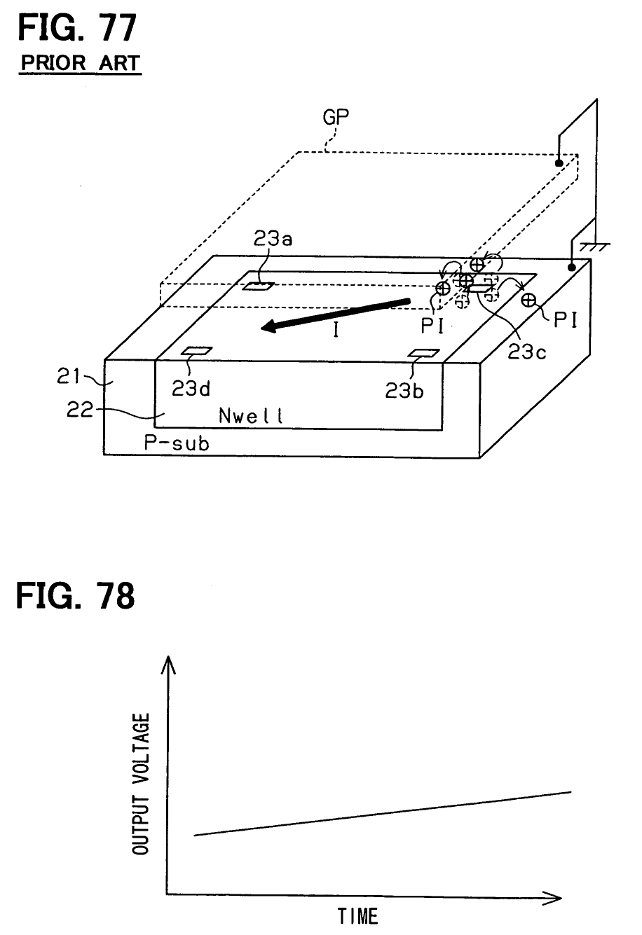

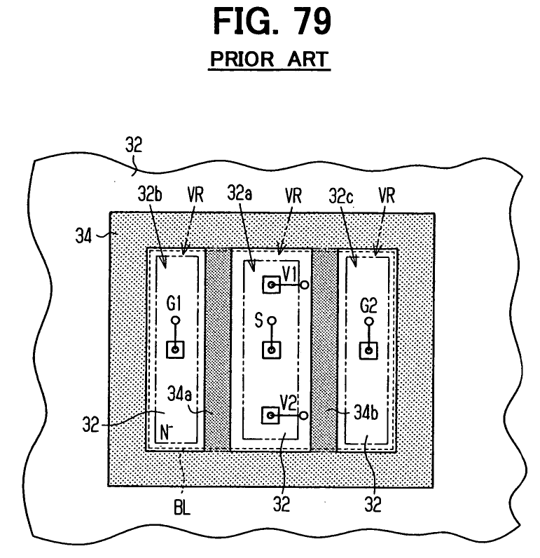

Hereinafter, a formation mode of potential distribution of the vertical Hall element according to the embodiment is described with reference to FIG. 2A and FIG. 2B and FIG. 3 by comparison with potential distribution of a conventional vertical Hall element exemplified in FIG. 70A to FIG. 70C.

FIG. 2A shows potential distribution of the conventional vertical Hall element exemplified in FIG. 70A to FIG. 70C. In the vertical Hall element, portions (i.e., contact regions 33e and 33b) for making current flow in pairs (i.e., sets) with a contact region 33a arranged in manner of being interposed by contact regions 33c and 33d provided as portions for outputting Hall voltage are provided symmetrically (i.e., axisymmetrically) with respect to an axis (line L1-L1) given by the contact regions 33c and 33d. Therefore, as shown in the FIG. 2A, in the vertical Hall element, in the periphery (i.e., region 32a) of an axis (line L1-L1) given by the contact regions 33c and 33d, potential distribution that is symmetric (i.e., axisymmetric horizontally in FIG. 2A) to the axis is formed.

On the other hand, in the vertical Hall element, when a structure in which the region 32c and the contact region 33e are omitted is used, as shown in FIG. 2B, the portion (i.e., contact region 33b) for making current flow in a pair with the contact region 33a is provided only at one side (i.e., left side of FIG. 2B) with respect to the axis (line L1-L1) given by the contact regions 33c and 33d. Therefore, potential distribution in the periphery of the axis is biased to one side; consequently potential distribution asymmetric to the axis is formed.

Since the vertical Hall element according to the embodiment has a structure similar to this, as shown in FIG. 3, potential distribution in the periphery (i.e., region 12a) of the axis (line L1-L1) given by the contact regions 13c and 13d is biased to one side, and potential distribution similarly asymmetric to the axis is formed. Moreover, as shown in the FIG. 3, the contact regions 13c and 13d are in a layout where they are displaced to a side at which equipotential lines of the asymmetric potential distribution formed as above is nondense in a mode that the contact region 13a arranged in manner of being interposed by the two regions is diverged from the axis.

Next, an operation mode of the vertical Hall element is described with reference to FIG. 4A and FIG. 4B together.

In the Hall element, for example, when constant drive current flows from the terminal S to the terminal G, the current flows from the contact region 13a formed on the substrate surface to the contact regions 13b through the magnetic detection part HP and a lower part of the diffusion layer 14a as shown in FIG. 4A. That is, current containing a component perpendicular to the substrate surface (i.e., chip surface) flows into the magnetic detection part HP. However, in the vertical Hall element, a structure in which a buried layer (see a buried layer BL in FIG. 70B) is omitted is used; thereby drive current of the element is guided to flow in an oblique direction with respect to the substrate surface at least in the magnetic detection part HP. Therefore, unlike the conventional vertical Hall element as shown in the previous FIG. 70A to FIG. 70C, in the vertical Hall element, the drive current in the magnetic detection part HP flows in the oblique direction with respect to the substrate surface, rather than a direction approximately vertical to the substrate surface.

When a magnetic field (for example, magnetic field indicated by an arrow B in FIG. 1A) containing a component parallel to the surface of the substrate is assumed to be applied to the magnetic detection part HP of the relevant Hall element, Hall voltage responding to the magnetic field is generated between the terminals V1 and V2 due to the Hall effect. Accordingly, the generated Hall voltage is detected through the terminals V1 and V2, thereby a magnetic field component as the detection object, or the magnetic field component parallel to the surface (i.e., chip surface) of the substrate used for the relevant Hall element is obtained according to the previous relational expression “V_{H}=(R_{H}IB/d)cos θ” as shown in FIG. 67. In the Hall element, a dimension d shown in FIG. 1A corresponds to thickness (“d” in the relational expression) of the magnetic detection part (i.e., Hall plate). In the Hall element, a direction along which the drive current flows can be optionally set, and for example, as shown in FIG. 4B, the Hall voltage can be detected with the drive current being reversed, that is, in a condition that the terminal G is fixed to the source potential, and the terminal S is fixed to the ground potential respectively. Also in this case, the drive current in the magnetic detection part HP flows in the oblique direction with respect to the substrate surface, rather than a direction approximately vertical to the substrate surface.

As described before, the offset voltage and sensitivity of the element are important factors in magnetic field detection using the Hall element. Decrease in offset voltage may be required much compared with the sensitivity of the element as Hall element depending on environment where the relevant element is placed, use of the Hall element, or use of the sensor using the element. In this regard, in the vertical Hall element according to the embodiment, the contact regions 13c and 13d provided as the portions for outputting Hall voltage are in the layout where they are displaced to the side at which the equipotential lines of the asymmetric potential distribution formed as above is nondense in order to diverge the contact region 13a from the axis (line L1-L1) given by the regions. That is, the contact regions 13c and 13d are placed in a region (i.e., region where potential change is gentle) where the equipotential lines are nondense, and thus potential difference between the two regions is reduced, thereby decrease in offset voltage is achieved. In this way, according to the vertical Hall element according to the embodiment, the element flexibly responds to the environment where the relevant Hall element is placed, use of the Hall element, or use of the sensor using the element, consequently optimization can be achieved.

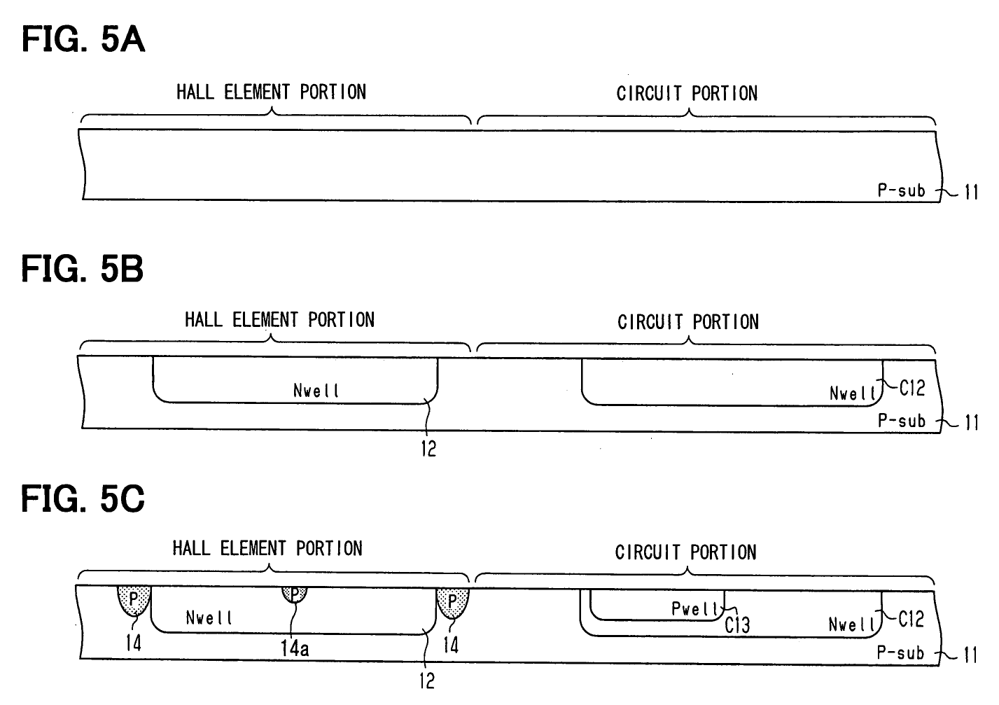

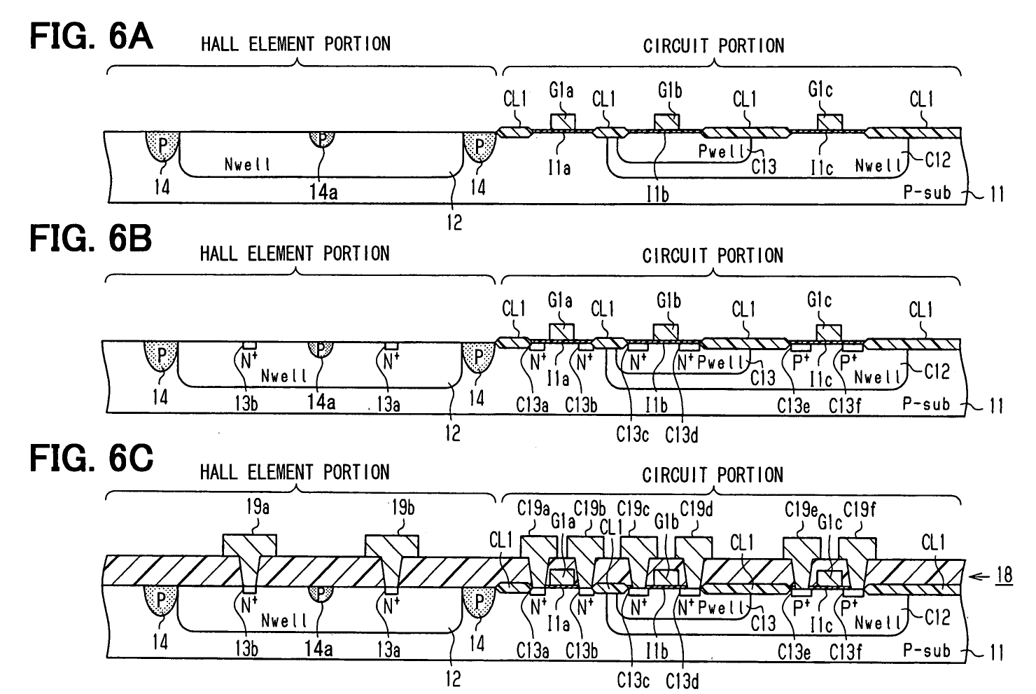

Next, a method for manufacturing the vertical Hall element according to the embodiment is described in detail with reference to FIG. 5A to FIG. 5C and FIG. 6A to FIG. 6C. Each of the figures is a cross section view corresponding to the cross section view of the previous FIG. 1C, and elements identical to the elements shown in the FIG. 1C are shown with being marked with identical signs respectively. Here, a magnetic sensor is supposed in which a signal processing circuit that is integrated into one chip together with the vertical Hall element and performs predetermined signal processing to a Hall voltage signal outputted from the element, a correction circuit that performs correction operation (i.e., operational removal) of the offset voltage are provided as peripheral circuits of the relevant Hall element. That is, a manufacturing method in the case that the peripheral circuits (i.e., circuit portion) comprising a CMOS (i.e., Complementary Metal Oxide Semiconductor) circuit and the relevant Hall element (i.e., Hall element part) are simultaneously formed is described.

In manufacturing the element, first, as shown in FIG. 5A, a substrate (i.e., semiconductor layer 11) comprising P-type silicon having a plane direction “100” is prepared. Then, as shown in FIG. 5B, ion implantation of an N-type impurity comprising, for example, phosphorus is performed to the semiconductor layer 11 using an appropriate mask patterned by, for example, photolithography, and then appropriate heat treatment is performed thereto to form N-type semiconductor regions 12 and C12 as diffusion layers (i.e., Nwells).

Then, as shown in FIG. 5C, ion implantation of a P-type impurity comprising, for example, boron is performed to desired places using an appropriate mask patterned by, for example, photolithography, and then appropriate heat treatment is performed thereto to form P-type diffusion layers (i.e., P wells) 14 and 14a, and a diffusion layer (i.e., P well) C13.

Next, in order to form a structure as shown in FIG. 6A, field oxide films (i.e., LOCOS oxide films) CL1 having the LOCOS structure are selectively formed at desired places, for example, by an well known selective oxidation method. Then, gate insulating films I1a to I1c comprising silicon oxide is formed, for example, by thermal oxidation, and then gate electrodes G1a to G1c comprising, for example, polycrystalline silicon are formed on the gate insulating films I1a to I1c, respectively.

Next, ion implantation of an N-type impurity comprising, for example, arsenic, and the P-type impurity comprising, for example, boron is performed to desired places using an appropriate mask patterned, for example, by photolithography, and then appropriate heat treatment is performed thereto. In this way, as shown in FIG. 6B, contact regions 13a to 13d (here, only contact regions 13a and 13b are shown for convenience) and source/drain layers C13a to C13f are formed. The source/drain layers C13a to C13f can be formed in a self aligning manner using the LOCOS oxide film CL1 or the gate electrodes G1a to G1c as a mask. During the formation, a sidewall or silicide is also formed as required.

Furthermore, an insulating film 18 comprising, for example, PSG (i.e., Phospho Silicate Glass) is formed thereon, for example, by thermal CVD, and contact holes are formed at desired places by appropriately patterning the insulating film 18. Then, a wiring material comprising, for example, aluminum is deposited in a manner of filling the contact holes, and the deposited wiring material is appropriately patterned. In this way, as shown in FIG. 6C, wiring lines (i.e., electrodes) 19a and 19b, and C19a to C19f are formed, which form excellent ohmic contact to the contact regions or the source/drain layers respectively. Thus, the vertical Hall element shown in the previous FIG. 1 and peripheral circuits of the element are completed.

As described hereinbefore, according to the vertical Hall element according to the embodiment, many excellent advantages as described below can be obtained.

(1) A structure is made, wherein in the periphery of the axis (line L1-L1) given by the contact regions 13c and 13d provided as the portions for outputting Hall voltage, potential distribution asymmetric to the axis is formed. The contact regions 13c and 13d are in a layout where they are displaced to the side at which equipotential lines of the asymmetric potential distribution formed in the periphery of the axis are nondense in order to diverge the contact region 13a from the axis, the region 13a being the portion that is arranged in a manner of being interposed by the two regions to supply current to the magnetic detection part HP, or draw out current from the magnetic detection part HP. Thus, the element flexibly responds to the environment where the element is placed, use of the Hall element, or use of the sensor using the element, consequently optimization of characteristics as the Hall element can be achieved.

(2) The optimization of characteristics as the Hall element leas to improvement in yield or reduction in cost of the Hall element, consequently energy saving can be achieved.

(3) A layout is made, wherein the axis given by the contact regions 13a, 13b and the axis given by the contact regions 13c, 13d are perpendicular to each other. Thus, excellent element characteristics can be obtained in a simple element design.

(4) Moreover, a structure is made, wherein the portion (i.e., contact region 13b) for making current flow in a pair with the contact region 13a is provided only at one side with respect to the axis (line L1-L1) given by the contact regions 13c and 13d. Thus, since potential distribution in the periphery of the axis is biased to one side, asymmetric potential distribution with respect to the axis is easily formed. In addition, in this case, since the portion for making current flow in a pair with the contact region 13a is provided only at one side with respect to the axis, area of the relevant Hall element is naturally small, consequently reduction in size as the Hall element can be achieved.

The two portions for outputting Hall voltage, the portion that is disposed in a manner of being interposed by the two portions and supplies current to the magnetic detection part or draw out current from the magnetic detection part, and a portion for making current flow in a pair with the portion are all provided as regions formed in a manner of selectively increasing impurity concentration of the substrate surface. Thus, excellent ohmic contact is formed to the electrode (i.e., wiring line) arranged on each of the regions for supplying or drawing out current, or detecting Hall voltage.

(6) A structure is made, wherein current containing a component perpendicular to the substrate surface (i.e., chip surface) is guided to flow in an oblique direction with respect to the substrate surface in the magnetic detection part HP. Thus, the original function as the vertical Hall element of generating the Hall voltage responding to the magnetic field component parallel to the substrate surface is maintained without causing change of potential distribution within the element or complicated element structure due to preparation of the buried layer.

(7) A magnetic sensor for detecting a magnetic field applied from a predetermined direction is configured by integrating the relevant vertical Hall element into one chip together with the signal processing circuit that performs predetermined signal processing to the Hall voltage signal outputted from the relevant Hall element, thereby a magnetic sensor preferably used for the angle detection sensor can be also realized.

### Second Embodiment

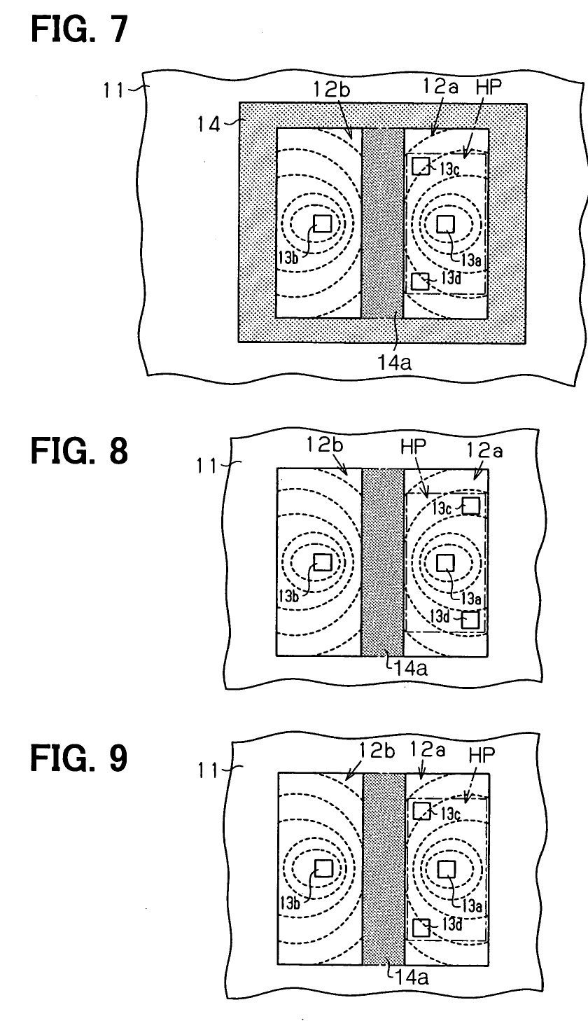

FIG. 7 shows a second embodiment of a vertical Hall element according to the invention.

Hereinafter, a structure of the vertical Hall element according to the embodiment is described with reference to FIG. 7 mainly on different points from the previous first embodiment. A plan view of the FIG. 7 corresponds to the plan view of the previous FIG. 1A, and respective elements identical to the elements shown in the FIG. 1A are shown with being marked with identical signs, and overlapped description on the elements is omitted.

As shown in the FIG. 7, the vertical Hall element has the approximately same structure as the vertical Hall element of the previous first embodiment exemplified in FIG. 1A to FIG. 1C, in addition, an operation mode of the element is the same as the mode described before. That is, in the vertical Hall element, a structure is made, wherein in the periphery of the axis (line L1-L1) given by the contact regions 13c and 13d provided as the portions for outputting Hall voltage, potential distribution asymmetric to the axis is formed. However, in the embodiment, the contact regions 13c and 13d are in a layout where they are displaced to a side, at which equipotential lines of the asymmetric potential distribution formed as above is dense, in order to diverge the contact region 13a from the axis, the region 13a being arranged in a manner of being interposed by the contact regions 13c and 13d.

Improvement in sensitivity of the element may be required much compared with decrease in offset voltage depending on environment where the element is placed, use of the Hall element, or use of the sensor using the element. In this regard, according to the layout, the contact regions 13c and 13d are placed in a region at which the equipotential lines are dense, or a region at which change of potential is large (i.e., steep), thereby large voltage (i.e., potential difference) is outputted from the two regions. That is, improvement in sensitivity as the Hall element can be achieved. In this way, according to the vertical Hall element according to the embodiment, the element flexibly responds to the environment where it is placed, use of the Hall element, or use of the sensor using the element, consequently optimization can be achieved.

As described hereinbefore, according to the vertical Hall element according to the embodiment, advantages equal or similar to the advantages of the above (1) to (7) according to the previous first embodiment can be obtained.

### Third Embodiment

FIG. 8 shows a third embodiment of a vertical Hall element according to the invention.

Hereinafter, a structure of the vertical Hall element according to the embodiment is described with reference to FIG. 8 mainly on different points from the previous first embodiment. A plan view of FIG. 8 corresponds to the plan view of the previous FIG. 1A, and respective elements identical to the elements shown in FIG. 1A are shown with being marked with identical signs, and overlapped description on the elements is omitted.

As shown in the FIG. 8, the vertical Hall element has the approximately same structure as the vertical Hall element of the previous first embodiment exemplified in FIG. 1A to FIG. 1C, and an operation mode of the element is also the same as the mode described before. However, in the embodiment, a structure is made, wherein the diffusion layer 14 provided for isolating the relevant Hall element from other elements is omitted. Thus, simplification of the structure as the Hall element, and reduction in size (i.e., reduction in area) can be achieved. Moreover, as shown in FIG. 9, even in the case that a structure is used, wherein the diffusion layer 14 is omitted in the vertical Hall element of the previous second embodiment, the same effects can be obtained. In those vertical Hall elements, the semiconductor layer 11 performs isolation instead of the omitted diffusion layer 14.

As described hereinbefore, according to the vertical Hall element according to the embodiment, advantages equal or similar to the advantages of the above (1) to (7) according to the previous first embodiment can be obtained; in addition, the following advantage can be obtained.

(8) A structure is made, wherein the diffusion layer 14 provided for isolating the relevant Hall element from other elements is omitted. Thus, simplification of the structure as the Hall element, and reduction in size (i.e., reduction in area) can be achieved.

### Fourth Embodiment

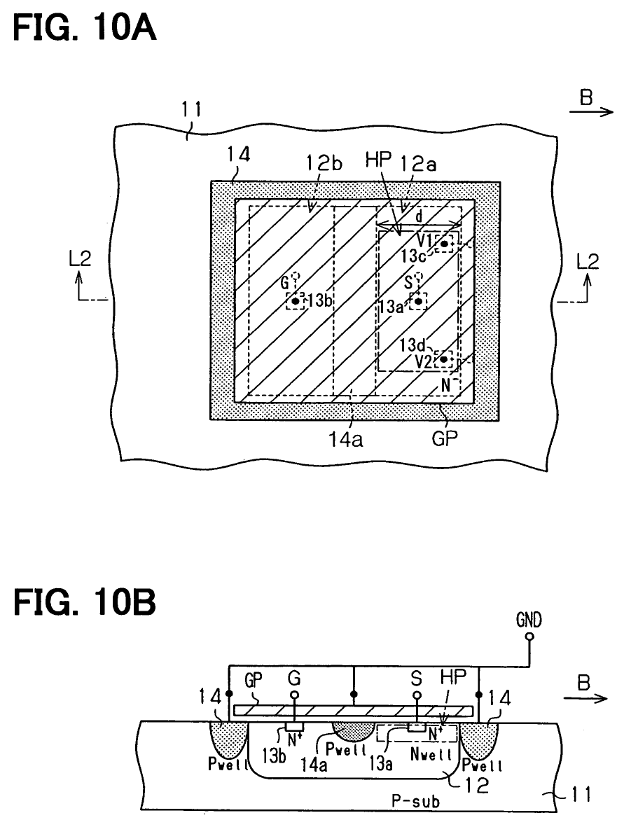

FIG. 10A and FIG. 10B show a fourth embodiment of a vertical Hall element according to the invention.

Hereinafter, a structure of the vertical Hall element according to the embodiment is described with reference to FIG. 10A and FIG. 10B mainly on different points from the previous first embodiment. A plan view of FIG. 10A corresponds to the plan view of the previous FIG. 1A, and FIG. 10B is a cross section view along a line L2-L2 of FIG. 10A. In each of fugues, elements identical to the elements shown in FIG. 1A and FIG. 1B are shown with being marked with identical signs respectively, and overlapped description on the elements is omitted.

As shown in the FIG. 10A and FIG. 10B, the vertical Hall element has the approximately same structure as the vertical Hall element of the previous first embodiment exemplified in FIG. 1A to FIG. 1C, and an operation mode of the element is also the same as the mode described before. However, in the embodiment, a structure is made, wherein a conductor plate GP comprising, for example, aluminum or polycrystalline silicon, which is fixed to predetermined potential (for example, ground potential), is provided in a manner of covering the element surface. The diffusion layer 14 is also fixed to predetermined potential (for example, ground potential).

In the vertical Hall element, movable ions such as sodium (i.e., Na) ions exist within an interlayer insulating film (for example, insulating film 18 as shown in FIG. 6) formed on the element surface. Therefore, the movable ions move in accordance with current application to the relevant Hall element or temperature change, which may fluctuate an extremely small Hall voltage signal outputted from the element. Such fluctuation of output voltage causes error in detection of a magnetic field based on the voltage, in particular, when the relevant Hall element is used for the angle detection sensor, deterioration of characteristics of the sensor is inevitable, which is a serious issue. In this regard, in the vertical Hall element according to the embodiment, the conductor plate GP is provided, or the diffusion layer 14 is fixed to predetermined potential, thereby potential at the element surface is fixed, and the periphery of the surface is also in stable potential environment. Therefore, movement of the movable ions is suppressed, and the fluctuation of the output voltage due to the movable ions is reduced, consequently detection accuracy as the Hall element can be maintained high. Furthermore, since the conductor plate GP also functions as shield against noise from the upside of the element, durability to noise of the relevant Hall element can be improved.

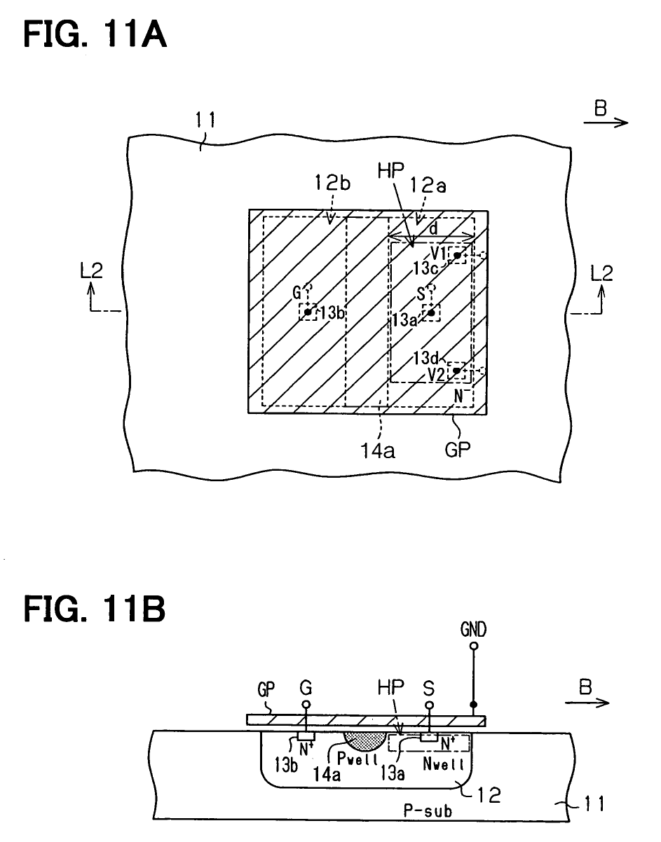

When the conductor plate GP is used for the vertical Hall element of the previous third embodiment, as shown in FIG. 11A and FIG. 11B, the same or similar advantages are obtained. While omitted to be shown, when it is used for the vertical Hall element of the second embodiment, the advantages are also obtained.

As described hereinbefore, according to the vertical Hall element according to the embodiment, advantages equal or similar to the advantages of the above (1) to (7) according to the previous first embodiment can be obtained; in addition, the following advantage can be obtained.

(9) A structure is made, wherein a conductor plate GP fixed to predetermined potential is provided in a manner of covering the element surface. Thus, detection accuracy as the Hall element is maintained high. Furthermore, durability to noise of the relevant Hall element is improved.

### Fifth Embodiment

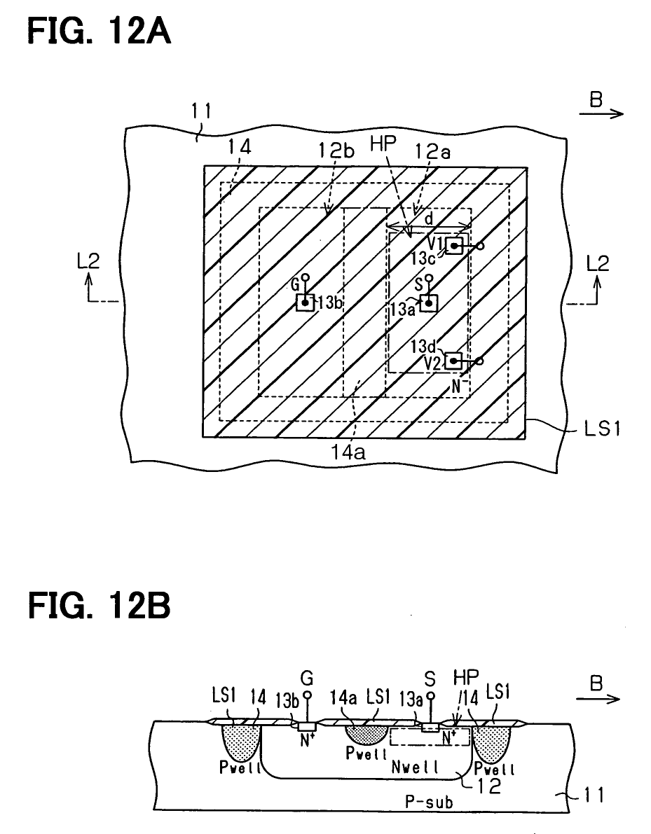

FIG. 12A and FIG. 12B shows a fifth embodiment of a vertical Hall element according to the invention.

Hereinafter, a structure of the vertical Hall element according to the embodiment is described with reference to FIG. 12A and FIG. 12B mainly on different points from the previous first embodiment. A plan view of FIG. 12A corresponds to the plan view of the previous FIG. 1A, and FIG. 12B is a cross section view along a line L2-L2 of FIG. 12A. In each of the fugues, elements identical to the elements shown in FIG. 1A to FIG. 1C are shown with being marked with identical signs respectively, and overlapped description on the elements is omitted.

As shown in the FIG. 12A and FIG. 12B, the vertical Hall element has the approximately same structure as the vertical Hall element of the previous first embodiment exemplified in FIG. 1A to FIG. 1C, and an operation mode of the element is also the same as the mode described before. However, in the embodiment, a structure is made, wherein a LOCOS oxide film LS1 is formed in a manner of covering the element surface, for example, by the well known selective oxidation method.

As described before, behavior of the movable ions contained in the interlayer insulating film on the substrate surface has an effect on the detection accuracy of the relevant Hall element. In this regard, according to the vertical Hall element according to the embodiment, the LOCOS oxide film LS1 covers the element surface, thereby the surface is protected, and consequently the effect of the movable ions, or reduction in detection accuracy is suppressed. In addition, the element surface is protected by the LOCOS oxide film LS1, thereby even if, after the element is formed, ion implantation treatment, plasma treatment or the like is performed onto the entire surface of the substrate as a manufacturing process of peripheral circuits of the element, damage to the relevant Hall element due to the treatment is reduced. An appropriate oxide film or insulating film can be used instead of the LOCOS oxide film LS1.

As described hereinbefore, according to the vertical Hall element according to the embodiment, advantages equal or similar to the advantages of the above (1) to (7) according to the previous first embodiment can be obtained; in addition, the following advantage can be obtained.

(10) The structure in which the LOCOS oxide film LS1 is formed in a manner of covering the substrate surface is made. Thus, the effect of the movable ions, or reduction in detection accuracy is preferably suppressed. In addition, since the element surface is protected, damage to the element surface during a manufacturing process is preferably reduced.

### Sixth Embodiment

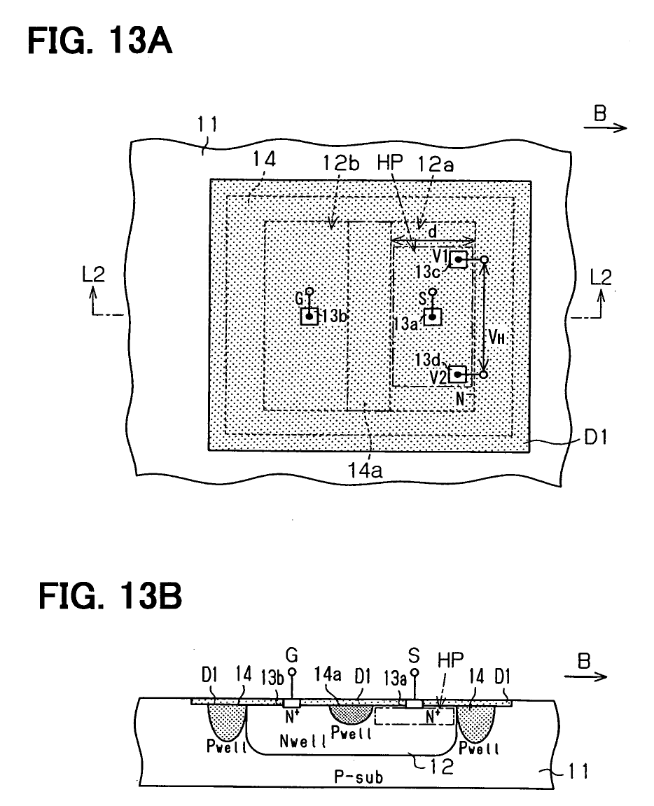

FIG. 13 shows a sixth embodiment of a vertical Hall element according to the invention.

Hereinafter, a structure of the vertical Hall element according to the embodiment is described with reference to FIG. 13A and FIG. 13B mainly on different points from the previous first embodiment. A plan view of FIG. 13A corresponds to the plan view of the previous FIG. 1A, and FIG. 13B is a cross section view along a line L2-L2 of FIG. 13A. In each of the fugues, elements identical to the elements shown in FIG. 1A and FIG. 1B are shown with being marked with identical signs respectively, and overlapped description on the elements is omitted.

As shown in the FIG. 13A and FIG. 13B, again, the vertical Hall element has the approximately same structure as the vertical Hall element of the previous first embodiment exemplified in FIG. 1A to FIG. 1C, and an operation mode of the element is also the same as the mode described before. However, in the embodiment, a structure is made, wherein a diffusion region D1 into which a P-type conductivity type impurity is introduced, for example, by introducing a P-type impurity comprising, for example, boron is formed in a manner of covering the element surface.

As described before, behavior of the movable ions contained in the interlayer insulating film on the substrate surface has an effect on the detection accuracy of the relevant Hall element. In this regard, according to the vertical Hall element according to the embodiment, for example, the element is placed in a condition that reverse bias voltage is applied between the diffusion region D1 and the semiconductor region 12, thereby the element surface is protected by a depletion layer near PN junction formed by the applied voltage, consequently the effect of the movable ions, or reduction in detection accuracy is suppressed.

As described hereinbefore, according to the vertical Hall element according to the embodiment, advantages equal or similar to the advantages of the above (1) to (7) and (10) according to the previous first or fifth embodiment can be obtained; in addition, the following advantage can be obtained.

### Seventh Embodiment

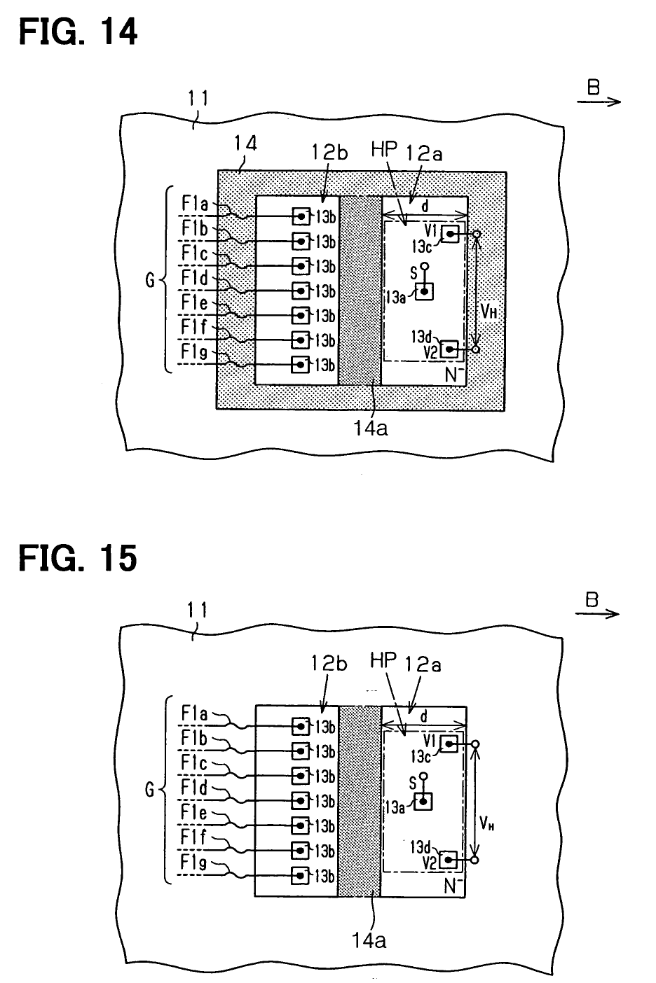

FIG. 14 shows a seventh embodiment of a vertical Hall element according to the invention.

Hereinafter, a structure of the vertical Hall element according to the embodiment is described with reference to FIG. 14 mainly on different points from the previous first embodiment. A plan view of FIG. 14 also corresponds to the plan view of the previous FIG. 1A, and elements identical to the elements shown in FIG. 1A are shown with being marked with identical signs respectively, and overlapped description on the elements is omitted.

As shown in the FIG. 14, the vertical Hall element has the approximately same structure as the vertical Hall element of the previous first embodiment exemplified in FIG. 1A, and an operation mode of the element is also the same as the mode described before. However, in the embodiment, a plurality of the contact regions 13b for making current flow in pairs with the contact region 13a are provided, and each of the contact regions 13b is fixed to predetermined potential (for example, ground potential) via a wiring line arranged in a manner that part of the wiring line (i.e., fuses F1a to F1g which are self-disconnected by overcurrent) can be disconnected.

According to such a structure, the plurality of wiring materials (i.e., fuse portions) are appropriately disconnected, and then a desired one or desired combination can be selected from the plurality of contact regions 13b. When positions or the number of the contact regions 13b are/is changed by the disconnection, potential distribution within the element is accordingly changed. Therefore, when the disconnection is appropriately performed, desired potential distribution can be obtained as potential distribution within the element. In this way, in the vertical Hall element according to the embodiment, for example, even when unbalance occurs in the potential distribution within the element due to alignment displacement during a manufacturing process, it can be appropriately corrected to preferably reduce the offset voltage (i.e., unbalanced voltage). Moreover, even in a configuration having a correction circuit for correction operation on the offset voltage, since a voltage level corresponding to the correction is reduced, reduction in circuit scale of the correction circuit can be achieved. Moreover, as shown in FIG. 15, even in such a structure, it can be formed as the structure in which the diffusion layer 14 is omitted.

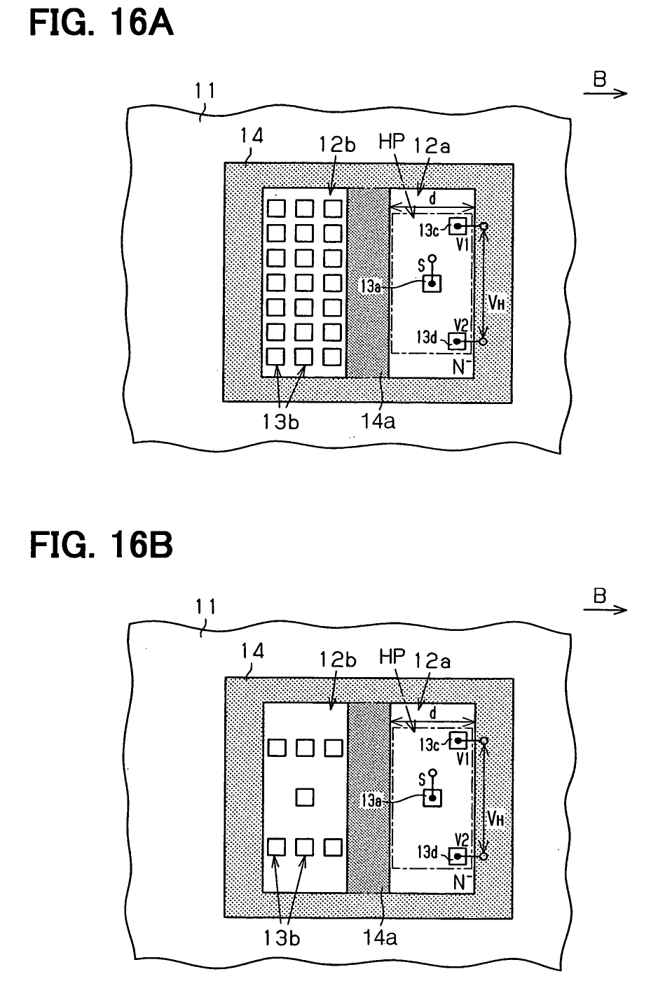

As shown in FIG. 16A, the plurality of contact regions 13b can be arrayed in a lattice having columns and rows. According to such a structure, for each of the regions arrayed in a lattice, a wiring material to be disconnected is appropriately selected from wiring materials arranged on the regions respectively, thereby the offset voltage can be preferably corrected or reduced with flexibly responding to various patterns of potential distribution within the element. Moreover, as shown in FIG. 16B, even in a layout where spaces are provided at desired places in the lattice having columns and rows, advantages similar to the advantages are obtained. In each of the figures, fuses are omitted to be shown for convenience of description.

As described hereinbefore, according to the vertical Hall element according to the embodiment, advantages equal or similar to the advantages of the above (1) to (7) according to the previous first embodiment can be obtained; in addition, the following advantage can be obtained.

(11) A plurality of contact regions 13b for making current flow in pairs with the contact region 13a are provided, and each of the contact regions 13b is fixed to predetermined potential (for example, ground potential) via a wiring material arranged in a manner that part of the material (i.e., fuses F1a to F1g) can be disconnected. Thus, even when unbalance occurs in the potential distribution within the element due to alignment displacement during the manufacturing process, it can be appropriately corrected to preferably reduce the offset voltage (i.e., unbalanced voltage). Moreover, even in a configuration having a correction circuit for correction operation on the offset voltage, since a voltage level corresponding to the correction is reduced, reduction in circuit scale of the correction circuit can be achieved.

### Eighth Embodiment

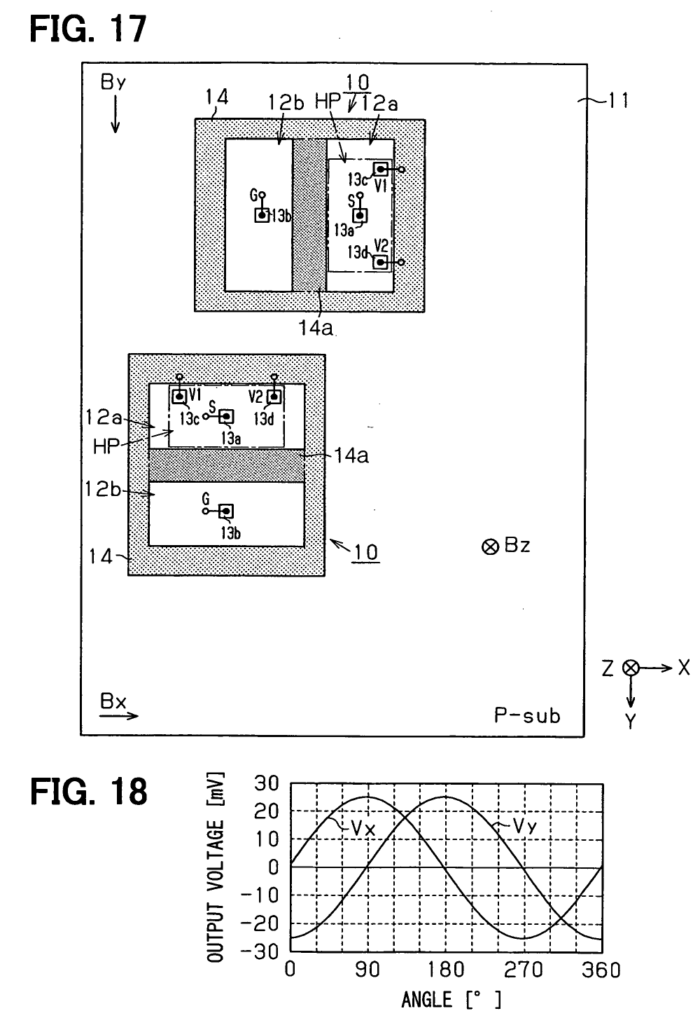

FIG. 17 and FIG. 18 show an eighth embodiment of a vertical Hall element according to the invention.

First, a structure of the vertical Hall element according to the embodiment, more accurately a configuration of a magnetic sensor using the vertical Hall element is described with reference to FIG. 17. In a plan view of the FIG. 17, elements identical to the elements shown in FIG. 1A are shown with being marked with identical signs respectively, and overlapped description on the elements is omitted.

As shown in FIG. 17, in the embodiment, two vertical Hall elements 10, arranged in a mode of detecting magnetic fields applied in biaxial directions perpendicular to each other (for example, magnetic field indicated by arrows Bx and By in FIG. 17), that is, arranged in a manner of being perpendicular to each other, are integrated into one chip to configure a magnetic sensor. Both of the two vertical Hall elements 10 are vertical Hall elements having the structure shown in the previous FIG. 1A to FIG. 1C.

FIG. 18 is a graph showing output waveforms Vx and Vy of Hall voltage signals outputted from the two vertical Hall elements arranged in a manner of being perpendicular to each other. Angles in the horizontal axis indicate angles of magnetic fields applied to the Hall elements.

As seen from the graph of FIG. 18, by using such Hall voltage signals, more accurately, by performing appropriate signal processing (i.e., calculation) to the Hall voltage signals, for example, through a signal processing circuit provided as a periphery circuit, magnetic field detection in all directions on a plane, or magnetic field detection in a wide angle of 360 degrees is enabled.

Regarding the two vertical Hall elements integrated into one chip in this way, since it is concerned that pairing performance of the elements is deteriorated due to variation in various conditions during the manufacturing process of the elements, it is preferable that an interval between the two is decreased at maximum, and for example, they are disposed within an interval of “100 μm.” According to such a layout, variation between the two due to the manufacturing process is suppressed, consequently excellent pairing performance is obtained.

As described hereinbefore, according to the vertical Hall element according to the embodiment, advantages equal or similar to the advantages of the above (1) to (7) according to the previous first embodiment can be obtained; in addition, the following advantage can be obtained.

(12) Two vertical Hall elements 10 are integrated into one chip in a mode of detecting magnetic fields applied in biaxial directions perpendicular to each other to configure a magnetic sensor. Thus, a high-performance magnetic sensor that enables the magnetic field detection in a wide angle of 360 degrees can be realized.

### Ninth Embodiment

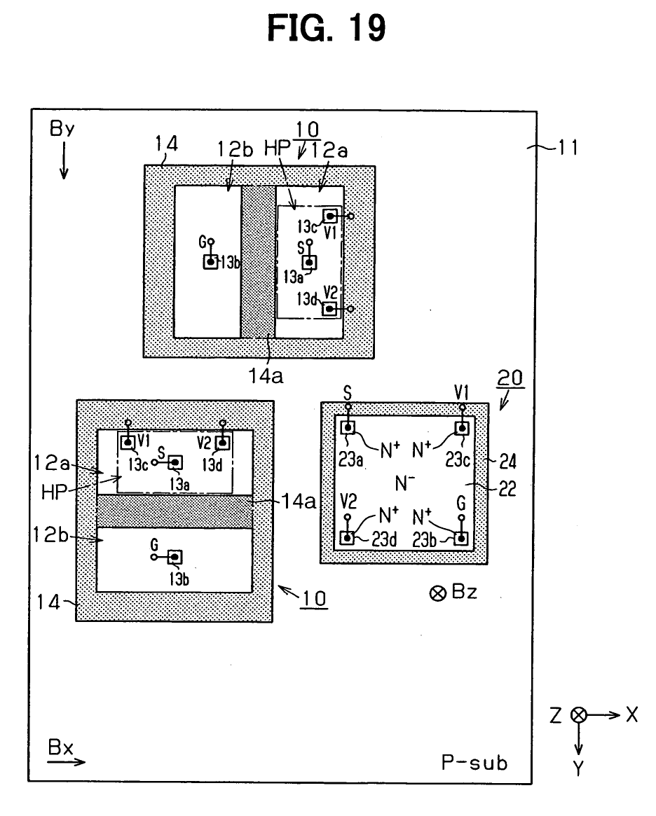

FIG. 19 shows a ninth embodiment of a vertical Hall element according to the invention.

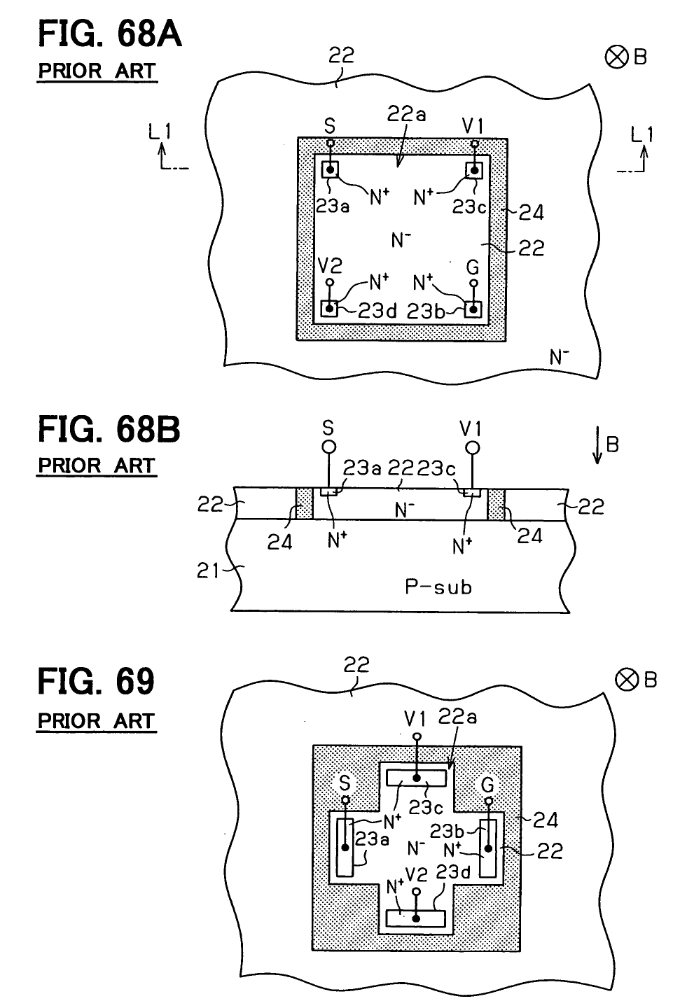

Hereinafter, a structure of the vertical Hall element according to the embodiment, more accurately a configuration of a magnetic sensor using the vertical Hall element is described with reference to the FIG. 19. In a plan view of the FIG. 19, elements identical to the elements shown in FIG. 1A and FIGS. 68A and 68B are shown with being marked with identical signs respectively, and overlapped description on the elements is omitted.

As shown in the FIG. 19, in the embodiment, two vertical Hall elements 10 disposed perpendicularly to each other are integrated into one chip together with a horizontal Hall element 20 that detects a magnetic field perpendicular to the substrate surface (i.e., chip surface) to configure a three-dimensional magnetic sensor for detecting magnetic fields in triaxial directions perpendicular to one another (for example, magnetic fields indicated by arrows Bx, By and Bz in FIG. 19). Herein, the vertical Hall elements 10 are the vertical Hall elements having the structure exemplified in the previous FIG. 1A. The horizontal Hall element is not limited to the horizontal Hall element 20 having the structure exemplified in the previous FIG. 68A and FIG. 68B, and an appropriate horizontal Hall element can be used.

In the magnetic sensor having such a configuration, for example, appropriate signal processing (i.e., calculation) is performed to the Hall voltage signal outputted from each of the Hall elements through a signal processing circuit provided as a periphery circuit, thereby magnetic field detection in all directions on one plane (i.e., two-dimensional direction) is canceled, in addition, detection of magnetic field (i.e., arrow Bz) in an axial direction perpendicular to them is enabled. That is, so-called three-dimensional magnetic field detection can be realized.

As described hereinbefore, according to the vertical Hall element according to the embodiment, advantages equal or similar to the advantages of the above (1) to (7) according to the previous first embodiment can be obtained; in addition, the following advantage can be obtained.

(13) The two vertical Hall elements 10 disposed perpendicularly to each other are integrated into one chip together with the horizontal Hall element 20 that detects the magnetic field perpendicular to the substrate surface (i.e., chip surface) to configure the three-dimensional magnetic sensor for detecting magnetic fields in triaxial directions perpendicular to one another. This enables three-dimensional magnetic field detection.

### Tenth Embodiment

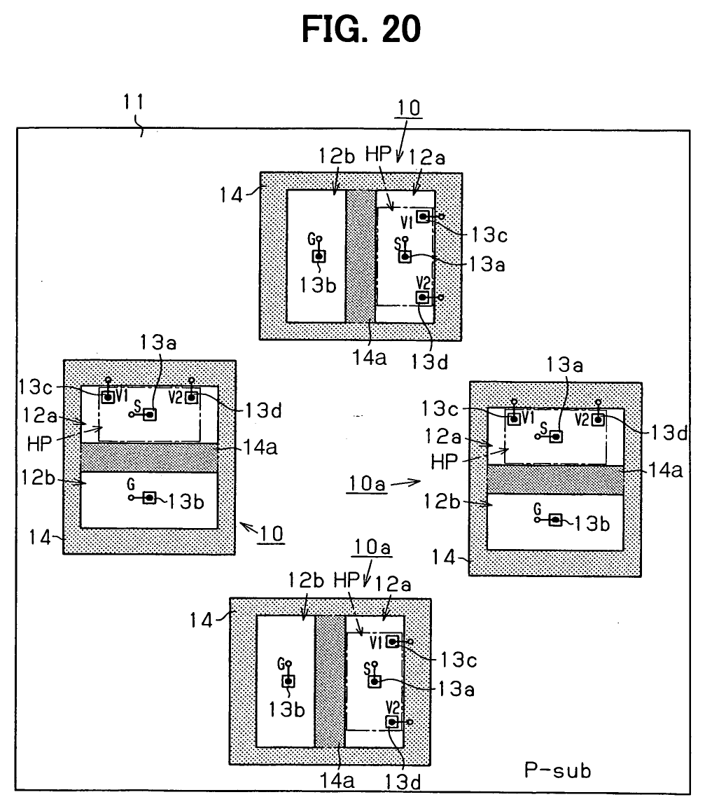

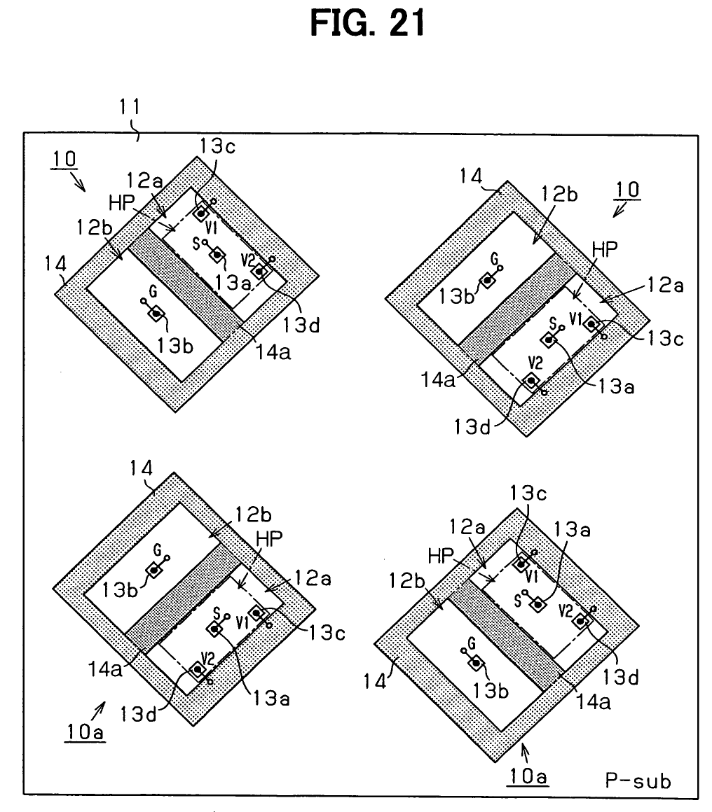

FIG. 20 and FIG. 21 show a tenth embodiment of a vertical Hall element according to the invention.

Hereinafter, a structure of the vertical Hall element according to the embodiment, more accurately a configuration of a magnetic sensor using the vertical Hall element is described with reference to FIG. 20 and FIG. 21 mainly on different points from the previous eighth embodiment. In plan views of the FIG. 20 and FIG. 21, elements identical to the elements shown in FIG. 1A are shown with being marked with identical signs respectively, and overlapped description on the elements is omitted.

As shown in the FIG. 20, in the embodiment, two vertical Hall elements 10 (i.e., vertical Hall elements having the structure shown in the previous FIG. 1A to FIG. 1C) arranged in a mode of detecting magnetic fields applied in biaxial directions perpendicular to each other, that is, arranged in a manner of being perpendicular to each other, are integrated into one chip to configure a magnetic sensor. However, herein, each of the two vertical Hall elements 10 is formed as a pair with another vertical Hall element 10a (i.e., it is also the vertical Hall element having the structure shown in the previous FIG. 1A to FIG. 1C) formed in a manner of facing in the same direction. By using such a configuration, detection accuracy as the magnetic sensor can be improved by averaging output voltage (i.e., Hall voltage) of the two vertical Hall elements in pairs which are disposed oppositely to each other, or by changing output of the vertical Hall elements one to another.

As shown in FIG. 21, either of pairs formed by the two vertical Hall elements 10 is disposed with being inclined at approximately 45 degrees with respect to a side face of a substrate cut out as a chip, thereby the various types of mechanical stress applied from the outside of the element are hardly affected thereon. That is, the offset voltage of each of the Hall elements is preferably reduced, consequently detection accuracy as the magnetic sensor is further improved.

As described hereinbefore, according to the vertical Hall element according to the embodiment, advantages equal or similar to the advantages of the above (1) to (7) and (12) according to the previous first or eighth embodiment can be obtained; in addition, the following advantage can be obtained.

(14) Each of the two vertical Hall elements 10, which are integrated into a one chip in a manner of being perpendicular to each other, is formed as a pair with another vertical Hall element 10a formed in a manner of facing in the same direction. Thus, detection accuracy as the magnetic sensor can be improved.

(15) Moreover, either of pairs formed by the two vertical Hall elements 10 is disposed with being inclined at approximately 45 degrees with respect to the side face of the substrate cut out as the chip, thereby detection accuracy as the magnetic sensor is further improved.

### Eleventh Embodiment

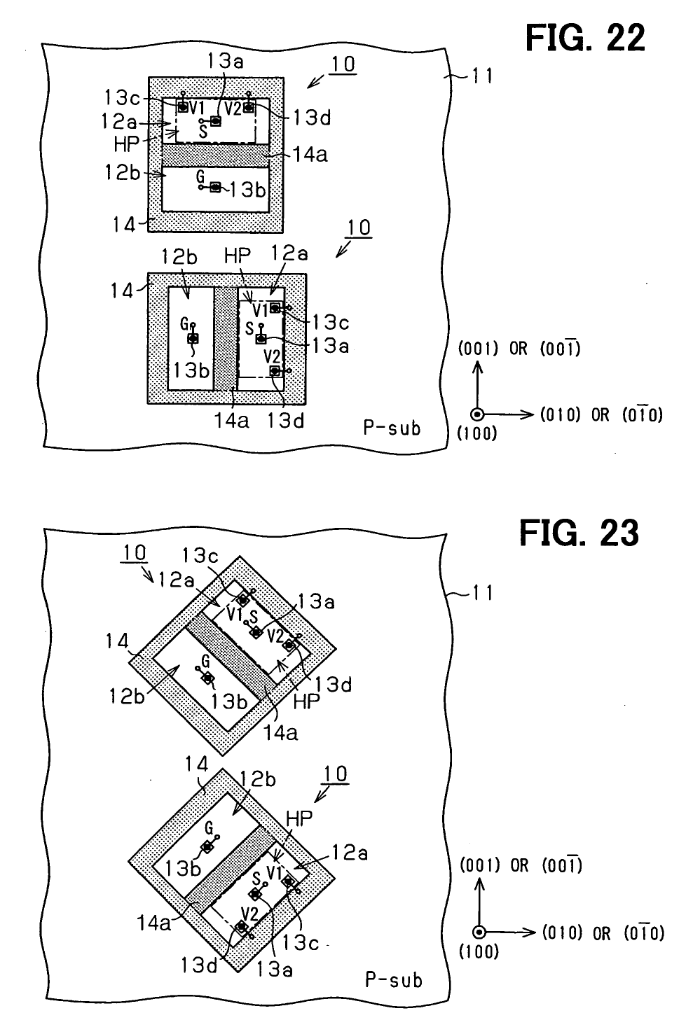

FIG. 22 to FIG. 25 show an eleventh embodiment of a vertical Hall element according to the invention.

First, a structure of the vertical Hall element according to the embodiment, more accurately a configuration of a magnetic sensor using the vertical Hall element is described with reference to FIG. 22. In a plan view of the FIG. 22, elements identical to the elements shown in FIG. 1A are shown with being marked with identical signs respectively, and overlapped description on the elements is omitted.

As shown in the FIG. 22, in the embodiment, two vertical Hall elements 10 (i.e., vertical Hall elements having the structure shown in the previous FIG. 1A to FIG. 1C), arranged in a mode of detecting magnetic fields applied in biaxial directions perpendicular to each other, that is, arranged in a manner of being perpendicular to each other, are integrated into one chip (i.e., one substrate) to configure a magnetic sensor. However, herein, the two vertical Hall elements 10 are arranged in a crystal orientation where atomic arrangement of a substrate of them is equalized, that is, arranged in crystal orientations of (001)or (00-1) and (010)or (0-10), respectively. Here, a case of using a substrate comprising silicon (i.e., silicon substrate) is supposed.

Generally, the output voltage of the Hall element (i.e., Hall voltage) is in proportion to carrier mobility of the magnetic detection part HP. The carrier mobility tends to depend on a crystalline structure (more specifically atomic arrangement). Similarly, the effects of the piezoresistance effect along with various types of mechanical stress applied from the outside of the element tend to depend on the crystalline structure. Therefore, when a plurality of Hall elements are integrated into one chip (i.e., one substrate), which crystal orientation (i.e., plane orientation) of the substrate the Hall elements are arranged in is important. In this regard, as the vertical Hall element according to the embodiment, when the vertical Hall elements 10 are arranged in a crystal orientation for equalizing atomic arrangement of the substrate, excellent pairing performance is given for the vertical Hall elements 10. That is, with regard to the Hall voltage (i.e., output voltage) generated in the vertical Hall elements 10 or the piezoresistance effect responding to the external stress, variation among the Hall elements is suppressed, consequently excellent detection accuracy as the magnetic sensor is obtained.

In the silicon substrate, the crystal orientation for equalizing atomic arrangement of the substrate is not limited to those exemplified in FIG. 22. As well known, since single crystal silicon is a material of the diamond structure (i.e., tetrahedron structure), it has the same atomic arrangement at crystal orientations of (001), (00-1), (010) and (0-10). That is, even when the following configuration is made: as shown in FIG. 23,

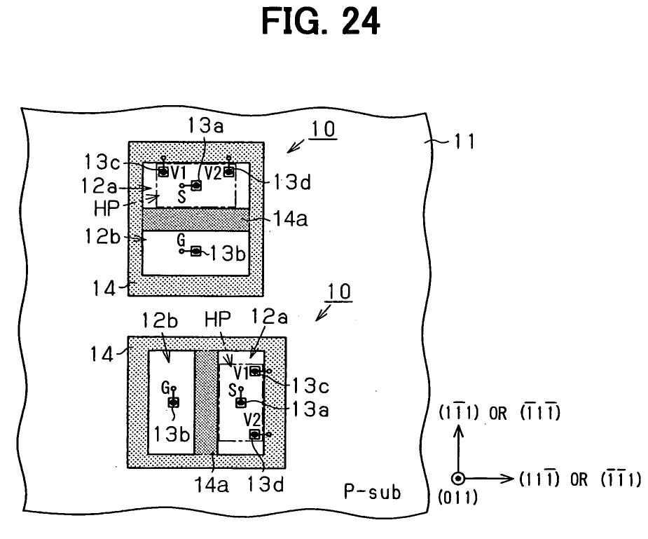

a configuration where the two vertical Hall elements 10 are arranged in a crystal orientation (011) or (0-1-1), and a crystal orientation (0-11) or (01-1) respectively; or as shown in FIG. 24,

a configuration where the two vertical Hall elements 10 are arranged in a crystal orientation (1-11) or (−11-1), and a crystal orientation (11-1) or (−1-11) respectively;

the same advantages as the above advantages are obtained.

Furthermore, when three vertical Hall elements are integrated into one chip, for example as shown in FIG. 25, a configuration where the three vertical Hall elements 10 are arranged in a crystal orientation (1-10) or (−110), a crystal orientation (0-11) or (01-1), and a crystal orientation (10-1) or (−101) respectively is made, thereby the same advantages are obtained.

Similarly, when a substrate other than the silicon substrate is used, the two elements to be integrated into one chip are arranged in the crystal orientation for equalizing the atomic arrangement of the substrate, thereby the same advantages as above are obtained.

As described hereinbefore, according to the vertical Hall element according to the embodiment, advantages equal or similar to the advantages of the above (1) to (7) and (12) according to the previous first or eighth embodiment can be obtained; in addition, the following advantage can be obtained.

(16) A plurality of vertical Hall elements 10 to be integrated into one chip (i.e., one substrate) are arranged in a crystal orientation for equalizing the atomic arrangement of the substrate. Thus, excellent detection accuracy as the magnetic sensor can be obtained.

### Twelfth Embodiment

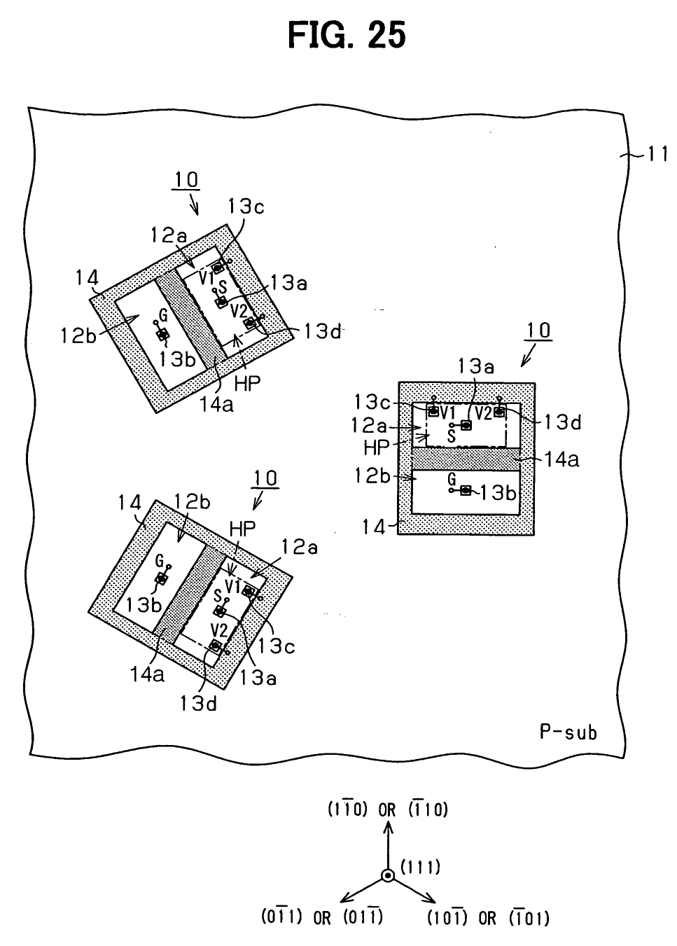

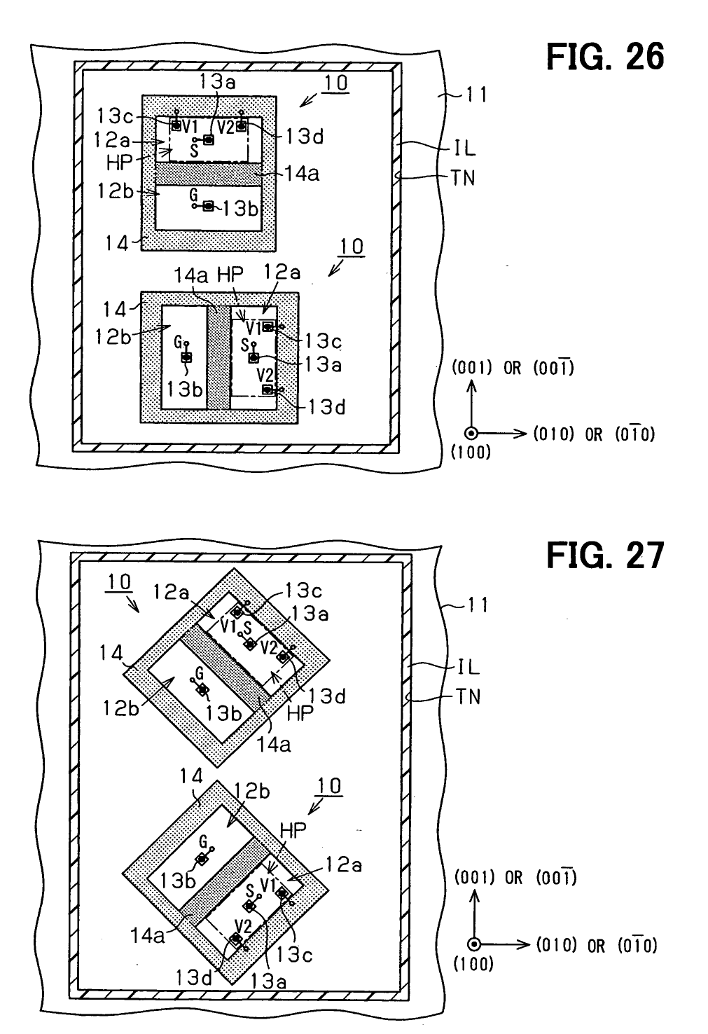

FIG. 26 and FIG. 27 show a twelfth embodiment of a vertical Hall element according to the invention.

Hereinafter, a structure of the vertical Hall element according to the embodiment, more accurately a configuration of a magnetic sensor using the vertical Hall element is described with reference to the FIG. 26 and FIG. 27 mainly on different points from the eleventh embodiment. Plan views of the FIG. 26 and FIG. 27 correspond to the previous FIG. 22 and FIG. 23. In each of the views, elements identical to the elements shown in FIG. 1A are shown with being marked with identical signs respectively, and overlapped description on the elements is omitted.

As shown in the FIG. 26 and FIG. 27, again in the embodiment, two vertical Hall elements 10 (i.e., vertical Hall elements having the structure shown in the previous FIG. 1A to FIG. 1C) arranged in a mode of detecting magnetic fields applied in biaxial directions perpendicular to each other, that is, arranged in a manner of being perpendicular to each other, are integrated into one chip to configure a magnetic sensor. The two vertical Hall elements 10 are formed in a manner of being adjacent to each other, and arranged in the crystal orientation for equalizing the atomic arrangement of the substrate respectively. However, here, a configuration is given in which trench isolation, that is, a trench TN in which an insulating film IL is buried is provided in a mode of enclosing the circumference of each of the two vertical Hall elements 10. Thus, the effect of various types of mechanical stress applied from the outside of the element is relaxed; consequently more excellent pairing performance can be obtained. As the trench TN, a shallow trench (i.e., STI) may be used.

As described hereinbefore, according to the vertical Hall element according to the embodiment, advantages equal or similar to the advantages of the above (1) to (7), (12), and (16) according to the previous, first, eighth, or eleventh embodiment can be obtained; in addition, the following advantage can be obtained.

(17) A configuration is given in which the two vertical Hall elements 10 to be integrated into one chip are formed in a manner of being adjacent to each other, and a trench TN is provided in a mode of enclosing the circumference of each of the two vertical Hall elements 10. Thus, the effect of various types of mechanical stress applied from the outside of the element is relaxed; consequently more excellent pairing performance can be obtained.

### Modifications

Each of the first to twelfth embodiments may be also practiced in the following modes.

In the seventh embodiment, as the wiring material arranged in a way that the part of which is able to be disconnected, the wiring material having the fuse that is self-disconnected by overcurrent is used. However, the material is not limited to this, and for example, a thin film resistance comprising, for example, CrSi or Al (aluminum), which can be disconnected by laser trimming, may be used instead of the fuse. Furthermore, as a configuration that separately uses a memory for storing adjustment data (for example, EPROM, EEPROM, flash memory, and ROM), for example, a switching element that performs switching operation responding to an external signal can be used. In a word, when a wiring material which is arranged in a way that the part of which can be disconnected is given, advantages equal or similar to the advantages of the above (11) according to the seventh embodiment can be obtained.

While the two vertical Hall elements 10 are integrated into one chip to configure the magnetic sensor in the mode of detecting the magnetic fields applied in the biaxial directions perpendicular to each other in the eighth embodiment, the configuration is not restrictive. In a word, it is adequate that the two vertical Hall elements 10 are integrated into one chip to configure the magnetic sensor in a mode of detecting magnetic fields applied from different angles. By using such a structure, advantages similar to the advantages of the above (12) according to the eighth embodiment can be obtained.

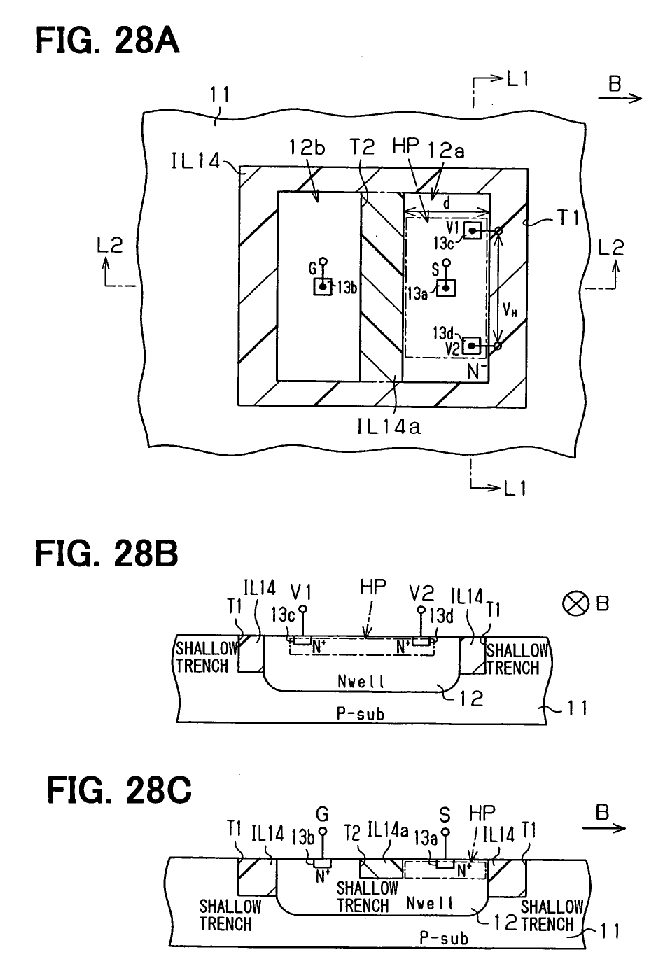

In each of the first to twelfth embodiments, the diffusion layers 14 and 14a are used for the separation barriers for electrically partitioning the regions 12a and 12b. However, this is not restrictive, and for example, as shown in FIG. 28A to FIG. 28C (corresponding to FIG. 1A to FIG. 1C), trench isolation, that is, trenches T1 and T2 in which insulating films IL14 and IL14a are buried may be used.

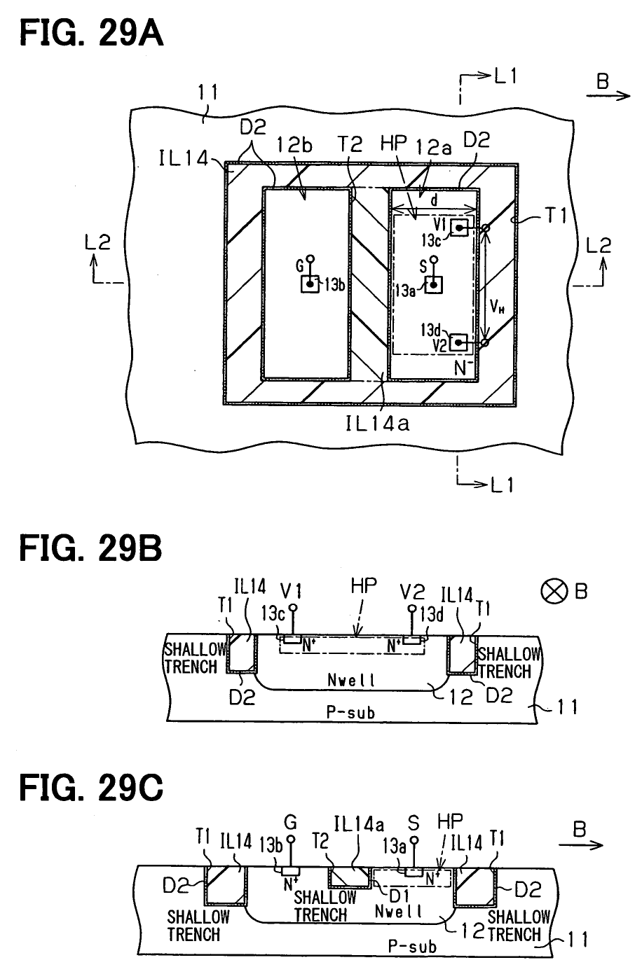

Moreover, for example, as shown in FIG. 29A to FIG. 29C, a configuration may be used in which regarding the vertical Hall element shown in the previous FIG. 28A to FIG. 28C, p-type diffusion regions D2 are provided on inner walls of the trenches T1 and T2 by introducing a P-type impurity comprising boron. When a trench is formed in a semiconductor substrate, a damage layer is generally formed in an inner wall of the trench, and carrier recombination tends to occur therein. In this regard, according to the structure having the diffusion region D2, such carrier recombination is suppressed by the diffusion region D2, consequently carrier mobility of the semiconductor region 12 is maintained high. Moreover, since a depletion layer of PN junction formed between the diffusion region D2 and the semiconductor region 12 penetrates into the inside of the element, a dimension corresponding to thickness d (see FIG. 67) of the magnetic detection part (i.e., Hall Plate) HP is substantially reduced. That is, according to such a structure, improvement in sensitivity as the Hall element can be achieved.

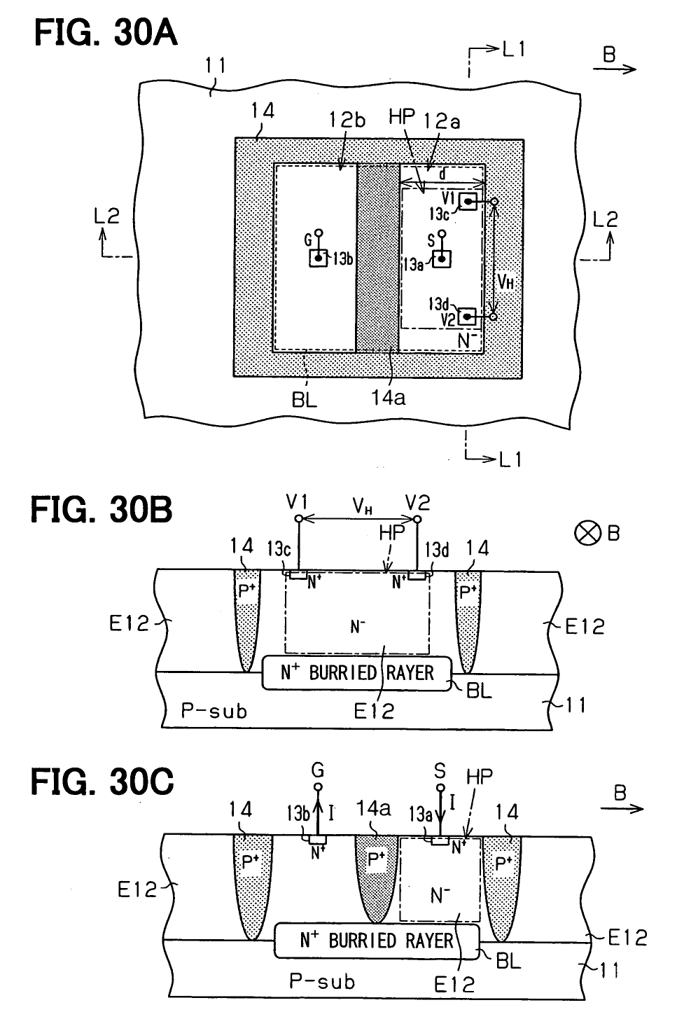

While the semiconductor region 12 is formed as the diffusion layer in each of the first to twelfth embodiments, it is not limited to this, and for example, the invention can be similarly applied to a structure in which the semiconductor region 12 is formed as an epitaxial film as the conventional vertical Hall element as shown in FIGS. 30A to 30C. Generally, when such an epitaxial substrate is used, the buried layer BL (FIGS. 70A to 70C) is often used. Alternatively, SOI (i.e., Silicon On Insulator) substrate and the like can be appropriately used.

In each of the first to twelfth embodiments, circular trench isolation may be provided in a mode of enclosing the region (i.e., element region) 12a. That is, for example as shown in FIG. 31, a configuration where a trench T3 in which an insulating film IL14b is buried is used as the circular trench isolation, and the diffusion region D2 is provided on an inner wall of the trench can be used.

In each of the first to twelfth embodiments, the two portions for outputting Hall voltage, and the portion that is arranged in a manner of being interposed by the two portions for supplying current to the magnetic detection part or drawing out current from the magnetic detection part, and the portion for making current flow in a pair with the above portion are provided as regions formed in a manner of selectively increasing impurity concentration at the substrate surface each. However, this is not an limited configuration, and for example, the wiring line (i.e., electrode) may be provided directly on the semiconductor region 12 without providing such contact regions.

Furthermore, in each of the first to twelfth embodiments, the separation barrier for electrically partitioning the region 12a, such as the diffusion layer 14a, is not the limited configuration as well. That is, for example, in a configuration where wiring lines (i.e., electrodes) for making current flow into the magnetic detection part HP are provided on two sides of the substrate in an opposed manner, even when such a separation barrier is not provided, current containing a component perpendicular to the substrate surface (i.e., chip surface) can flow into the magnetic detection part HP.

Moreover, in each of the first to twelfth embodiments, the layout is given in which the axis given by the contact regions 13a and 13b and the axis given by the contact regions 13c and 13d are perpendicular to each other. However, it is not limited, and layouts are not limited to the layout in which the axes are perpendicular to each other.

While the constant current drive is described as an example of the drive method of the vertical Hall element in each of the first to twelfth embodiments, the drive method of the vertical Hall element can be optionally selected, and for example, the element can be driven by constant voltage drive.

Moreover, in each of the first to twelfth embodiments, the circuit configured to have a CMOS circuit is exemplified as an example of peripheral circuits of the relevant Hall element. However, the peripheral circuits can be optionally configured, and for example, a circuit configured to have a bipolar circuit can be used for the peripheral circuits.

The invention can be also applied to a structure where conductivity type of respective components configuring the semiconductor substrate is exchanged, that is, a structure where the P-type is exchanged for the N-type, in each of the first to twelfth embodiments.

While silicon is used for the material of the substrate in each of the first to twelfth embodiment, other materials may be appropriately used depending on manufacturing processes, structural conditions and the like. For example, compound semiconductor materials such as GaAs, InSb, InAs and SiC, or other semiconductor materials such as Ge (i.e., germanium) can be used. Particularly, GaAs and InSb are materials having an excellent temperature characteristic, and effective for improving sensitivity of the relevant Hall element.

In each of the first to twelfth embodiments, a configuration is made in which the portions (i.e., contact region 13b) for making current flow in a pair with the contact region 13a is provided only at one side with respect to the axis given by the contact regions 13c and 13d, thereby potential distribution asymmetric to the axis is formed in the periphery of the axis. However, it is not restrictive, and as long as a structure is given in which potential distribution asymmetric to an axis given by two portions for outputting Hall voltage is formed in the periphery of the axis, dense/nondense equipotential lines appear clearly in the potential distribution. By using this, the structure exemplified in the previous FIG. 3 and the structure exemplified in the FIG. 7 can be easily realized depending on situation on each occasion. That is, even in a structure where the portions for making current flow in a pair with the contact region 13a is provided asymmetrically to the axis given by the contact regions 13c and 13d, for example, even in a structure where the portions are provided at both sides with respect to the axis in an asymmetric layout or number, the advantages can be obtained.

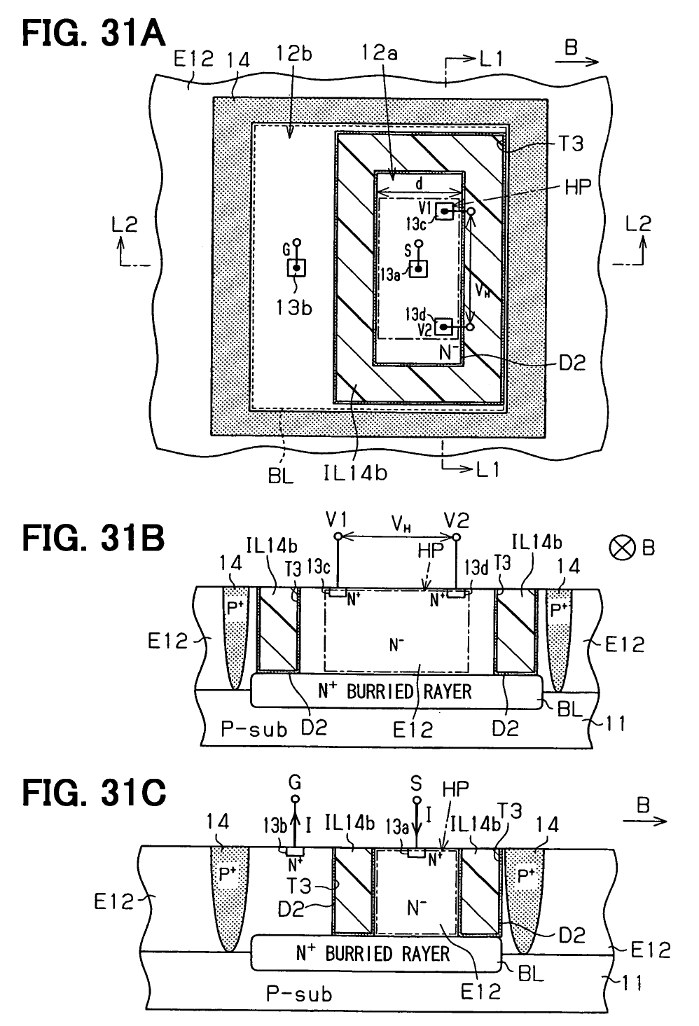

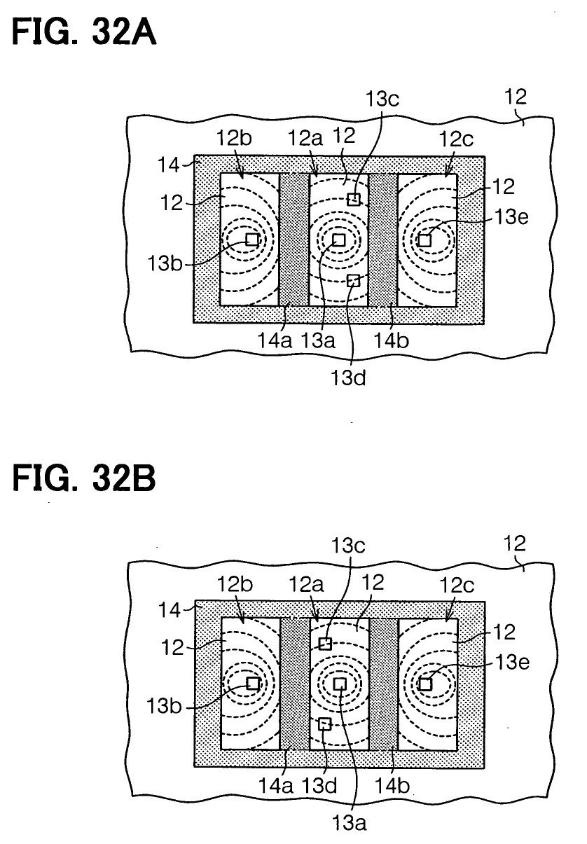

As shown in FIG. 32A and FIG. 32B (i.e., both correspond to FIG. 1A), the invention can be applied similarly to a vertical Hall element having the structure as shown in the previous FIG. 70A to FIG. 70C, that is, a structure where in the periphery of the axis given by the contact regions 13c and 13d provided as the portions for outputting Hall voltage, potential distribution symmetric to the axis is formed. Again in this case, the two portions for outputting Hall voltage are arranged at an area where equipotential lines of the potential distribution surrounding the periphery of an axis given by the two portions is dense, or an area where it is nondense, thereby advantages similar to the advantages of the above (1) according to the first embodiment can be obtained. FIG. 32A and FIG. 32B show examples that the portions are arranged at the area where the equipotential lines are nondense.

### Thirteenth Embodiment

Hereinafter, a thirteenth embodiment of a vertical Hall element according to the invention is represented.

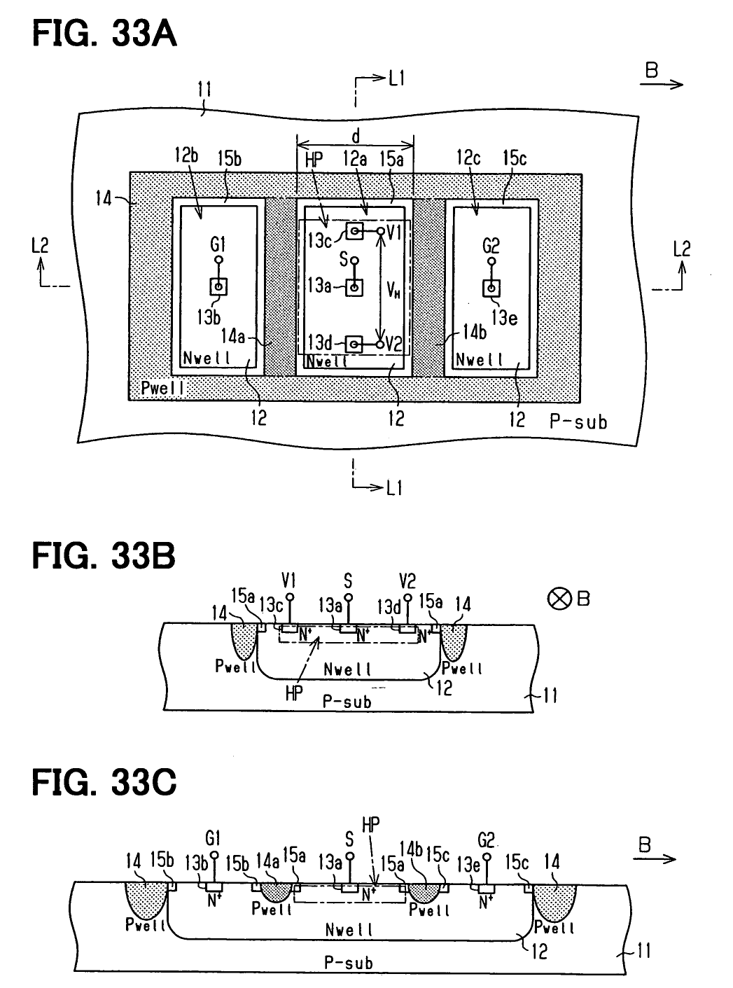

First, a schematic structure of the vertical Hall element according to the embodiment is described with reference to FIG. 33A to FIG. 33C. In FIG. 33A to FIG. 33C, FIG. 33A is a plan view schematically showing a plane structure of the Hall element, FIG. 33B is a cross section view along a line L1-L1 of FIG. 33A, and FIG. 33C is a cross section view along a line L2-L2 of FIG. 33A.

Again in this Hall element, in the semiconductor layer 11, for example, a P-type diffusion layer (i.e., P-type diffusion separation barrier) 14 is formed in order to isolate the relevant Hall element from other elements. In a region (i.e., active region) that is situated on a surface of the semiconductor region 12 and enclosed by the diffusion layer 14, contact regions (i.e., N⁺ layer) 13a to 13e are formed in a manner of selectively increasing impurity concentration (i.e., N-type) of the surface. Thus, excellent ohmic contact is formed between each of the contact regions and an electrode (i.e., wiring line) arranged thereon. The contact regions 13a to 13e are electrically connected to terminals S, G1, G2, V1, and V2 via respective electrodes (i.e., wiring lines) arranged thereon. Among them, the contact regions 13b and 13e are paired with the contact region 13a to form current supply pairs, respectively, and the contact regions 13c and 13d correspond to respective terminals of a voltage output pair.

As shown in FIG. 33A, the region (i.e., active region) enclosed by the diffusion layer 14 that is extensionally arranged from a surface to the inside of a substrate is divided into regions 12a to 12c separated from one another across P-type diffusion layers (i.e., P-type diffusion separation barrier) 14a and 14b through PN-junction separation by each diffusion layer. As shown in FIG. 33C, electrically partitioned regions are formed even within the substrate in the regions 12a to 12c. Portions adjacent to inner circumferential sides (i.e., PN-junction sides) of the diffusion layers 14, 14a, and 14b that electrically partition the regions 12a to 12c are selectively increased in impurity concentration in the vicinity of the substrate surface respectively, and high concentration regions (i.e., N⁺ layers) 15a to 15c are formed therein. A dimension in a depth direction of the high concentration region 15a is set to be sufficiently short to make current containing a component perpendicular to the substrate surface flow into a magnetic detection part HP, and for example, set to at least “half” the depth dimension of the diffusion layers 14a and 14b for partitioning the magnetic detection part HP. Here, dimensions in the depth direction of the high concentration regions 15a to 15c are set to be nearly equal to dimensions in the depth direction of the contact regions 13a to 13e, for example, set to be about “1 μm.”

In the regions, the contact regions 13a, 13c and 13d are formed on the region (i.e., element region) 12a, the contact regions 13b is formed on the region 12b, and contact regions 13e is formed on the region 12c, respectively. More specifically, regarding the contact regions, the contact region 13a is disposed in a manner of being interposed by both of the contact regions 13b, 13e, and the contact regions 13c, 13d perpendicular to the regions 13b, 13e. That is, the contact region 13a is disposed in a manner of being opposed to the contact regions 13b and 13e across the diffusion layers 14a and 14b, respectively. In the Hall element, a region in the region 12a which is electrically partitioned within the substrate and interposed by the contact regions 13c and 13d is a so-called magnetic detection part (i.e., Hall plate) HP. That is, in the Hall element, a Hall voltage signal responding to a magnetic field applied to the part is generated.

Here, for example, when constant drive current flows from the terminal S to terminal G1, and from the terminal S to terminal G2 respectively, the current flows from the contact region 13a formed on the substrate surface to the contact regions 13b and 13e through the magnetic detection part HP and lower parts of the diffusion layers 14a and 14b respectively. That is, in this case, current containing a component perpendicular to the substrate surface (i.e., chip surface) flows into the magnetic detection part HP. However, in the vertical Hall element, a structure in which a buried layer (see a buried layer BL in FIG. 70B) is omitted is used; thereby drive current of the element is guided to flow in an oblique direction with respect to the substrate surface at least in the magnetic detection part HP. Therefore, unlike the conventional vertical Hall element as shown in FIG. 70B and FIG. 70C, in the vertical Hall element, the drive current in the magnetic detection part HP flows in the oblique direction with respect to the substrate surface, rather than a direction approximately vertical to the substrate surface.

Moreover, since the dimension in the depth direction of the high concentration region 15a is set to be sufficiently short to make the current containing a component perpendicular to the substrate surface flow into the magnetic detection part HP. This prevents such a situation that much current flows into the high concentration region 15a adjacent to the magnetic detection part HP, as a result the current required for magnetic detection can not flow into the magnetic detection part HP. That is, sufficient current is secured for the magnetic detection part HP.

Therefore, when a magnetic field containing a component parallel to the substrate surface (i.e., chip surface) (for example, magnetic field indicated by an arrow B in FIG. 33A) is assumed to be applied to the magnetic detection part HP of the relevant Hall element, Hall voltage responding to the magnetic field is generated between the terminals V1 and V2 due to the Hall effect. Accordingly, the generated Hall voltage signal is detected through the terminals V1 and V2, thereby a magnetic field component as the detection object, or the magnetic field component parallel to the surface (i.e., chip surface) of the substrate used for the relevant Hall element is obtained according to the previous relational expression “V_{H}=(R_{H}IB/d)cos θ” as shown in FIG. 67. In the Hall element, a dimension d shown in FIG. 33A corresponds to thickness (“d” in the relational expression) of the magnetic detection part (i.e., Hall plate). In the Hall element, a direction along which the drive current flow can be optionally set, and the magnetic field (i.e., magnetism) can be detected in a direction opposite to the direction of the drive current.

In the vertical Hall element according to the embodiment, impurity concentration of a portion adjacent to a PN-junction side of the diffusion layers (i.e., P-type diffusion separation barriers) 14, 14a and 14b that electrically partition the inside of the substrate through PN-junction is selectively increased. Thus, expansion of depletion layers due to the diffusion layers 14, 14a and 14b is suppressed in the vicinity of the substrate surface, and accordingly, movement of movable ions at the substrate surface is also suppressed. Therefore, the temporal variation is reduced, consequently detection accuracy as the magnetic detection element can be maintained high. In addition, since impurity concentration is maintained low (i.e., less) in the semiconductor region 12, high mobility is obtained as carrier mobility in the magnetic detection part HP, consequently sensitivity in magnetic detection is maintained high. Moreover, since the expansion of the depletion layers is suppressed, change of an element shape accompanied with formation of the depletion layer is naturally suppressed; consequently the variation in element sensitivity due to variation in environmental temperature or manufacturing conditions is preferably suppressed.

As described hereinbefore, according to the vertical Hall element according to the embodiment, the following excellent advantages are obtained.

(18) The impurity concentration of the portion adjacent to the PN-junction sides of the diffusion layers (i.e., P-type diffusion separation barriers) 14, 14a and 14b that electrically partition the inside of the substrate through PN-junction is selectively increased, and the high concentration regions (i.e., N⁺ layer) 15a to 15c are formed therein. Thus, the temporal variation is reduced, consequently detection accuracy as the magnetic detection element can be maintained high. In addition, carrier mobility in the magnetic detection part HP is maintained high, consequently sensitivity in magnetic detection is maintained high. Furthermore the variation in element sensitivity due to variation in environmental temperature or manufacturing conditions is preferably suppressed.

(19) Moreover, since the detection accuracy as the magnetic detection element is maintained high, small magnetic variation that has been hard to be detected can be detected, consequently the element can be applied to a new field. Moreover, even when it is applied to usual fields, improvement in yield and reduction in cost can be achieved, consequently energy saving can be achieved.

(20) The high concentration regions (i.e., N⁺ layer) 15a to 15c are provided at a PN-junction side with respect to the diffusion layers (i.e., separation barriers) 14, 14a and 14b that enclose periphery of the magnetic detection part HP. The variation in element sensitivity due to change of the element shape is particularly increased when a shape of the magnetic detection part (i.e., Hall plate) is changed. In this regard, in the structure, since the high concentration regions (i.e., N⁺ layer) 15a to 15c are provided in the diffusion layers (i.e., separation barriers) that enclose the periphery of the magnetic detection part HP, change of the shape of the detection part HP is preferably suppressed, consequently the variation in element sensitivity is further preferably suppressed.

(21) Moreover, the dimension in a depth direction of the high concentration region 15a is set to be sufficiently short to make the current containing the component perpendicular to the substrate surface flow into the magnetic detection part HP. Thus, it is prevented that much current flows into the high concentration region 15a adjacent to the magnetic detection part HP, as a result the current required for magnetic detection can not flow into the magnetic detection part HP; consequently sufficient current is secured for the magnetic detection part HP.

(22) The high concentration regions (i.e., N⁺ layer) 15a to 15c are provided at the PN-junction side to the diffusion layer (i.e., separation barrier) 14 for isolating the relevant Hall element from other elements. Thus, a structure having strong durability against effects of disturbance factors (for example, noise from peripheral circuits of the element) is given.

(23) Dimensions in the depth direction of the high concentration regions 15a to 15c are set to be nearly equal to dimensions in the depth direction of the contact regions 13a to 13e. According to such a structure, the high concentration regions 15a to 15c can be easily formed by using a manufacturing process of the contact regions 13a to 13e, that is, manufacturing processes of the two can be made in common; consequently the above structure is more easily realized.

(24) The structure is made in which current containing the component perpendicular to the substrate surface (i.e., chip surface) is guided to flow in an oblique direction with respect to the substrate surface at least in the magnetic detection part HP. Thus, the current containing the component perpendicular to the substrate surface flows into the magnetic detection part HP without causing change in potential distribution within the element or a complicated element structure along with the arranged buried-layer, consequently an original function as the vertical Hall element of generating Hall voltage responding to the magnetic field component parallel to the substrate surface can be maintained.

### Fourteenth Embodiment

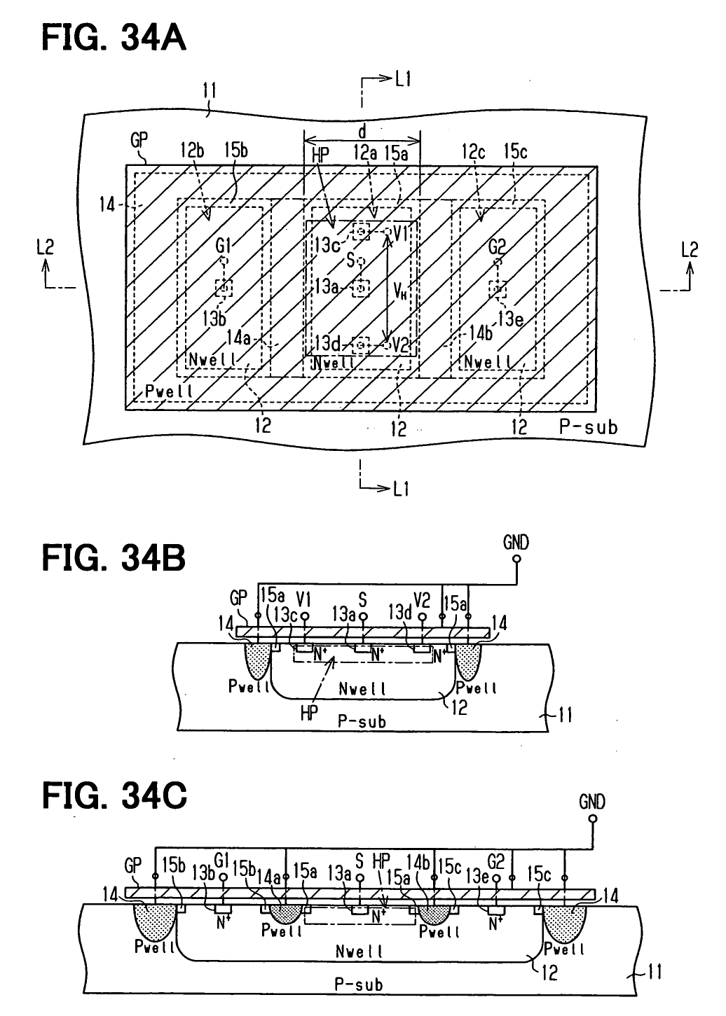

FIG. 34A to FIG. 34C show a fourteenth embodiment of a vertical Hall element according to the invention.

Hereinafter, a structure of the vertical Hall element according to the embodiment is described with reference to FIGS. 34A to 34C mainly on different points from the previous thirteenth embodiment. A plan view of FIG. 34A corresponds to the plan view of the previous FIG. 33A, FIG. 34B is a cross section view along a line L1-L1 of FIG. 34A, and FIG. 34C is a cross section view along a line L2-L2 of FIG. 34A. In each of the figures, respective elements identical to the elements shown in FIG. 33A to FIG. 33C are shown with being marked with identical signs, and overlapped description on the elements is omitted.

As shown in the FIG. 34A to FIG. 34C, the vertical Hall element has the approximately same structure as the vertical Hall element of the previous thirteenth embodiment exemplified in FIG. 33A to FIG. 33C, in addition, an operation mode of the element is same as the mode as described before. However, the embodiment is in a structure where a conductor plate GP comprising, for example, aluminum or polycrystalline silicon, which is fixed to predetermined potential (for example, ground potential), is provided in a manner of covering the element surface. The diffusion layers 14, 14a and 14b are fixed to predetermined potential (for example, ground potential) via appropriate wiring lines. Any optional conductor material can be used for the material of the conductor plate GP; for example, metals other than aluminum can be used.

Such a conductor plate GP is provided such that it covers the element surface, thereby electric potential of the element surface is fixed, and the periphery of the element surface is also in stable potential environment. Therefore, the movement of movable ions within the interlayer insulating film (i.e., abbreviated to be shown) formed on the substrate surface is suppressed, and the temporal variation due to the movable ions is reduced, consequently detection accuracy as the magnetic detection element can be maintained high. Furthermore, noise from the upside of the substrate can be shielded to protect the relevant Hall element from the noise.

As described hereinbefore, according to the vertical Hall element according to the embodiment, advantages equal or similar to the advantages of the above (18) to (24) according to the previous thirteenth embodiment are obtained; in addition, the following advantages are obtained.

(25) The conductor plate GP is arranged above the substrate surface in a manner of covering the element surface including the magnetic detection part HP. Thus, detection accuracy as the magnetic detection element can be maintained high. Furthermore, noise from the upside of the substrate can be shielded to protect the relevant Hall element from the noise.

(26) Aluminum or polycrystalline silicon is used for the material of the conductor plate GP. Thus, the conductor plate GP that appropriately functions as a shield plate against disturbance can be easily formed.

### Modifications

Each of the thirteenth and fourteenth embodiments can be also practiced in the following mode.

In each of the thirteenth and fourteenth embodiments, the dimensions in the depth direction of the high concentration regions 15a to 15c are set to be nearly equal to the dimensions in the depth direction of the contact regions 13a to 13e. However, this is not limited configuration, and the dimensions in the depth direction of the high concentration regions 15a to 15c can be optionally set. Moreover, as long as the dimension in a depth direction of the high concentration region 15a adjacent to the magnetic detection part HP is set to be sufficiently short to make the current containing the component perpendicular to the substrate surface flow into the magnetic detection part HP, advantages equal or similar to the advantages of the above (21) according to the thirteenth embodiment can be obtained.

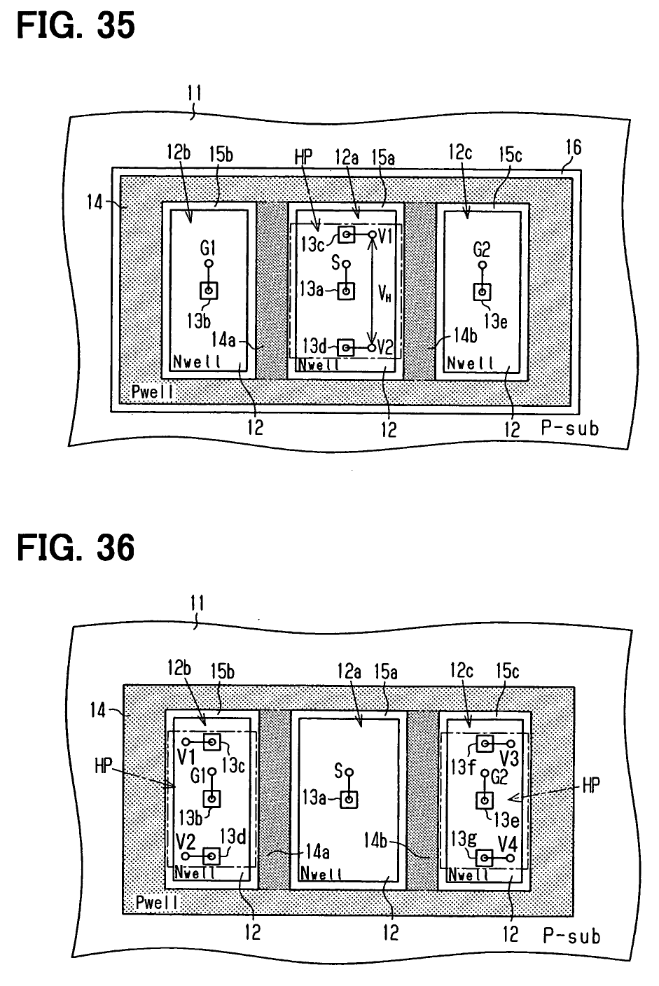

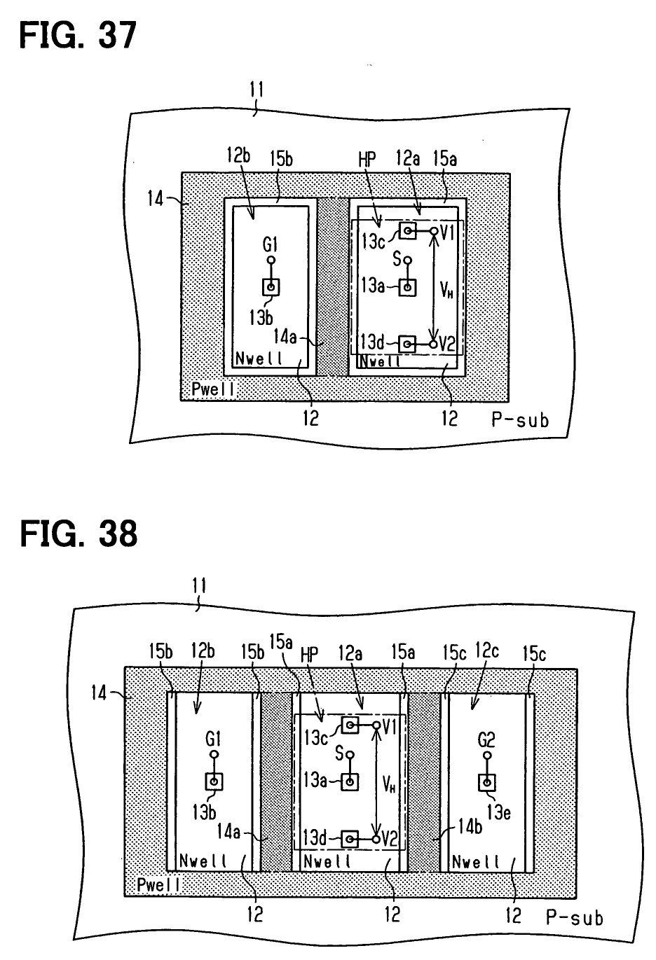

For example, as shown in FIG. 35, the vertical Hall element according to the thirteenth embodiment can be in a structure in which a high concentration region (i.e., N⁺ layer) 16 is provided at a portion adjacent to the outside of the diffusion layer (i.e., separation barrier) 14 for isolation. According to such a structure, durability against effects of disturbance factors (i.e., for example, noise from the peripheral circuits of the element) can be further improved.

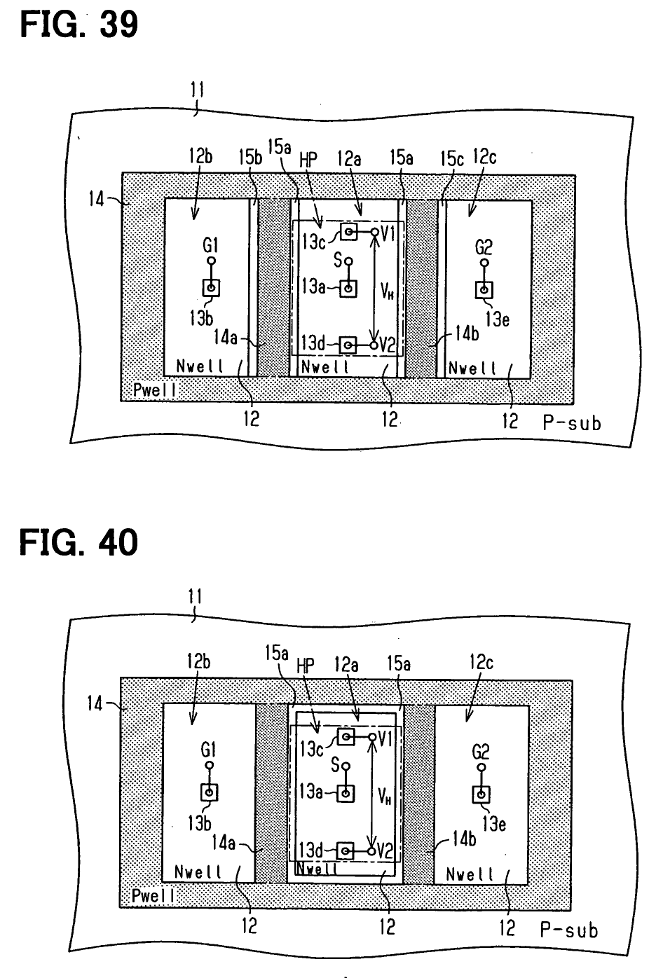

In each of the thirteenth and fourteenth embodiments, the high concentration regions (i.e., N⁺ layer) 15a to 15c are provided at a PN-junction side with respect to the diffusion layers (i.e., separation barriers) 14, 14a and 14b that enclose the periphery of the magnetic detection part HP. However, when a structure is given in which the high concentration regions (i.e., N⁺ layer) 15a to 15c are provided at the PN-junction side to the diffusion layers (i.e., separation barriers) 14a, 14b that partition the magnetic detection part HP in the substrate and the diffusion layer (i.e., separation barrier) 14 for isolation, that is, even in a structure, for example, as shown in FIG. 38, advantages similar to the advantages of the above (20) and (22) according to the thirteenth embodiment can be obtained. Furthermore, for example as shown in FIG. 39, even in a structure where the high concentration regions (i.e., N⁺ layer) 15a to 15c are provided only to the diffusion layers (i.e., separation barriers) 14a, 14b that partition the magnetic detection part HP in the substrate, advantages similar to the advantages of the above (20) according to the thirteenth embodiment can be obtained. By using such structures, the high concentration regions (i.e., N⁺ layer) are provided only at a portion having a steep potential gradient in a drive current channel, or a portion having a largely expanded depletion layer, thereby the advantages can be efficiently obtained with a simple structure being kept.

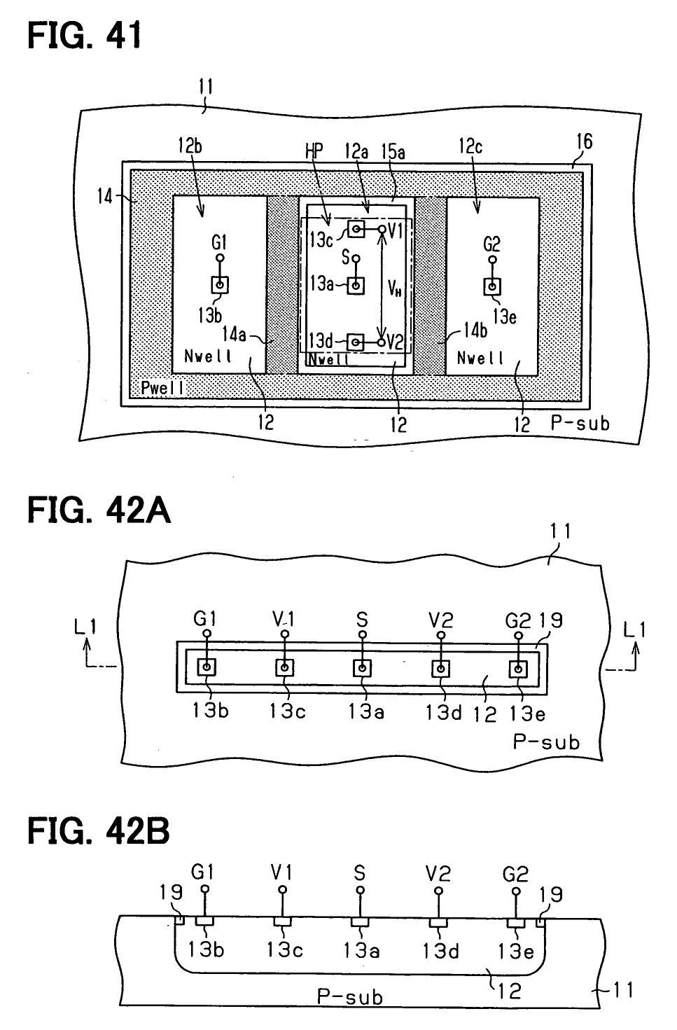

In each of the thirteenth and fourteenth embodiments, while the high concentration regions (i.e., N⁺ layer) 15a to 15c are provided for all of the regions 12a to 12c, it is not restrictive, and for example, as shown in FIG. 40, a structure where the high concentration region (i.e., N⁺ layer) 15a is provided only to the region 12a may be given. Again in this case, for example as shown in FIG. 41, a high concentration region (i.e., N⁺ layer) 16 is provided at a portion adjacent to the outside of the diffusion layer (i.e., separation barrier) 14 for isolation, thereby durability against effects of disturbance factors can be improved.

### Fifteenth Embodiment

Hereinafter, regarding a vertical Hall element and a method for adjusting offset voltage of the element according to the invention, a fifteenth embodiment of them is represented.

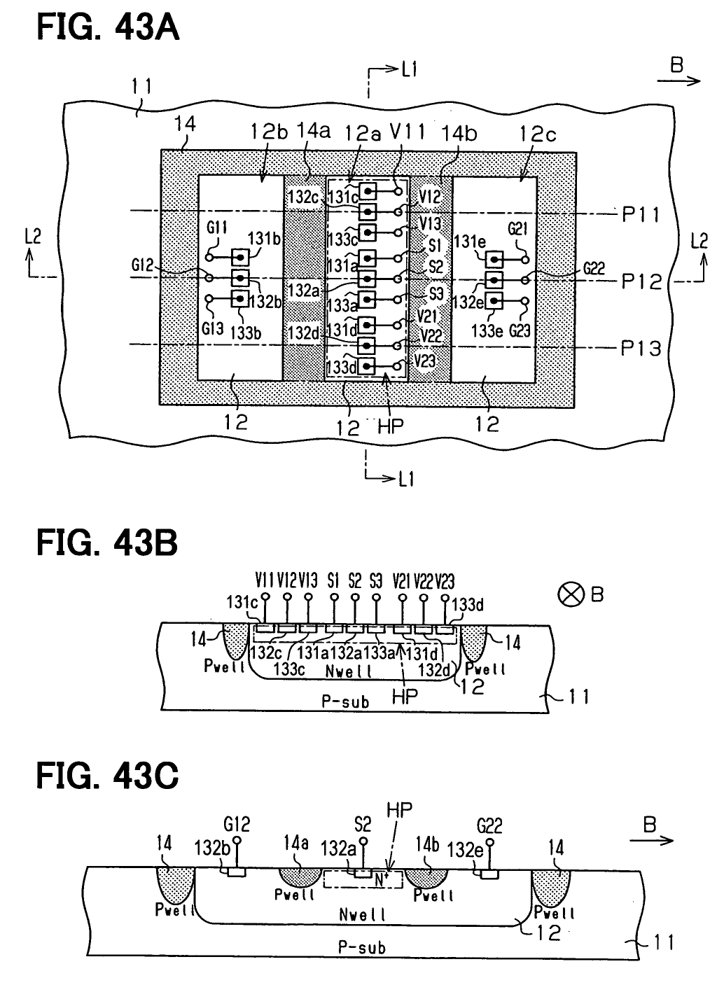

First, a schematic structure of the vertical Hall element according to the embodiment is described with reference to FIGS. 43A to 43C. FIG. 43A is a plan view typically showing a schematic structure of the Hall element, FIG. 43B is a cross section view along a line L1-L1 of FIG. 43A, and FIG. 43C is a cross section view along a line L2-L2 of FIG. 43A.

As shown in FIG. 43A to 43C, the Hall element is roughly configured to have a semiconductor layer (i.e., P⁻sub) 11 comprising, for example, P-type silicon, and a N-type semiconductor region (i.e., N well) 12 formed as a diffusion layer (i.e., well), for example, by introducing an N-type conductivity type impurity into a surface of the layer 11. As described before, in the semiconductor material such as silicon, since N-type semiconductor has large carrier mobility compared with P-type semiconductor, the N-type semiconductor material is desirably used for a material (i.e., for example, silicon) of the semiconductor region 12. However, the P-type semiconductor material (i.e., P⁻sub) can be also used depending on manufacturing processes or structural conditions. Moreover, as impurity concentration of the semiconductor region 12 is decreased (i.e., less), carrier mobility in the region increases, therefore impurity concentration in the semiconductor region 12 is desirably decreased (i.e., less) in order to improve sensitivity as the Hall element, that is, in order to obtain large voltage as output voltage.

Again in this Hall element, in the semiconductor layer 11, for example, a P-type diffusion layer (i.e., P-type diffusion separation barrier) 14 is formed such that the relevant Hall element is isolated from other elements. In a region (i.e., active region) that is situated on a surface of the semiconductor region 12 and enclosed by the diffusion layer 14, contact regions (i.e., N⁺ layers) 131a to 131e, 132a to 132e and 133a to 133e are formed in a manner of selectively increasing impurity concentration (i.e., N-type) of the surface. Thus, excellent ohmic contact is formed between the contact regions and electrodes (i.e., wiring lines) arranged thereon, respectively. The contact regions are electrically connected to terminals S1 to S3, G21 to G23, G11 to G13, V11 to V13, and V21 to V23 via respective electrodes (i.e., wiring lines) arranged thereon. That is, in the Hall element, the contact regions 131a to 133a, 131b to 133b, and 131e to 133e correspond to current supply terminals, and the contact regions 131c to 133c and 131d to 133d correspond to voltage output terminals.

Here, the contact regions 131a to 131e, 132a to 132e and 133a to 133e are formed to have the same pattern (i.e., crosswise pattern). More specifically, the crosswise pattern is in a pattern that either of the voltage output terminals and the current supply terminals is symmetrically disposed with the other as a reference. That is, the pattern is made such that the contact regions 131e to 133e, 131b to 133b and 131a to 133a are disposed axisymmetrically with an axis of symmetry comprising the contact regions 131c to 133c and 131d to 133d as the reference, and the reverse is also true. The three identical patterns comprise one reference pattern (i.e., pattern given by the contact regions 132a to 132e), and a pattern pair in a symmetrical (i.e., axisymmetrical) relation to each other with the pattern as the reference, or a pattern given by the contact regions 131a to 131e and a pattern given by the contact regions 133a to 133e.

As shown in FIG. 43A, the region (i.e., active region) enclosed by the diffusion layer 14 is divided into regions 12a to 12c separated from one another by P-type diffusion layers (i.e., P-type diffusion separation barriers) 14a and 14b through PN-junction separation by each diffusion layer. As shown in FIG. 43C, electrically partitioned regions are formed even within the substrate in the regions 12a to 12c. Regarding the regions, the contact regions 131e to 133e are formed in the region 12c, the contact regions 131b to 133b are formed in the region 12b, and the contact regions 131c to 133c, 131a to 133a and 131d to 133d are formed in the region (i.e., element region) 12a respectively. More specifically, the contact regions 131a to 133a are disposed in a manner of being interposed by both of the contact regions 131e to 133e, 131b to 133b and the contact regions 131c to 133c, 131d to 133d perpendicular to the regions. That is, a layout is made such that the contact regions 131a to 133a are opposed to each of the contact regions 131e to 133e and 131b to 133b across the contact regions 14a and 14b.

In the Hall element, a region in the region 12a which is electrically partitioned within the substrate and interposed by the contact regions 131c to 133c and 131d to 133d (i.e., more accurately, contact regions actually used as the voltage output terminals) is the so-called magnetic detection part (i.e., Hall Plate) HP. That is, in the Hall element, a Hall voltage signal responding to a magnetic field applied to the part is generated.

Next, an operation mode of the vertical Hall element is described.

For example, when constant drive current is made to flow from the terminal S2 to the terminal G22, and from the terminal S2 to the terminal G12 respectively, the current is made to flow from the contact region 132a formed on the substrate surface to the contact regions 132e and 132b through the magnetic detection part HP and lower parts of the diffusion layers 14a and 14b respectively. That is, in this case, current containing a component perpendicular to the substrate surface (i.e., chip surface) is made to flow into the magnetic detection part HP. Therefore, when a magnetic field (i.e., for example, magnetic field indicated by an arrow B in FIGS. 43A to 43C) containing a component parallel to the substrate surface (i.e., chip surface) is assumed to be applied to the magnetic detection part HP of the relevant Hall element, for example, Hall voltage responding to the magnetic field is generated between the terminals V12 and V22 due to the Hall effect. Accordingly, the generated Hall voltage signal is detected through the terminals V12 and V22, thereby a magnetic field component as the detection object, or the magnetic field component parallel to the surface (i.e., chip surface) of the substrate used for the relevant Hall element is obtained according to the previous relational expression “V_{H}=(R_{H}IB/d)cos θ” as shown in FIG. 67. In the Hall element, a direction along which the drive current is made to flow can be optionally set, and the magnetic field (i.e., magnetism) can be detected in a direction opposite to the direction of the drive current. While detection of magnetic field by using the pattern given by the contact regions 132a to 132e was mentioned herein, the magnetic field can be detected by using (i.e., selecting) other patterns or combinations of the patterns.

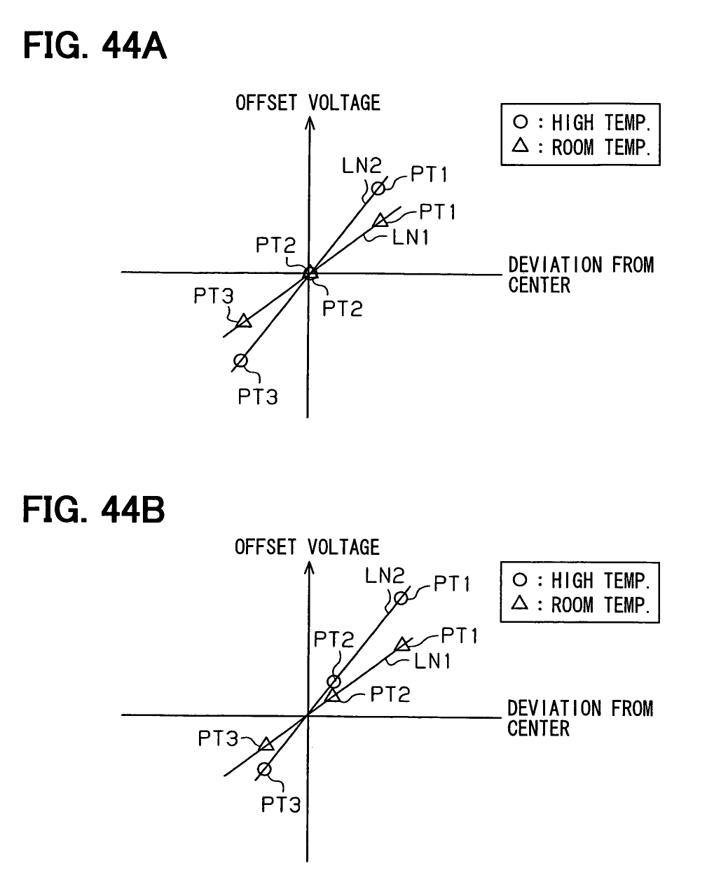

Next, an adjustment (i.e., correction) mode of the offset voltage on the vertical Hall element is described with reference to FIGS. 44A and 44B together. FIGS. 44A and 44B are graphs showing offset voltage characteristics in the cases with and without alignment displacement, respectively. In the graphs, vertical axes indicate offset voltage, and horizontal axes indicate displacement levels of the patterns (i.e., voltage output terminals and current supply terminals) from reference positions (i.e., center positions), or displacement levels from reference axes P11 to P13, respectively. Furthermore, herein, characteristics at room temperature and high temperature are shown by linear (i.e., straight) data lines LN1 and LN2 in order to simply exemplify a temperature characteristic of offset voltage, respectively. Here, data PT1 to PT3 on the data lines LN1 and LN2 indicate characteristics of respective patterns given by the contact regions 131a to 131e, 132a to 132e, and 133a to 133e. First, the offset voltage characteristic of the vertical Hall element is described in detail with reference to each of the drawings.

As shown in FIGS. 44A and 44B, the offset voltage characteristics are different between the cases with and without alignment displacement. Since the reference axes P11 to P13 are assumed to be original positions of the contact regions 132a to 132e, when the alignment displacement is not present, the regions are arranged on the reference axes P11 to P13. That is, in this case, as shown in FIG. 44A, data PT2 of a pattern given by the regions lie at a displacement level of “0” from the reference position (i.e., center position) and at offset voltage of “0.” Since the two patterns given by the contact regions 131a to 131e and 133a to 133e are provided symmetrically (i.e., axisymmetrically) with the contact regions 132a to 132e as the reference (i.e., axis of symmetry), the data PT2 that are data of a pattern given by the contact regions 132a to 132e lie at a center position of data PT1 and PT3 that are data of other patterns. Such a positional relationship among the data PT1 to PT3 is maintained even when a temperature variation or the alignment displacement occurs.

Next, a mode on offset voltage adjustment (i.e., correction) which is performed by using such offset voltage characteristics is shown.

In the vertical Hall element according to the embodiment, the three patterns are simultaneously formed using the same mask, thereby they can be easily obtained as accurate patterns without causing alignment displacement, and the positional relationship among respect patterns can be freely established in a layout (i.e., design process) stage. That is, the positional relationship among respective patterns can be understood at the layout stage. Therefore, a correction value of the offset voltage that varies depending on change of temperature (i.e., environmental temperature) can be obtained easily and accurately from the positional relationship among respect patterns, and the offset voltage can be appropriately corrected and/or removed based on the correction value.

Specifically, when the alignment displacement occurs, as shown in FIG. 44B, some level of alignment displacement (i.e., displacement level from the center position) and offset voltage appears in the data PT2. At that time, occurrence of the offset voltage against the level of alignment displacement varies depending on temperature (i.e., environmental temperature) as shown in data lines LN1 and LN2 in the FIG. 44B. Therefore, even when a value of the offset voltage of the data PT2 is known, unless temperature at that time is known, the level of alignment displacement of data PT2, or the correction value of the offset voltage can not be specified. The temperature detection device and the like have been needed to specify the correction value, as described before. In this regard, in the vertical Hall element according to the embodiment, the positional relationship among respective patterns and the positional relationship among data PT1 to PT3 are previously understood, for example, by recording them at the layout stage, and offset voltage on respective patterns is measured, and then data lines according to the patterns are made from the measured offset voltage and each of the previously understood positional relationships. Specifically, for example, the data line LN1 is obtained as the data line at room temperature, and for example, the data line LN2 is obtained as the data line at high temperature. Then, as seen from the graph of FIG. 44B, by making the data lines, the level of alignment displacement of the data PT2, or the correction value of the offset voltage can be obtained easily and accurately independently of temperature (i.e., environmental temperature). Furthermore, offset voltage of the Hall element can be appropriately corrected and/or removed based on the correction value. In the data line made herein, the data PT2 lies at the midpoint position between the data PT1 and PT3, as described before. Generally, the offset voltage is adjusted, for example, through trimming at completion of a wafer process or after packaging.

In this way, according to the vertical Hall element according to the embodiment, the offset voltage can be preferably corrected by accurately grasping the correction value of the offset voltage that varies depending on environmental temperature. Moreover, since the temperature detection device is not required, even in the configuration having the correction circuit on the offset voltage as described before, reduction in scale of the circuit can be achieved. Furthermore, when the above method is used as the adjustment (i.e., correction) method of the offset voltage, a correction range of the offset voltage can be optionally set, therefore even in the case that the offset voltage significantly varies, it can be easily corrected. That is, the method can be widely used for further various Hall elements independently of manufacturing processes of the Hall element.

As described hereinbefore, according to the vertical Hall element and the adjustment method of the offset voltage of the element according to the embodiment, the following excellent advantages are obtained.

(27) Voltage output terminals that output Hall voltage signals in pairs, and current supply terminals that supply current to the magnetic detection part HP in pairs are formed in a mode of having three patterns which are identical. Thus, the correction value of the offset voltage that varies depending on change of temperature (i.e., environmental temperature) can be obtained easily and accurately from the positional relationship among respect patterns without requiring the temperature detection device, and the offset voltage can be appropriately corrected and/or removed based on the correction value. Moreover, in the configuration having the correction circuit on the offset voltage as described before, reduction in scale of the circuit can be achieved.

(28) In addition, improvement in production yield and reduction in cost of the Hall element are caused, consequently saving of energy is achieved.

(29) As the pattern given by the voltage output terminals and the current supply terminals, the crosswise pattern (see FIGS. 43A to 43C) in which either of the terminals is symmetrically disposed with the other as the reference, thereby the terminals (i.e., contact regions) can be regularly disposed, consequently simplification of the structure as the Hall element is achieved.

(30) Furthermore, the pattern configured by one reference pattern and a pair of patterns that are in a symmetrical (i.e., axisymmetrical) relation with each other with the reference pattern as the reference is used as the three identical patterns given by the terminals, thereby the correction value can be easily obtained from, for example, the graph as shown in FIG. 44B.

(31) Both the voltage output terminals and the current supply terminals are provided as the contact regions (i.e., N⁺ layer) 131a to 131e, 132a to 132e and 133a to 133e in which concentration of the conductivity type impurity is selectively increased in the substrate surface. Thus, excellent ohmic contact is formed between the regions and electrodes (i.e., wiring lines) arranged on the regions respectively to supply or draw out current, or detect the Hall voltage signal, consequently more excellent electric characteristics are achieved.

(32) In adjusting the offset voltage of the vertical Hall element, the correction value (i.e., level of alignment displacement) used for adjustment of the offset voltage is obtained from the relation between the positions of the three patterns given by the voltage output terminals and the current supply terminals, and the offset voltage (i.e., graphs of FIG. 44A and FIG. 44B). Thus, the correction value of the offset voltage that varies depending on change of temperature (i.e., environmental temperature) can be obtained easily and accurately from the positional relationship among respective patterns without requiring the temperature detection device, and the offset voltage can be appropriately corrected and/or removed based on the correction value.

### Sixteenth Embodiment

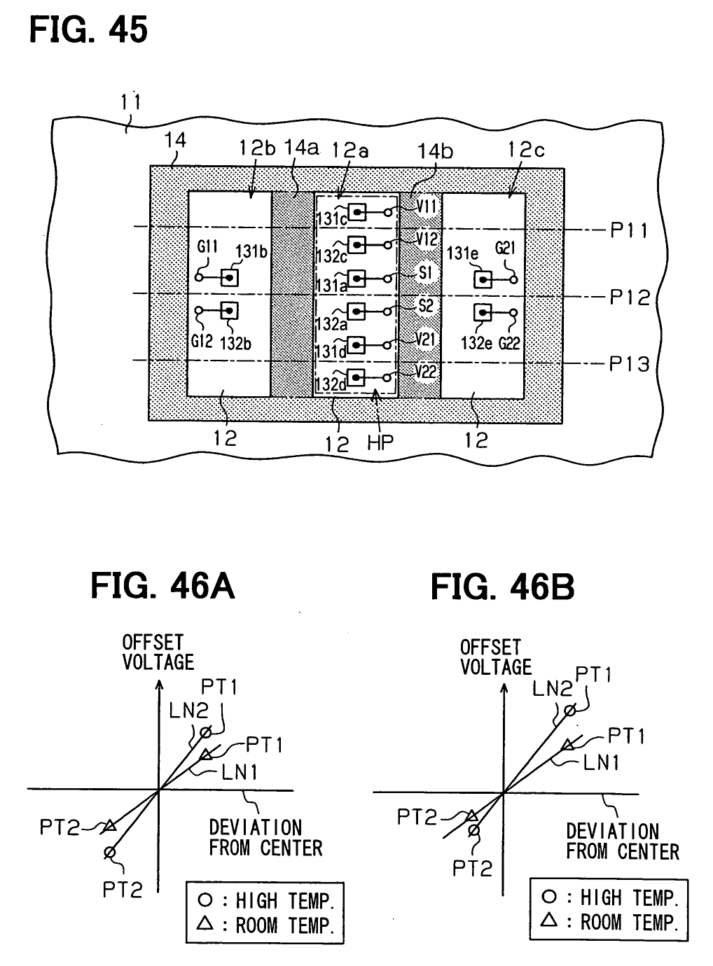

FIG. 45 shows a sixteenth embodiment of a vertical Hall element and a method for adjusting the offset voltage of the element according to the invention.

Hereinafter, the vertical Hall element according to the embodiment is described with reference to FIG. 45 and FIGS. 46A and 46B mainly on different points from the previous fifteenth embodiment. A plan view of FIG. 45 corresponds to the plan view of the previous FIG. 43A, and graphs of FIG. 46A and 46B correspond to the previous graphs of FIGS. 44A and 44B respectively, and in the FIG. 45, respective elements identical to the elements shown in FIG. 43A are shown with being marked with identical signs, and overlapped description on the elements is omitted.

As shown in the FIG. 45, the vertical Hall element has the approximately same structure as the vertical Hall element of the previous, fifteenth embodiment exemplified in FIGS. 43A and 43B, in addition, an operation mode of the element is same as the mode described before. However, in the embodiment, the number of patterns given by the voltage output terminals and the current supply terminals is decreased, and two identical patterns are formed on the surface (i.e., semiconductor region 12) of the semiconductor substrate as a pattern given by the terminals. That is, in the vertical Hall element, the contact regions 131a to 131e and 132a to 132e are formed with identical patterns respectively. Again in this case, the two identical patterns configure a pair of patterns that are in a symmetric relation with each other by the contact regions 131a to 131e and 132a to 132e, and both the patterns are formed as a crosswise pattern. However, since the number of patterns is decreased by one here, the contact regions 131a to 131e and 132a to 132e are formed with positions, in which the regions are axisymmetrical with respect to the reference axes P11 to P13 as virtual lines, rather than other patterns (i.e., contact regions), as original positions. That is, when the alignment displacement is not present, as shown in FIG. 46A, midpoints between data PT1 and PT2 in the patterns lie at the displacement level of “0” from the reference position (i.e., center position) and at offset voltage of “0.” Again in this case, such a positional relationship between the data PT1 and PT2 is maintained even when the temperature change or the alignment displacement occurs.

Again in the embodiment, when the alignment displacement occurs, as shown in FIG. 46B, some level of alignment displacement (i.e., displacement level from the center position) and offset voltage appears in the midpoint of the data PT1 and PT2. Therefore, offset voltage is measured on respective patterns similarly as in the previous fifteenth embodiment, and then data lines according to the patterns are made from the measured offset voltage and the previously understood, positional relationships between respective patterns, thereby the correction value of the offset voltage can be obtained easily and accurately independently of temperature (i.e., environmental temperature). Furthermore, the offset voltage of the Hall element can be appropriately corrected and/or removed using the correction value.

As described hereinbefore, according to the vertical Hall element according to the embodiment, advantages equal or similar to the advantages of the above (27) to (32) according to the fifteenth embodiment can be obtained. Moreover, in the vertical Hall element according to the embodiment, since the number of patterns is decreased compared with the previous fifteenth embodiment, while detection accuracy is somewhat sacrificed because of the decreased number of data, signal processing on the data is facilitated, thereby further reduction in scale of the circuit such as correction circuit can be achieved.

### Seventeenth Embodiment

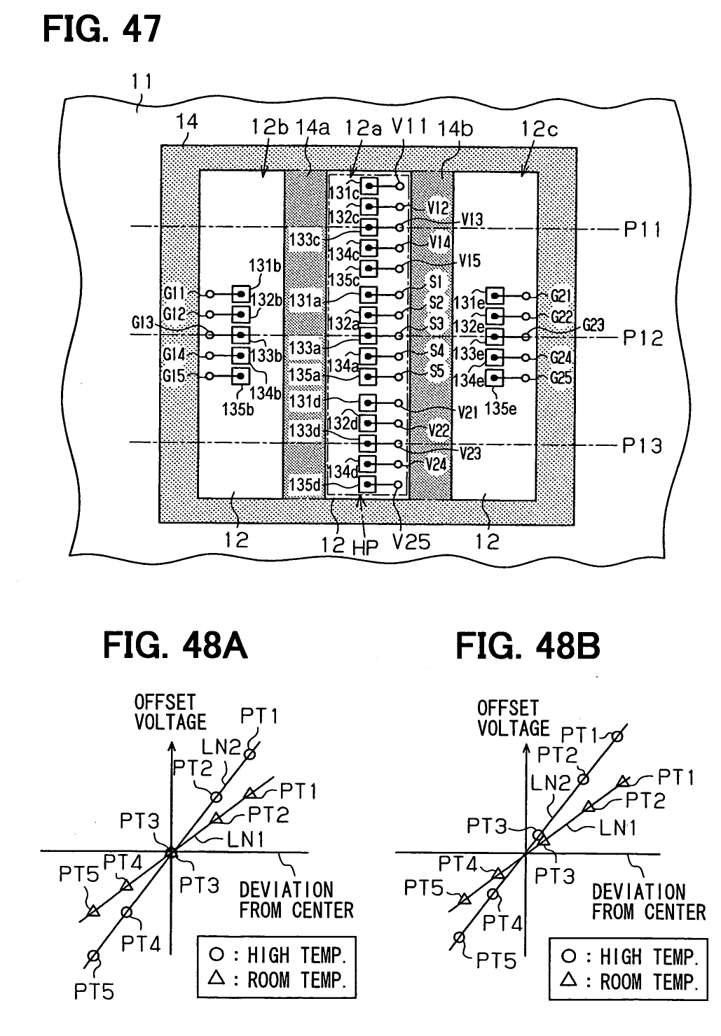

FIG. 47 shows a seventeenth embodiment of a vertical Hall element and a method for adjusting the offset voltage of the element according to the invention.

Hereinafter, a structure of the vertical Hall element according to the embodiment is described with reference to FIG. 47 and FIGS. 48A and 48B mainly on different points from the previous fifteenth embodiment. Herein, a plan view of FIG. 47 corresponds to the plan view of the previous FIG. 43A, and graphs of FIGS. 48A and 48B correspond to the graphs of the previous FIGS. 44A and 44B respectively, and in the FIG. 47, respective elements identical to the elements shown in FIG. 43A are shown with being marked with identical signs, and overlapped description on the elements are omitted.

As shown in the FIG. 47, the vertical Hall element has the approximately same structure as the vertical Hall element of the previous fifteenth embodiment exemplified in FIGS. 43A to 43C, and an operation mode of the element is the same as the mode described before. However, in the embodiment, the number of patterns given by the voltage output terminals and the current supply terminals is increased, and five identical patterns are formed on the surface (i.e., semiconductor region 12) of the semiconductor substrate as a pattern given by the terminals. That is, in the vertical Hall element, the contact regions 131a to 131e, 132a to 132e, 133a to 133e, 134a to 134e, and 135a to 135e, each having an identical pattern, or a crosswise pattern, are formed. Again in this case, the five identical patterns are configured by one reference pattern, and two pairs of patterns that are in a symmetric (i.e., axisymmetrical) relation with each other with the reference pattern as the reference (i.e., axis of symmetry), that is, a pattern pair given by the contact regions 131a to 131e and 135a to 135e and a pattern pair given by the contact regions 132a to 132e and 134a to 134e. The reference pattern herein is a pattern given by the contact regions 133a to 133e, and when the alignment displacement is not present, the regions are arranged on the reference axes P11 to P13. That is, in this case, as shown in FIG. 48A, the data PT3 of the pattern given by the regions lie at the displacement level of “0” from the reference position (i.e., center position) and at offset voltage of “0.” The data PT3 of the reference pattern lie at the midpoints between the data of the two pattern pairs, or midpoints between the data PT1 and PT5, as well as data PT2 and PT4. Again in this case, such a positional relationship among the data PT1 to PT5 is maintained even when the temperature change or the alignment displacement occurs.

In the embodiment, when the alignment displacement occurs, as shown in FIG. 48B, some level of alignment displacement (i.e., displacement level from the center position) and offset voltage appears in the data PT3. Therefore, offset voltage is measured on respective patterns similarly as in the previous fifteenth embodiment, and then data lines according to the patterns are made from the measured offset voltage and the previously understood positional relationships among respective patterns, thereby the correction value of the offset voltage can be obtained easily and accurately independently of temperature (i.e., environmental temperature). Furthermore, the offset voltage of the Hall element can be appropriately corrected and/or removed using the correction value. In addition, in the embodiment, since the correction value is obtained based on the increased number of data by increasing the number of data, the offset voltage can be adjusted (i.e., corrected) in more excellent accuracy.

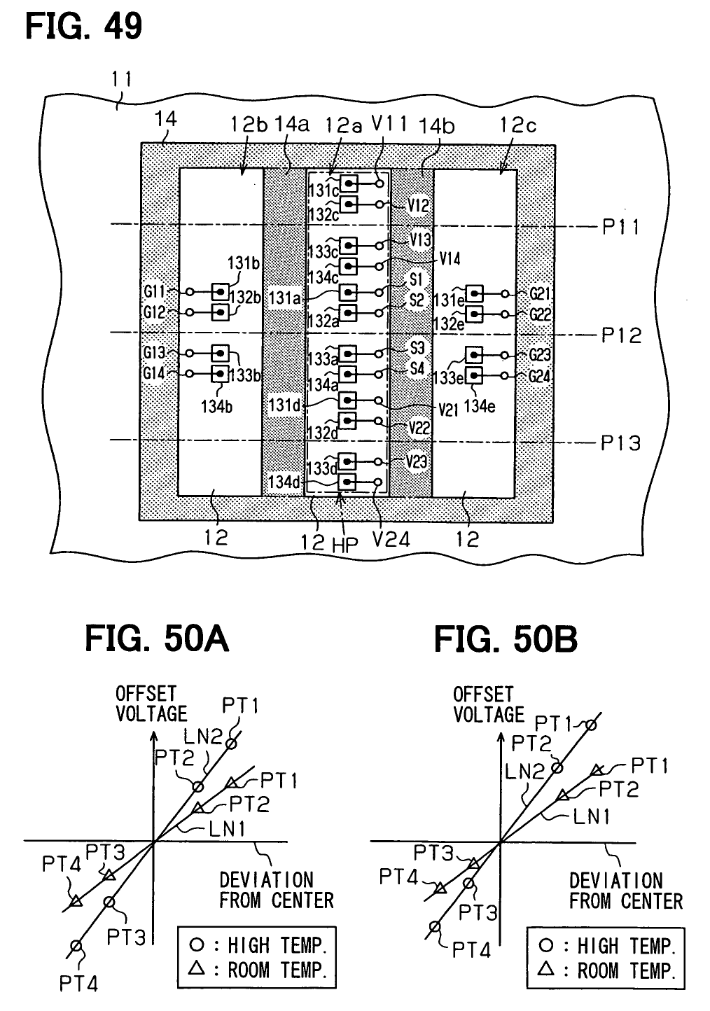

Moreover, as shown in FIG. 49, even in the case that the number of patterns of the vertical Hall element according to the previous sixteenth embodiment is increased, thereby four patterns, which are identical, of voltage output terminals and current supply terminals are formed on the surface (i.e., semiconductor region 12) of the semiconductor substrate, the offset voltage can be adjusted in more excellent accuracy similarly as the above. FIGS. 50A and 50B show an offset voltage characteristic of the vertical Hall element in graphs. The FIGS. 50A and 50B correspond to the previous FIGS. 44A and 44B.

As described hereinbefore, according to the vertical Hall element according to the embodiment, advantages equal or similar to the advantages of the above (27) to (32) according to the previous fifteenth embodiment can be obtained. Moreover, in the vertical. Hall element according to the embodiment, since the number of patterns is increased compared with the previous fifteenth or sixteenth embodiment, the number of data given by the patterns are increased, consequently the offset voltage can be adjusted in more excellent accuracy.

The fifteenth to seventeenth embodiments can be practiced in the following mode.

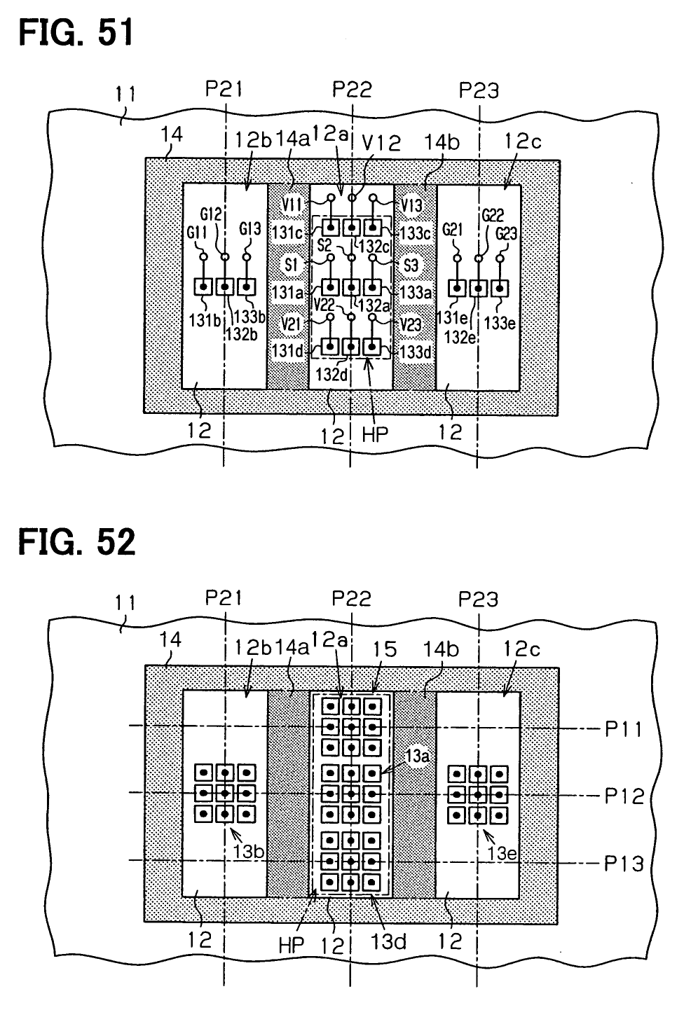

While respective patterns are formed in a manner of being displaced in an layout direction of the voltage output terminals on the assumption that alignment displacement occurs along such a direction in the fifteenth to seventeenth embodiments, the formation of the patterns are not limited to this, and for example, as shown in FIG. 51, respective patterns may be formed in a manner of being displaced in a layout direction of the current supply terminals (i.e., horizontal direction in the figure). While a modification of the vertical Hall element according to the fifteenth embodiment is shown in FIG. 51, the vertical Hall elements according to the sixteenth and seventeenth embodiments can be similarly modified. Reference axes P21 to P23 in FIG. 51 correspond to the reference axes P11 to P13 in FIGS. 43A to 43C.

Furthermore, in order to respond to alignment displacement in both the layout direction of the voltage output terminals and the layout direction of the current supply terminals, for example as shown in FIG. 52, respective patterns may be arrayed in a lattice of columns and rows. While a modification of the vertical Hall element according to the fifteenth embodiment is shown in FIG. 52, the vertical Hall elements according to the sixteenth and seventeenth embodiments can be similarly modified. Contact regions 13a to 13e in FIG. 52 correspond to the contact regions 131a to 133a, 131b to 133b, 131c to 133c, 131d to 133d, and 131e to 133e in FIGS. 43A to 43C respectively.

Regarding the fifteenth to seventeenth embodiments, a configuration where a wiring material at least part of which can be temporarily or permanently disconnected is arranged on respective contact regions is used, thereby the offset voltage can be adjusted (i.e., corrected) more easily and more appropriately through disconnection of the wiring material arranged on the contact regions respectively. Furthermore, since a desired pattern can be freely selected from a plurality of identical patterns, even when the alignment displacement occurs, more accurate magnetic detection using such a pattern that the offset voltage (i.e., unbalanced voltage) is most reduced can be realized by selecting any one of the patterns. As the wiring material at least part of which can be temporarily or permanently disconnected, the following materials can be employed:

(a) a wiring material having a fuse comprising, for example, polycrystalline silicon (i.e., poly-Si) or Al (i.e., aluminum), which is self-disconnected by overcurrent;

(b) a wiring material having a thin film resistance comprising, for example, CrSi or Al (i.e., aluminum), which can be disconnected by laser trimming; and

(c) a wiring material having a switching element that performs switching operation in response to an external signal.

When the switching element is used, an appropriate configuration including a configuration where the relevant switching element is connected to a memory (for example, EPROM, EEPROM, flash memory, and ROM) in which adjustment data have been stored via an appropriate decoder is desirably used depending on use of the Hall element and the like.

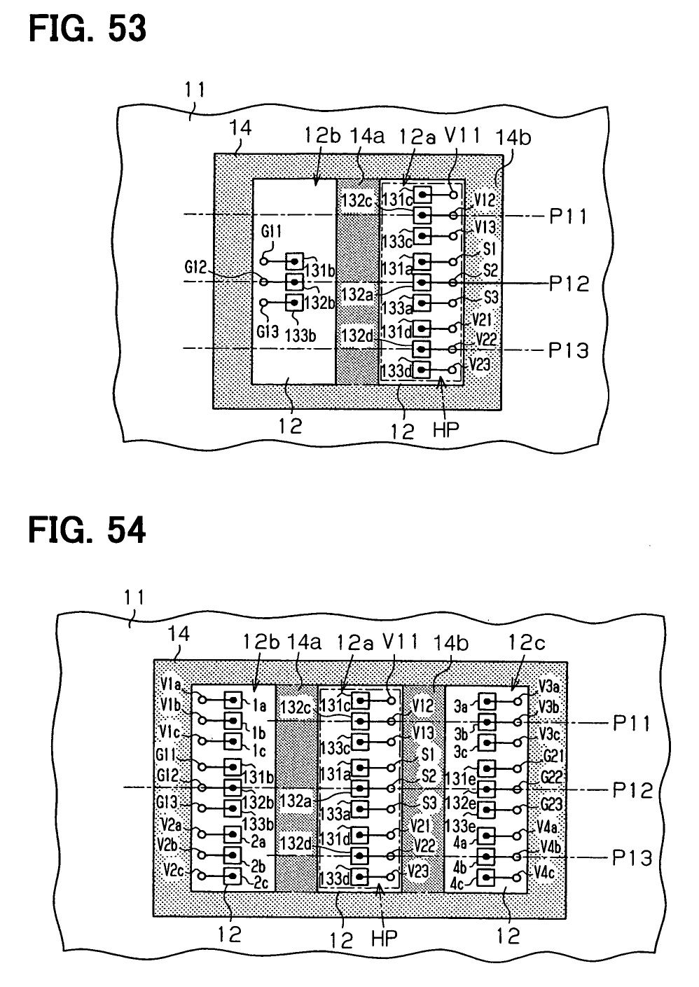

While the vertical Hall element having two current channels during driving is supposed in the fifteenth to seventeenth embodiments, the invention is not limited to this, and the invention can be similarly applied to a vertical Hall element having only one current channel during driving. For example, as shown in FIG. 53, even in a structure where a region 12c or contact regions 131e to 133e at a side of the terminals G21 to G23 is/are omitted from the vertical Hall element according to the fifteenth embodiment, advantages equal or similar to the above advantages are obtained. In addition, when such a structure is made, area is reduced by approximately “third” compared with the vertical Hall element as shown in the previous FIGS. 43A to 43C, consequently significant size reduction can be achieved. The operation mode of such a Hall element is still the same as that of the previous vertical Hall element exemplified in FIGS. 43A to 43C.

In addition, the number of the voltage output terminals is not limited to one pair, and can be optionally set. For example, as shown in FIG. 54, the vertical Hall element according to the fifteenth embodiment may have a structure where contact regions 1a to 1c and 2a to 2c, and contact regions 3a to 3c and 4a to 4c, corresponding to voltage output terminals, are provided even for contact regions 131e to 133e and 131b to 133b, corresponding to the current supply terminals, respectively. In such a structure, characteristics of output voltage (Vₒᵤₜ) of the terminals V1a to V1c and V2a to V2c and the terminals V3a to V3c and V4a to V4c are reverse to characteristics of output voltage (Vₒᵤₜ) of the terminals V11 to V13 and V21 to V23 arranged on the region 12a (i.e., polarity is reverse). Therefore, the number of data for obtaining the correction value is increased, consequently the offset voltage can be adjusted in more excellent accuracy.

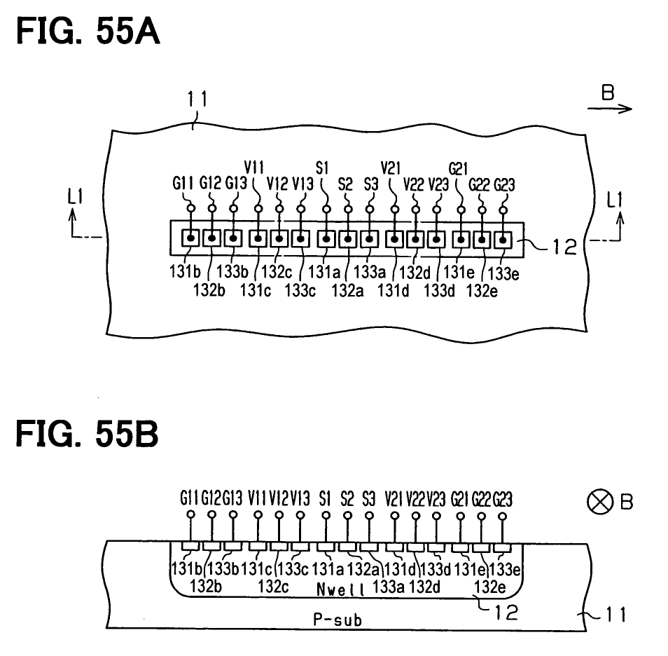

Here, as a pattern given by the voltage output terminals and the current supply terminals, several patterns in which at least one of the terminals are symmetrically disposed with the other as the reference are exemplified. However, the patterns (i.e., pattern layouts) are not limited to them, and any optional pattern can be used. That is, for example, as shown in FIGS. 55A and 55B, a pattern in which the contact regions 131e to 133e, 131b to 133b, and 131a to 133a corresponding to the current supply terminals and the contact regions 131c to 133c and 131d to 133d corresponding to voltage output terminals are arrayed in a line can be appropriately used. FIG. 55A is a plan view schematically showing a planar structure of the Hall element, and FIG. 55B is a cross section view along a line L1-L1 of FIG. 55A. The operation principle of such a vertical Hall element is the same as that of the vertical Hall element described in the non-patent literature 2.

Furthermore, the number of such patterns is set optionally. In a word, when a structure is given such that the voltage output terminals that output the Hall voltage signals in pairs, and the current supply terminals in pairs as portions for supplying current to the magnetic detection part are formed on the surface of the semiconductor substrate in at least two identical patterns, advantages at least equal or similar to the advantages of the above (27) can be obtained.

On the other hand, as a method for adjusting the offset voltage, when the method is a method wherein a substrate having at least two identical patterns on a surface, the patterns being given by both terminals of the voltage output terminals that output the Hall voltage signal in pairs, and the current supply terminals in pairs as portions for supplying current to the magnetic detection part, is prepared, and the correction value of the offset voltage is obtained from a relation between positions of the patterns and the offset voltage, it is adequate. According to such a method, advantages at least equal of similar to the advantages of the above (32) can be obtained.

### Eighteenth Embodiment

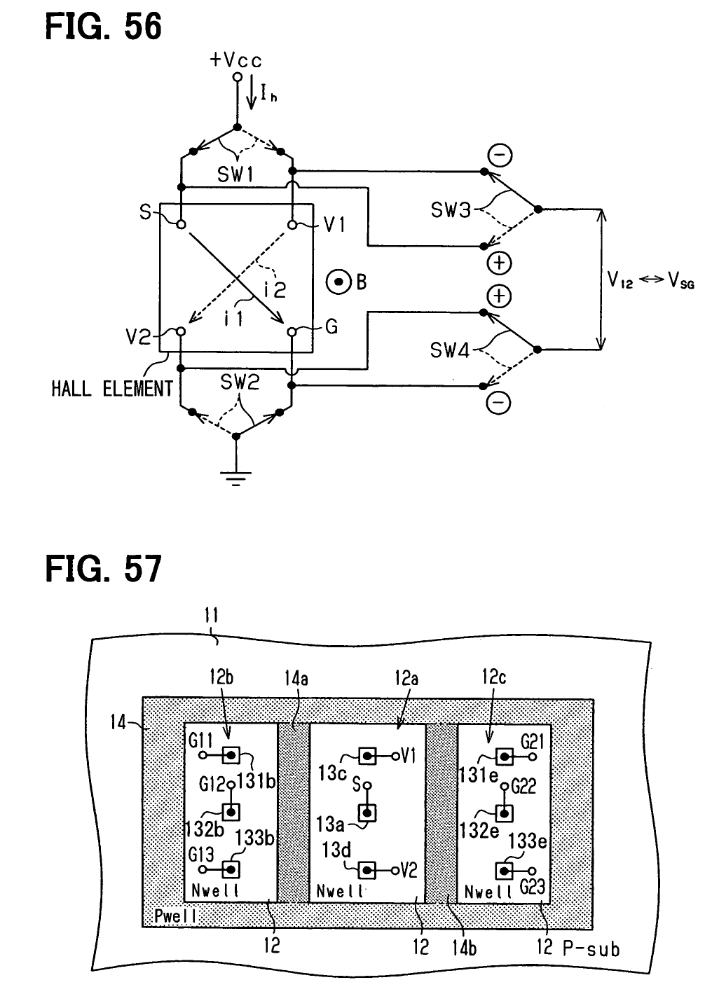

Hereinafter, an eighteenth embodiment of a vertical Hall element and a method for adjusting the offset voltage of the element according to the invention is described with reference to FIG. 56 and FIG. 57 together.

First, a principle of canceling the offset voltage by chopper drive is described with reference to FIG. 56. Here, for convenience of description, using the horizontal Hall element shown in the previous FIGS. 68A and 68B as an example, a case that the chopper drive is applied to the Hall element is described.

As shown in the FIG. 56, in driving the Hall element, for example, when drive current Iₕ is made to flow from a terminal S to a terminal G, the current flows in a direction as shown by an arrow i1 in the figure. In this case, a Hall voltage signal Vₕ₁₂ to the drive current Iₕ is detected through terminals V1 and V2. More specifically, difference in electric potential (i.e., electric voltage) V₁₂ between the terminals V1 and V2 is expressed as “V₁₂=Vₕ₁₂+Vₒₛ₁₂” (Vₒₛ₁₂; offset voltage). On the other hand, when the two sets of terminals (i.e., electrodes) are exchanged, that is, for example, switches SW1 to SW4 in the figure are changed respectively so that the drive current Iₕ is made to flow from the terminal V1 to the terminal V2, the current flows in a direction as shown by a dashed arrow i2 in the figure. In this case, a Hall voltage signal V_{hSG} to the drive current Iₕ is detected through the terminals S and G. More specifically, difference in electric potential (i.e., electric voltage) V_{SG} between the terminals S and G is expressed as “V_{SG}=V_{hSG}+V_{osSG}” (V_{osSG}; offset voltage).

Here, the offset voltage Vₒₛ₁₂ and V_{osSG} in the two cases are in a relation of “Vₒₛ₁₂≅−V_{osSG}” from symmetry of layout of the two sets of terminals (i.e., electrodes). That is, the voltage signals V₁₂ and V_{SG} in the two cases are summed, thereby offset voltage included in the voltage signals is cancelled to each other. Specifically, for example, the Hall voltage signal is detected while the two sets of terminals (i.e., electrodes) are periodically exchanged, and output as the magnetic sensor (i.e., sensor output) is obtained as a result of calculation such as “V₁₂+V_{SG}/2,” thereby the offset voltage is cancelled. In this way, by using such a drive method (i.e., chopper drive), sensor output from which the offset voltage is decreased can be obtained, consequently magnetic detection can be performed in more excellent accuracy as the magnetic sensor.

According to the vertical Hall element and a method for adjusting the offset voltage of the element according to the embodiment, the chopper drive, which is traditionally hard to be realized in the vertical Hall element, can be realized even in the vertical Hall element, consequently the magnetic detection can be performed in more excellent accuracy.

That is, in this method, first, for example, as a vertical Hall element shown in FIG. 57, a substrate having a plurality of pairs formed on a surface by current supply terminals in pairs as portions for supplying current to the magnetic detection part HP is prepared. For example, in the vertical Hall element, a contact region 13a, and contact regions 131e to 133e and 131b to 133b in pairs with the region 13a are formed on a surface of the substrate, and plurality of pairs are formed on the substrate surface by any optional combinations of these two types of contact regions. FIG. 57 is a plan view corresponding to the previous FIG. 43A, and in the FIG. 57, elements identical to the elements shown in FIG. 43A are marked with identical signs respectively.

Then, the prepared vertical Hall element (i.e., semiconductor substrate) is driven by the chopper drive. That is, for example, constant drive current is made to flow from a terminal S (i.e., contact region 13a) to a terminal G21 (i.e., contact region 131e) and from the terminal S to a terminal G12 (i.e., contact region 131b) respectively, and a Hall voltage signal is detected through terminals V1 (i.e., contact region 13c) and V2 (i.e., contact region 13d). In addition, current supply terminals (i.e., electrodes) are changed, and for example, constant drive current is made to flow from the terminal S to a terminal G23 (i.e., contact region 133e), and from the terminal S to a terminal G13 (i.e., contact region 133b) respectively, and the Hall voltage signal is detected through the terminals V1 and V2. Then, the change of the current supply terminals is periodically performed, that is, a direction of drive current is periodically changed, thereby the relevant Hall element is driven while the offset voltage is cancelled by using the sum of voltage signals detected through the sets of respective terminals. In this way, according to the vertical Hall element and a method for adjusting the offset voltage of the element according to the embodiment, the chopper drive that is traditionally hard to be realized in the vertical Hall element, that is, a drive method where the relevant Hall element is driven while the offset voltage is cancelled by periodically changing the direction of the drive current can be realized.

Here, a pair given by the contact regions 13a and 131e and a pair given by the contact regions 13a and 133e, in addition, a pair given by the contact regions 13a and 131b and a pair given by the contact regions 13a and 133b are symmetrically disposed respectively in viewing from voltage output terminals (i.e., contact regions 13c and 13d). Therefore, the previous approximate equation “Vₒₛ₁₂≅−V_{osSG}” holds true in more excellent accuracy, consequently the offset voltage is cancelled more efficiently.

As described hereinbefore, according to the vertical Hall element and a method for adjusting the offset voltage of the element according to the embodiment, advantages equal or similar to the advantages of the above (28) and (31) according to the previous fifteenth embodiment are obtained, in addition, the following advantages are obtained.

(33) The configuration in which a plurality of pairs are formed on the surface (i.e., semiconductor region 12) of the semiconductor substrate as the vertical Hall element by the current supply terminals in pairs as the portions for supplying current to the magnetic detection part HP. Thus, the chopper drive that is traditionally hard to be realized in the vertical Hall element can be realized.

(34) Moreover, the plurality of pairs given by the current supply terminals are formed in the patterns that are symmetrically disposed with the voltage output terminals as the reference, thereby the offset voltage can be efficiently cancelled.

(35) Furthermore, when such a vertical Hall element is driven, the substrate having the plurality of pairs formed on its surface by the current supply terminals is used as the semiconductor substrate, and the relevant Hall element is driven while the offset voltage is cancelled by periodically changing the current direction to the magnetic detection part HP by the plurality of pairs. By using such a drive method, the offset voltage is preferably decreased, and in the configuration having the correction circuit on the offset voltage as described before, reduction in scale of the circuit can be achieved.

The drive method of the vertical Hall element is merely an example, and not restrictive.

That is, for example, constant drive current is made to flow from the terminal S to the terminal G23, and from the terminal S to the terminal G11 respectively, and the Hall voltage signal is detected through the terminals V1 and V2. In addition, the current supply terminals (i.e., electrodes) are changed, and constant drive current is made to flow from the terminal S to the terminal G21, and from the terminal S to the terminal G13 respectively, and the Hall voltage signal is detected through the terminals V1 and V2. Then, even when a drive method is such that such change of the current supply terminals is periodically performed, thereby the relevant Hall element is driven with the offset voltage being cancelled, the method can be appropriately used.

Furthermore, a drive method in which a period while constant drive current is made to flow from the terminal S to the terminal G22 (i.e., contact region 132e), and from the terminal S to the terminal G12 (i.e., contact region 132b) respectively, and the Hall voltage signal is detected through the terminals V1 and V2 is added to the drive method of the eighteenth embodiment and the drive method of the modification can be also used. That is, in this case, the relevant Hall element is driven while the three voltage signals detected through the sets of respective terminals are summed to cancel the offset voltage with the three current directions being periodically changed.

Moreover, a drive method in which directions of the drive current in these drive methods are reversed can be also used. That is, for example, the direction of the drive current in the drive method of the eighteenth embodiment is reversed, and constant drive current is made to flow from the terminal G21 to the terminal S, and from the terminal G11 to the terminal S respectively, and the Hall voltage signal is detected through the terminals V1 and V2. When the current supply terminals (i.e., electrodes) are changed, the constant drive current is made to flow from the terminal G23 to the terminal S, and from the terminal G13 to the terminal S respectively, and the Hall voltage signal is detected through the terminals V1 and V2. A drive method in which the relevant Hall element is driven while the offset voltage is cancelled by periodically performing the change of the current supply terminals can be also used.

The vertical Hall element (i.e., semiconductor substrate) used for such a drive method is not limited to the element exemplified in FIG. 57. For example, the drive method can be applied to the vertical Hall element (i.e., semiconductor substrate) according to the fifteenth to seventeenth embodiments or modifications of them. In a word, as long as the vertical Hall element (i.e., semiconductor substrate) having a plurality of pairs formed on the surface by the current supply terminals is given, such a drive method can be used. In the vertical Hall element of the fifteenth embodiment, the contact regions 131a to 133a, and the contact regions 131e to 133e and 131b to 133b which are in pairs with the regions 131a to 133a are formed on the substrate surface, and a plurality of pairs by any optional combinations of the two types of contact regions are formed on the substrate surface.

Eventually, when a structure is given such that it has a plurality of pairs formed on the surface of the semiconductor substrate by the current supply terminals in pairs as the portion for supplying current to the magnetic detection part, advantages at least equal or similar to the advantages of the above (33) can be obtained.

On the other hand, as the method for adjusting the offset voltage, when the method is a method wherein a substrate having a plurality of pairs formed on the surface by the current supply terminals in pairs as the portion for supplying current to the magnetic detection part is used as the semiconductor substrate, and the relevant Hall element is driven while the offset voltage is cancelled by periodical change of the current direction to the magnetic detection part by the plurality of pairs, it is adequate. According to such a method, advantages at least equal or similar to the advantages of the above (35) can be obtained.

### Nineteenth Embodiment

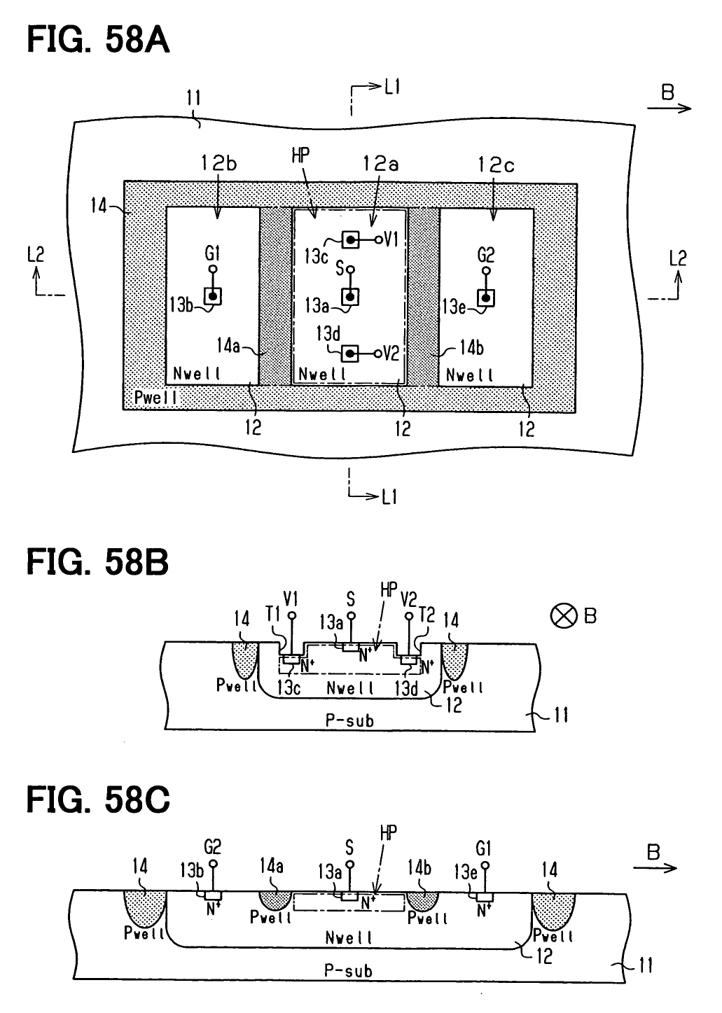

FIGS. 58A to 58C show a nineteenth embodiment of a vertical Hall element and a method for adjusting the offset voltage of the element according to the invention.

Hereinafter, a structure of the vertical Hall element according to the embodiment is described with reference to FIGS. 58A to 58C mainly on different points from the previous fifteenth embodiment. FIGS. 58A to 58C correspond to the previous FIGS. 43A to 43C, and in FIGS. 58A to 58C, respective elements identical to the elements shown in the previous FIGS. 43A to 43C are shown with being marked with identical signs, and overlapped description on the elements are omitted.

As shown in the FIGS. 58A to 58C, the vertical Hall element has a structure similar to the previous vertical Hall element of the fifteenth embodiment exemplified in FIGS. 43A to 43C, in addition, an operation mode of the element is the same as the mode as described before. However, in the Hall element, the number of patterns of the voltage output terminal and the current supply terminal is one each. That is, in a region (i.e., active region) that is situated on the surface of the semiconductor region 12 and enclosed by the diffusion layer 14, contact regions (i.e., N⁺ layer) 13a to 13e are formed in a manner of selectively increasing impurity concentration (i.e., N-type) of the surface. The contact regions 13a to 13e are electrically connected to terminals S, G1, G2, V1 and V2 via respective electrodes (i.e., wiring lines) arranged thereon. Again in this case, the contact regions 13e, 13b and 13a correspond to the current supply terminals, and the contact regions 13c and 13d correspond to the voltage output terminals.

In the vertical Hall element according to the embodiment, the contact regions 13c and 13d corresponding to the voltage output terminals are formed in recesses provided on a substrate surface (i.e., semiconductor region 12), specifically on bottoms of trenches T1 and T2 formed on the surface of the substrate, respectively. The trenches T1 and T2 need not have the same depth, and may be set to have different depth. The trenches T1 and T2 can be formed, for example, by etching, laser elution, and ion milling cutting. Then, a trench having a desired depth can be obtained by appropriately setting the formation condition.

In this way, a structure where the voltage output terminals are formed in the recesses (i.e., trenches T1 and T2) provided on the substrate surface is made, thereby the magnetic detection part HP can be distorted through adjustment of depth of the trenches T1 and T2, and potential distribution (i.e., equipotential line) within the element can be displaced. Thus, desired potential distribution, or potential distribution for decreasing the offset voltage is obtained. In this way, according to such a structure, preferable correction of the offset voltage is possible, and in the configuration having the correction circuit on the offset voltage as described above, reduction in scale of the circuit can be achieved. The offset voltage is adjusted typically in different tendency between a case of adjusting depth of the trench T1 and a case of adjusting depth of the trench T2. Therefore, adjustment of the offset voltage is performed with considering balance of depth between the trenches T1 and T2.

Moreover, the vertical Hall element is in a structure where a step is formed between the contact regions 13c, 13d corresponding to the voltage output terminals and a contact region 13a corresponding to the current supply terminal on the surface of the semiconductor substrate. The step is strongly correlated with the offset voltage, and by using such a structure, adjustment (i.e., correction) of the offset voltage can be performed more preferably through adjustment of height of the step.

As described hereinbefore, according to the vertical Hall element and a method for adjusting the offset voltage of the element according to the embodiment, advantages equal or similar to the advantages of the above (28) and (31) according to the previous fifteenth embodiment are obtained, in addition, the following advantages are obtained.

(36) The contact regions 13c, 13d corresponding to the voltage output terminals that output Hall voltage signals in pairs are formed in the recesses provided on the substrate surface (i.e., semiconductor region 12). Thus, the offset voltage can be preferably corrected, and in the configuration having the correction circuit on the offset voltage as described above, reduction in scale of the circuit can be achieved.

(37) A structure in which the step is formed on the surface of the semiconductor substrate between the contact region 13a corresponding to the current supply terminals in pairs as the portion for supplying current to the magnetic detection part HP and the contact regions 13c, 13d corresponding to the voltage output terminals is made. Thus, adjustment (i.e., correction) of the offset voltage can be performed more preferably.

(38) A substrate having the current supply terminals in pairs as a portion for supplying current to the magnetic detection part HP, and voltage output terminals that output Hall voltage signals in pairs on a surface is used as the semiconductor substrate, and the offset voltage is adjusted by selective height adjustment of a portion at which the terminals are formed in the surface of the substrate. According to such a method, the magnetic detection part HP can be distorted through adjustment of height of the terminals, and potential distribution (i.e., equipotential line) within the element can be displaced, consequently the desired potential distribution, or potential distribution for decreasing the offset voltage is obtained. That is, preferable correction of the offset voltage can be performed, and in the configuration having the correction circuit on the offset voltage as described above, reduction in scale of the circuit can be achieved.

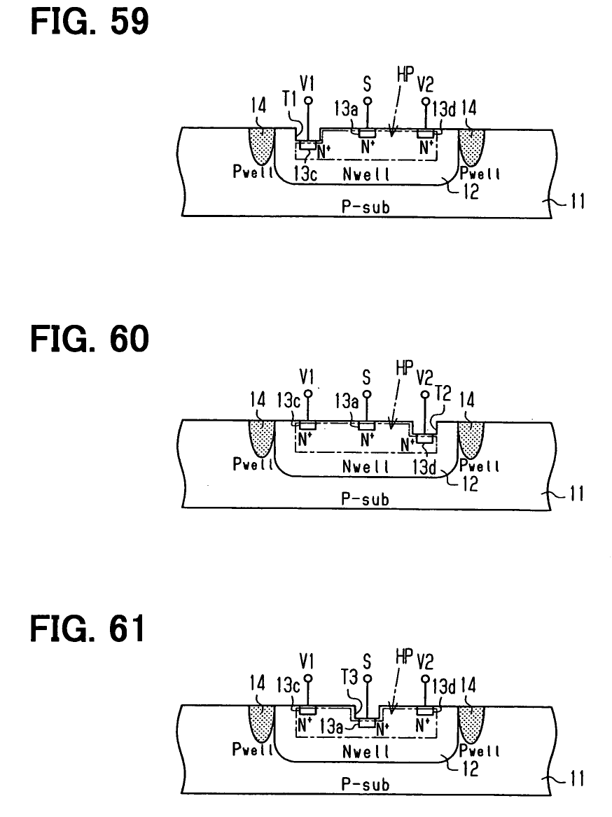

As shown in FIG. 59 or FIG. 60, the vertical Hall element according to the nineteenth embodiment may have a structure where only one of the contact regions 13c, 13d corresponding to the voltage output terminals is formed in the recess provided on the substrate surface, or the bottom of the trench T1 or T2 formed on the surface of the substrate.

As shown in FIG. 61, the element may have a structure where the contact region 13a corresponding to one of the current supply terminals in pairs, which is interposed by the contact regions 13c and 13d, is formed in the recess provided on the substrate surface, or the bottom of the trench T3 formed on the surface of the substrate.

On the other hand, as shown in FIG. 62, the element may have a structure where the contact regions 13c, 13d corresponding to the voltage output terminals are formed on convex portions B1 and B2 provided on the substrate surface respectively.

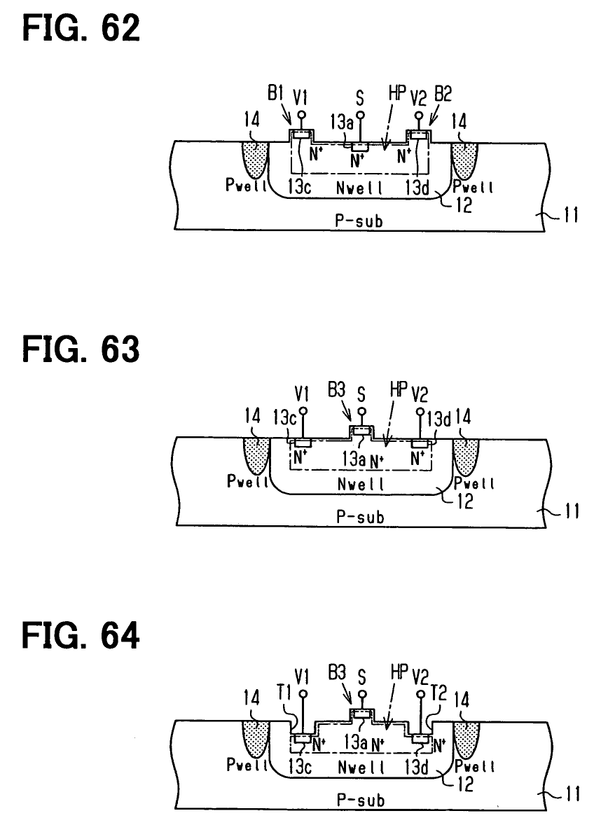

As shown in FIG. 63, the element may have a structure where the contact region 13a corresponding to one of the current supply terminals in pairs, which is interposed by the contact regions 13c and 13d, is formed on a convex portion B3 provided on the substrate surface.

Furthermore, as shown in FIG. 64, the element may have a structure where the recesses and the concave portion are combined, and the contact regions 13c and 13d are formed in the recesses (i.e., trenches T1 and T2) provided on the substrate surface, and the contact region 13a is formed on the convex portion B3 provided on the substrate surface, respectively.

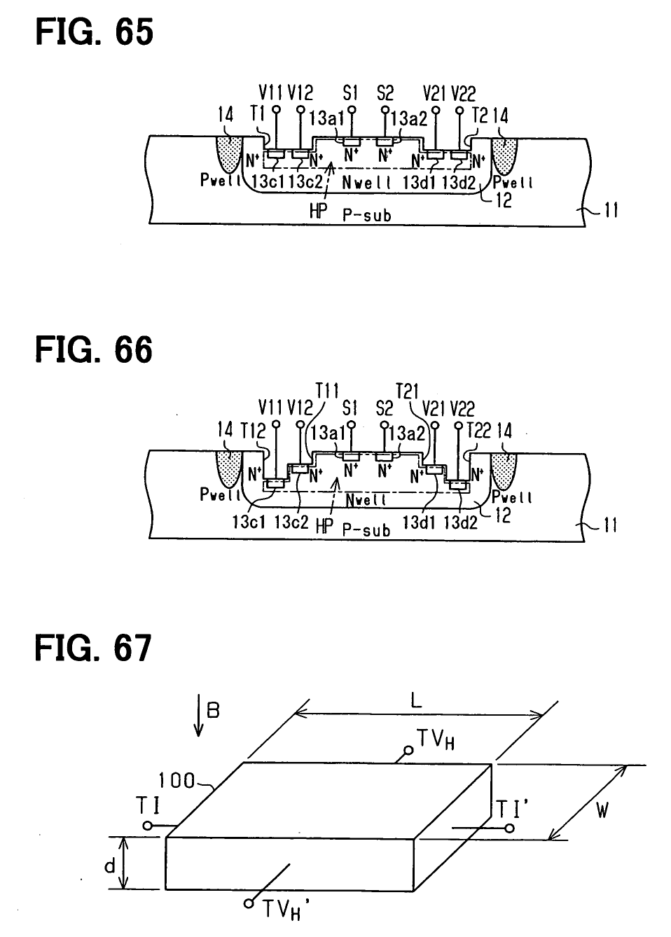

The structure can be similarly applied to the vertical Hall elements according to the fifteenth to eighteenth embodiments and modifications of them. That is, for example, in the case that it is applied to the vertical Hall element of the sixteenth embodiment, as shown in FIG. 65, the element has a structure in which the contact regions 13c1 and 13c2 and the contact regions 13d1 and 13d2, corresponding to the voltage output terminals of respective patterns described above, are formed in the recesses provided on the substrate surface (i.e., bottoms of trenches T1 and T2). In this case, the contact regions 13c1, 13c2 and the contact regions 13d1, 13d2 need not be formed in trenches having the same depth, and as shown in FIG. 66, the contact regions may formed in the trenches T11, T12 and the trenches T21, T22, each of them having different depth to each other, respectively.

Eventually, when the element has a structure in which at least one of the voltage output terminals that output the Hall voltage signals in pairs, and at least one of current supply terminals in pairs as the portion for supplying current to the magnetic detection part are formed in the recess or on the concave portion provided on the surface of the semiconductor substrate, advantages at least equal or similar to the advantages of the above (36) can be obtained.

On the other hand, as a method for adjusting the offset voltage, when the method is a method wherein a substrate having the current supply terminals in pairs as portions for supplying current to the magnetic detection part, and the voltage output terminals that output the Hall voltage signal in pairs, is prepared, and the offset voltage is adjusted by selectively adjusting height of a portion of the substrate surface on which at least one of the terminals is formed, it is adequate. When such a method is used, advantages at least equal or similar to the advantages of the above (38) can be obtained.

### Modifications

Each of the fifteenth to nineteenth embodiments can be also practiced in the following mode.

While the diffusion layer (i.e., diffusion layer 14 or diffusion layers 14a and 14b) is used as the separation barrier for isolating the relevant Hall element from other elements and as the separation barrier for electrically partitioning the magnetic detection part HP in each of the fifteenth to nineteenth embodiments, trench isolation may be used instead of it.

Furthermore, the isolation barriers are not always limited components, and can be omitted depending on a type of the Hall element or use of the element. For example, the vertical Hall element previously shown as the modification of the fifteenth to seventeenth embodiments, or the vertical Hall element in which the current supply terminals and the voltage output terminals are arrayed in a line (FIGS. 55A and 55B) is not necessarily required to have such a separation barrier. As described before, the invention can be similarly applied to such a vertical Hall element.

In each of the fifteenth to nineteenth embodiments, both of the voltage output terminals and the current supply terminals are provided as the contact region (i.e., N⁺ layer) in which concentration of the conductivity type impurity is selectively increased at the substrate surface. However, this is not a limited configuration, and for example, wiring lines (i.e., electrodes) may be directly provided on the semiconductor region 12 without providing such a contact region.

While the constant current drive is described as an example of the method for driving the vertical Hall element in the fifteenth to nineteenth embodiments, the drive method of the vertical Hall element can be optionally selected, and for example, the element can be driven by constant voltage drive.

The invention can be also applied to a structure in which the conductivity type of respective components configuring the semiconductor substrate is exchanged, that is, it can be similarly applied to a structure in which the P-type is exchanged for the N-type, in each of the fifteenth to nineteenth embodiment.

While silicon is used for the material of the substrate in each of the fifteenth to nineteenth embodiment, other materials may be appropriately used depending on manufacturing processes, structural conditions and the like. For example, compound semiconductor materials such as GaAs, InSb, InAs and SiC, or other semiconductor materials such as Ge (i.e., germanium) can be used. Particularly, GaAs and InSb are materials having an excellent temperature characteristic, and effective for improving sensitivity of the relevant Hall element.

While the semiconductor region 12 is formed as the diffusion layer in each of the fifteenth to nineteenth embodiments, it is not limited to this, and for example, the invention can be similarly applied to a structure in which the semiconductor region 12 is formed as an epitaxial film as the conventional vertical Hall element as shown in FIGS. 70A to 70C. Generally, when such an epitaxial substrate is used, the buried layer BL (FIGS. 70A to 70C) is often used. Alternatively, a SOI (i.e., Silicon On Insulator) substrate and the like can be appropriately used.

Each of the fifteenth to nineteenth embodiments can be also practiced in the following mode.

While respective patterns are formed in a manner of being displaced in a layout direction of the voltage output terminals on the assumption that alignment displacement occurs along such a direction in the fifteenth to seventeenth embodiments, the formation of the patterns are not limited to this, and for example, as shown in FIG. 60, respective patterns may be formed in a manner of being displaced in a layout direction (i.e., horizontal direction in the figure) of the current supply terminals. While a modification of the vertical Hall element according to the fifteenth embodiment is shown in FIG. 60, the vertical Hall elements according to the sixteenth and seventeenth embodiments can be similarly modified. Reference axes P21 to P23 in FIG. 60 correspond to the reference axes P11 to P13 in FIGS. 43 to 43C.

Furthermore, in order to respond to alignment displacement in both the layout direction of the voltage output terminals and the layout direction of the current supply terminals, for example, as shown in FIG. 61, respective patterns may be arrayed in a lattice of columns and rows. While a modification of the vertical Hall element according to the fifteenth embodiment is shown in FIG. 61, the vertical Hall elements according to the sixteenth and seventeenth embodiments can be similarly modified. Contact regions 13a to 13d in FIG. 61 correspond to the contact regions 131a to 133a, 131b to 133b, 131c to 133c, 131d to 133d, and 131e to 133e in FIGS. 43 to 43C respectively.

Regarding the fifteenth to seventeenth embodiments, a configuration where a wiring material at least part of which can be temporarily or permanently disconnected is arranged on respective contact regions is used; thereby the offset voltage can be adjusted (i.e., corrected) more easily and more appropriately through disconnection of the wiring material arranged on the contact regions respectively. Furthermore, since a desired pattern can be freely selected from a plurality of identical patterns, even when the alignment displacement occurs, more accurate magnetic detection using such a pattern that the offset voltage (i.e., unbalanced voltage) is most reduced can be realized by selecting any one of the patterns. As the wiring material at least part of which can be temporarily or permanently disconnected, the following materials can be employed:

(a) a wiring material having a fuse comprising, for example, polycrystalline silicon (i.e., poly-Si) or Al (i.e., aluminum), which is self-disconnected by overcurrent;

(b) a wiring material having a thin film resistance comprising, for example, CrSi or Al (i.e., aluminum), which can be disconnected by laser trimming; and

(c) a wiring material having a switching element that performs switching operation in response to an external signal.

When the switching element is used, an appropriate configuration including a configuration where the relevant switching element is connected to a memory (for example, EPROM, EEPROM, flash memory, and ROM) in which adjustment data have been stored via an appropriate decoder is desirably used depending on use of the Hall element and the like.

While the vertical Hall element having two pairs of current supply terminals was supposed in each of the fifteenth to nineteenth embodiments, the invention is not limited to this, and the invention can be similarly applied to a vertical Hall element having one pair of current supply terminals. For example, as shown in FIG. 62, even when a structure is made such that it has a region 12c or contact regions 131e to 133e at a side of the terminals G21 to G23 omitted from the vertical Hall element according to the fifteenth embodiment, the invention can be applied thereto. In addition, when such a structure is used, area is reduced by approximately “third” compared with the vertical Hall element as shown in the previous FIGS. 43A to 43C, consequently significant size reduction can be achieved. The operation mode of such a Hall element is still the same as that of the previous vertical Hall element exemplified in FIGS. 43A to 43C.

In addition, the number of the voltage output terminals is not limited to one pair, and can be optionally set. For example, as shown in FIG. 63, the vertical Hall element according to the fifteenth embodiment may have a structure where contact regions 1a to 1c and 2a to 2c, and contact regions 3a to 3c and 4a to 4c, corresponding to voltage output terminals, are provided even for contact regions 131e to 133e and 131b to 133b, corresponding to the current supply terminals, respectively. In such a structure, characteristics of output voltage (Vₒᵤₜ) of the terminals V1a to V1c and V2a to V2c and the terminals V3a to V3c and V4a to V4c are reverse to characteristics of output voltage (Vₒᵤₜ) of the terminals V11 to V13 and V21 to V23 arranged on the region 12a (i.e., polarity is reverse). Therefore, the number of data for obtaining the correction value is increased; consequently the offset voltage can be adjusted in more excellent accuracy.

While the diffusion layer (i.e., diffusion layer 14 or diffusion layers 14a and 14b) is used as the separation barrier for isolating the relevant Hall element from other elements and as the separation barrier for electrically partitioning the magnetic detection part HP in each of the fifteenth to nineteenth embodiments, trench isolation may be used instead of it.

Furthermore, the isolation barriers are not always limited components, and can be omitted depending on a type of the Hall element or use of the element. For example, the vertical Hall element as shown in FIGS. 64A and 64B is not required to have such separation barriers. As shown in FIGS. 64A and 64B, in the vertical Hall element, the contact regions 131e to 133e, 131b to 133b, and 131a to 133a corresponding to the current supply terminals, and the contact regions 131c to 133c and 131d to 133d corresponding to voltage output terminals are arrayed in a line. The invention can be similarly applied to such a vertical Hall element. An operation principle of the vertical Hall element is similar to that of the vertical Hall element described in R. S. Popovic, “The Vertical Hall-Effect Device,” IEEE ELECTRON DEVICE LETTER, SEPTEMBER 1984, EDL-5, No. 9, pp 357-358.

In each of the fifteenth to nineteenth embodiments, both of the voltage output terminals and the current supply terminals are provided as the contact region (i.e., N⁺ layer) in which concentration of the conductivity type impurity was selectively increased at the substrate surface. However, this is not a limited configuration, and for example, wiring lines (i.e., electrodes) may be directly provided on the semiconductor region 12 without providing such a contact region.

While the constant current drive is described as an example of the method for driving the vertical Hall element in the fifteenth to nineteenth embodiments, the drive method of the vertical Hall element can be optionally selected, and for example, the element can be driven by constant voltage drive.

The invention can be also applied to a structure in which the conductivity type of respective components configuring the semiconductor substrate is exchanged, that is, it can be similarly applied to a structure in which the P-type is exchanged for the N-type, in each of the fifteenth to nineteenth embodiment.

While silicon was used for the material of the substrate in each of the fifteenth to nineteenth embodiment, other materials may be appropriately used depending on manufacturing processes, structural conditions and the like. For example, compound semiconductor materials such as GaAs, InSb, InAs and SiC, or other semiconductor materials such as Ge (i.e., germanium) can be used. Particularly, GaAs and InAs are materials having an excellent temperature characteristic, and effective for improving sensitivity of the relevant Hall element.

While the semiconductor region 12 is formed as the diffusion layer in each of the fifteenth to nineteenth embodiments, it is not limited to this, and for example, the invention can be similarly applied to a structure in which the semiconductor region 12 is formed as an epitaxial film as the conventional vertical Hall element as shown in FIGS. 68A to 68C. Generally, when such an epitaxial substrate is used, the buried layer BL (FIGS. 68A to 68C) is often used. Alternatively, a SOI (i.e., Silicon On Insulator) substrate and the like can be appropriately used.

The layout or number of respective patterns can be set optionally. In a word, when a structure is made such that it has the voltage output terminals that output the Hall voltage in pairs, and the current supply terminals for supplying current to the magnetic detection part in pairs formed on the surface of the semiconductor substrate in a mode having at least two patterns that are identical, advantages equal or similar to the advantages of the above (1) according to the fifteenth embodiment can be obtained.

In the eighteenth embodiment, a structure is made, in which a step was formed between the contact regions 13c, 13d corresponding to the voltage output terminals, and the contact regions 13a corresponding to the current supply terminals on the surface of the semiconductor substrate. However, this is not limited configuration. In a word, when a structure is made such that it has at least one of the voltage output terminals that output the Hall voltage in pairs, and the current supply terminals for supplying current to the magnetic detection part HP in pairs formed in a recess or on a concave portion provided on the surface of the semiconductor substrate, advantages equal or similar to the advantages of the above (31) according to the eighteenth embodiment can be obtained.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A vertical Hall device comprising:
a semiconductor substrate including a magnetic field detection portion, a current portion and an output portion, wherein
the output portion outputs a Hall voltage in accordance with a magnetic field component parallel to a surface of the substrate when a magnetic field is applied to the magnetic field detection portion, and current including a component perpendicular to the surface of the substrate is supplied to the magnetic field detection portion through the current portion,
the output portion includes a pair of output terminals,
the current portion is capable of supplying the current to the magnetic field detection portion and retrieving the current from the magnetic field detection portion, and
the current portion is sandwiched between a pair of the output terminals in such a manner that the current portion is disposed apart from a line connecting between a pair of the output terminals.

2. The device according to claim 1, wherein
a pair of the output terminals is disposed on a portion of the substrate, the portion at which equipotential lines in an electric potential distribution are dense.

3. The device according to claim 1, wherein
a pair of the output terminals is disposed on a portion of the substrate, the portion at which equipotential lines in an electric potential distribution are dilute.

4. The device according to claim 1, wherein
a pair of the output terminals is disposed on the substrate, and
each output terminal has an impurity concentration higher than that of the substrate.

5. The device according to claim 1, wherein
the current portion is disposed on the substrate, and
the current portion has an impurity concentration higher than that of the substrate.

6. The device according to claim 1, wherein
the substrate has an asymmetric electric potential distribution with reference to the line connecting between a pair of the output terminals.

7. The device according to claim 6, wherein
the current portion is disposed on a dense side of equipotential lines in the asymmetric electric potential distribution.

8. The device according to claim 6, wherein
the current portion is disposed on a dilute side of equipotential lines in the asymmetric electric potential distribution.

9. The device according to claim 6, wherein
the current portion includes a pair of current terminals, which is disposed asymmetric with reference to the line connecting between a pair of the output terminals.

10. The device according to claim 6, wherein
the current portion includes a pair of current terminals, which is disposed on one side of the line connecting between a pair of the output terminals.

11. The device according to claim 1, wherein
the current portion includes a pair of current terminals, and
the line connecting between a pair of the output terminals is perpendicular to a line connecting between a pair of current terminals.

12. The device according to claim 1, wherein
the current portion includes a pair of current terminals,
a pair of the current terminals is disposed on the substrate, and
each current terminals has an impurity concentration higher than that of the substrate.

13. The device according to claim 1, wherein
the current including the component perpendicular to the surface of the substrate flows through the magnetic field detection portion in a slanting direction with reference to the surface of the substrate.

14. The device according to claim 1, further comprising:
a signal processing circuit for processing a signal corresponding to the Hall voltage outputted from the output terminals, wherein
the signal processing circuit is disposed on the substrate so that one chip magnetic sensor is provided, and
the one chip magnetic sensor detects the magnetic field applied to the device in a predetermined direction.

15. The device according to claim 1, wherein
the magnetic field detection portion, the current portion and the output portion provide a first Hall element,
the semiconductor substrate further includes a second magnetic field detection portion, a second current portion and a second output portion, which provide a second Hall element,
the first Hall element detects a first magnetic field component of a magnetic field in a first direction, and
the second Hall element detects a second magnetic field component of the magnetic field in a second direction.

16. The device according to claim 15, wherein
the semiconductor substrate further includes a lateral Hall element for detecting a third magnetic field component of the magnetic field in a third direction,
the third direction is perpendicular to the substrate,
the first direction is perpendicular to the second direction, and
the first and the second directions are perpendicular to the third direction.

17. The device according to claim 15, wherein
the semiconductor substrate further includes third and fourth magnetic field detection portions, third and fourth current portions and third and fourth output portions, which provide third and fourth Hall elements, respectively,
the first Hall element faces the third Hall element, and
the second Hall element faces the fourth Hall element.

18. The device according to claim 17, wherein
the substrate has four sides of a rectangular shape,
a line connecting between the first and the third Hall elements has a 45 degree angle with respect to one side of the substrate, and
a line connecting between the second and the fourth Hall elements has a 45 degree angle with respect to another one side of the substrate.

19. The device according to claim 15, wherein
the line connecting between a pair of the output terminals is parallel to a predetermined crystal orientation of the substrate, and
a line connecting between a pair of output terminals of the second output portion is parallel to another predetermined crystal orientation of the substrate.

20. The device according to claim 15, wherein
the first and the second Hall elements are surrounded with a trench isolation.

21. A vertical Hall device comprising:
a semiconductor substrate including a magnetic field detection portion, an output portion, a separation wall and a high concentration region, wherein
the output portion outputs a Hall voltage in accordance with a magnetic field component parallel to a surface of the substrate when a magnetic field is applied to the magnetic field detection portion, and current including a component perpendicular to the surface of the substrate is supplied to the magnetic field detection portion,
the separation wall electrically separates the substrate into a plurality of parts by a PN junction between the separation wall and the substrate,
the high concentration region is disposed on a surface of the substrate and disposed between the separation wall and the substrate, and
the high concentration region has an impurity concentration higher than that of the substrate.

22. The device according to claim 21, wherein
the magnetic field detection portion and the output portion are disposed in one of the parts of the substrate.

23. The device according to claim 21, wherein
the magnetic field detection portion and the output portion are surrounded with the separation wall.

24. The device according to claim 21, wherein
the high concentration region has a depth perpendicular to the substrate, and
the depth of the high concentration region is minimized as long as the current including the component perpendicular to the surface of the substrate is capable of flowing through the magnetic field detection portion.

25. The device according to claim 21, wherein
the magnetic field detection portion and the output portion provide a Hall element, and
the separation wall separates the Hall element from other parts on the substrate.

26. The device according to claim 25, wherein
the high concentration region includes a first high concentration region and a second high concentration region, and
the first high concentration region is disposed inside of the separation wall, and the second high concentration region is disposed outside of the separation wall.

27. The device according to claim 21, further comprising:
a conductor plate disposed on the substrate in such a manner that the conductor plate covers the magnetic field detection portion.

28. The device according to claim 27, wherein
the conductor plate is made of poly crystal silicon or aluminum.

29. The device according to claim 21, wherein
the substrate further includes a current portion having a pair of current terminals,
a pair of the current terminals is capable of supplying the current to the magnetic field detection portion,
the output portion includes a pair of output terminals for outputting the Hall voltage,
a pair of the output terminals is disposed on the substrate,
each output terminal has an impurity concentration higher than that of the substrate,
a pair of the current terminals is disposed on the substrate,
each current terminals has an impurity concentration higher than that of the substrate,
the high concentration region has a depth perpendicular to the substrate, and
the depth of the high concentration region is almost equal to a depth of the current terminals or a depth of the output terminals.

30. The device according to claim 21, wherein
the current including the component perpendicular to the surface of the substrate flows through the magnetic field detection portion in a slanting direction with reference to the surface of the substrate.

31. A vertical Hall device comprising:
a semiconductor substrate including a magnetic field detection portion, a current portion and an output portion, wherein
the output portion outputs a Hall voltage in accordance with a magnetic field component parallel to a surface of the substrate when a magnetic field is applied to the magnetic field detection portion, and current including a component perpendicular to the surface of the substrate is supplied to the magnetic field detection portion through the current portion,
the output portion includes a pair of output terminals for outputting the Hall voltage,
the current portion includes a pair of current terminals for supplying the current to the magnetic field detection portion,
each output terminal includes a plurality of output terminal parts having a predetermined pattern, and
each current terminal includes a plurality of current terminal parts having a predetermined pattern.

32. The device according to claim 31, wherein
the pattern of the output terminal parts is symmetric on the basis of the pattern of the current terminal parts.

33. The device according to claim 31, wherein
the pattern of the current terminal parts is symmetric on the basis of the pattern of the output terminal parts.

34. The device according to claim 31, wherein
the number of the current terminal parts is odd number,
the current terminal parts are symmetric on the basis of one of the current terminal parts,
the number of the output terminal parts is odd number, and
the output terminal parts are symmetric on the basis of one of the output terminal parts.

35. The device according to claim 31, wherein
the number of the current terminal parts is even number,
the current terminal parts are symmetric so that a predetermined number of pairs of the current terminal parts is provided,
the number of the output terminal parts is even number, and
the output terminal parts are symmetric so that a predetermined number of pairs of the output terminal parts is provided.

36. The device according to claim 31, wherein
each current terminal part is connected to a wiring, which is capable of temporary or eternally disconnecting to an external circuit, and
each output terminal part is connected to a wiring, which is capable of temporary or eternally disconnecting to the external circuit.

37. The device according to claim 36, wherein
the wiring of the current terminal part includes a fuse for disconnecting itself by overcurrent, and
the wiring of the output terminal part includes a fuse for disconnecting itself by overcurrent.

38. The device according to claim 36, wherein
the wiring of the current terminal part includes a thin film resistor capable of disconnecting by a trimming, and
the wiring of the output terminal part includes a thin film resistor capable of disconnecting by the trimming.

39. The device according to claim 36, wherein
the wiring of the current terminal part includes a switching device for switching on the basis of an external signal, and
the wiring of the output terminal part includes a switching device for switching on the basis of an external signal.

40. A vertical Hall device comprising:
a semiconductor substrate including a magnetic field detection portion, a current portion and an output portion, wherein
the output portion outputs a Hall voltage in accordance with a magnetic field component parallel to a surface of the substrate when a magnetic field is applied to the magnetic field detection portion, and current including a component perpendicular to the surface of the substrate is supplied to the magnetic field detection portion through the current portion,
the current portion includes a pair of current terminals for supplying the current to the magnetic field detection portion, and
each current terminal includes a plurality of pairs of current terminal parts.

41. The device according to claim 40, wherein
the output portion includes a pair of output terminals for outputting the Hall voltage,
each output terminal includes a plurality of pairs of output terminal parts, and
the pairs of the current terminal parts has a predetermined pattern, which is symmetric on the basis of a pattern of the pairs of the output terminal parts.

42. A vertical Hall device comprising:
a semiconductor substrate including a magnetic field detection portion, a current portion and an output portion, wherein
the output portion outputs a Hall voltage in accordance with a magnetic field component parallel to a surface of the substrate when a magnetic field is applied to the magnetic field detection portion, and current including a component perpendicular to the surface of the substrate is supplied to the magnetic field detection portion through the current portion,
the output portion includes a pair of output terminals for outputting the Hall voltage, and
at least one of the output terminals is disposed on a concavity or a convexity on the surface of the substrate.

43. The device according to claim 42, wherein
the current portion includes a pair of current terminals for supplying the current to the magnetic field detection portion,
at least one of the current terminals is sandwiched between the pair of the output terminals, and
the substrate further includes a step disposed between the one of the current terminals and at least one of the pair of the output terminals.

44. The device according to claim 42, wherein
the pair of the output terminals is disposed on the substrate, and
each output terminal has an impurity concentration higher than that of the substrate.

45. The device according to claim 42, wherein
the current portion includes a pair of current terminals for supplying the current to the magnetic field detection portion,
the pair of the current terminals is disposed on the substrate, and
each current terminal has an impurity concentration higher than that of the substrate.

46. A vertical Hall device comprising:
a semiconductor substrate including a magnetic field detection portion, a current portion and an output portion, wherein
the output portion outputs a Hall voltage in accordance with a magnetic field component parallel to a surface of the substrate when a magnetic field is applied to the magnetic field detection portion, and current including a component perpendicular to the surface of the substrate is supplied to the magnetic field detection portion through the current portion,
the current portion includes a pair of current terminals for supplying the current to the magnetic field detection portion, and
at least one of the current terminals is disposed on a concavity or a convexity on the surface of the substrate.

47. The device according to claim 46, wherein
the output portion includes a pair of output terminals for outputting the Hall voltage,
the concavity or the convexity, on which one of the current terminals is disposed, is sandwiched between the pair of the output terminals.

48. The device according to claim 46, wherein
the output portion includes a pair of output terminals for outputting the Hall voltage,
at least one of the current terminals is sandwiched between the pair of the output terminals, and
the substrate further includes a step disposed between the one of the current terminals and at least one of the pair of the output terminals.

49. The device according to claim 46, wherein
the output portion includes a pair of output terminals for outputting the Hall voltage,
the pair of the output terminals is disposed on the substrate, and
each output terminal has an impurity concentration higher than that of the substrate.

50. The device according to claim 46, wherein
the pair of the current terminals is disposed on the substrate, and
each current terminal has an impurity concentration higher than that of the substrate.

51. A method for adjusting an offset voltage of a vertical Hall device, which includes a semiconductor substrate having a magnetic field detection portion, a current portion and an output portion, wherein the output portion outputs a Hall voltage in accordance with a magnetic field component parallel to a surface of the substrate when a magnetic field is applied to the magnetic field detection portion, and current including a component perpendicular to the surface of the substrate is supplied to the magnetic field detection portion through the current portion, and wherein the output portion includes a pair of output terminals having a predetermined pattern for outputting the Hall voltage, and the current portion includes a pair of current terminals having a predetermined pattern for supplying the current to the magnetic field detection portion, the method comprising the step of:
determining a compensation value for adjusting the offset voltage of the Hall device on the basis of a relation ship between a position of the patterns of the output terminals and the current terminals and the offset voltage.

52. A method for adjusting an offset voltage of a vertical Hall device, which includes a semiconductor substrate having a magnetic field detection portion, a current portion and an output portion, wherein the output portion outputs a Hall voltage in accordance with a magnetic field component parallel to a surface of the substrate when a magnetic field is applied to the magnetic field detection portion, and current including a component perpendicular to the surface of the substrate is supplied to the magnetic field detection portion through the current portion, and wherein the output portion includes a pair of output terminals having a predetermined pattern for outputting the Hall voltage, and the current portion includes a pair of current terminals having a predetermined pattern for supplying the current to the magnetic field detection portion, the method comprising the step of:
canceling the offset voltage by controlling the current flowing through the magnetic field detection portion periodically when the Hall device is operated.

53. A method for adjusting an offset voltage of a vertical Hall device, which includes a semiconductor substrate having a magnetic field detection portion, a current portion and an output portion, wherein the output portion outputs a Hall voltage in accordance with a magnetic field component parallel to a surface of the substrate when a magnetic field is applied to the magnetic field detection portion, and current including a component perpendicular to the surface of the substrate is supplied to the magnetic field detection portion through the current portion, and wherein the output portion includes a pair of output terminals having a predetermined pattern for outputting the Hall voltage, and the current portion includes a pair of current terminals having a predetermined pattern for supplying the current to the magnetic field detection portion, the method comprising the step of:
selectively adjusting a height of at least one of the output terminals or at least one of the current terminals so that the offset voltage of the Hall device is adjusted.
